(19) United States
(12) Patent Application Publication
(10) Pub. No.: US 2026/0296686 A1
(43) Pub. Date: Oct. 1, 2026

(54) AUTOMATED CLEANING SYSTEM AND DEVICE

(71) Applicant: CLEANBOTIX, INC., Kentwood, MI (US)

(72) Inventors: Adam Jacques, Caledonia, MI (US); Andrew Zieger, Grand Rapids, MI (US)

(73) Assignee: CLEANBOTIX, INC., Kentwood, MI (US)

(21) Appl. No.: 19/568,169

(22) Filed: Mar. 16, 2026

Related U.S. Application Data
(63) Continuation-in-part of application No. 19/314,718, filed on Aug. 29, 2025.
(60) Provisional application No. 63/695,934, filed on Sep. 18, 2024.
(60) Provisional application No. 63/757,396, filed on Feb. 12, 2025.

(51) Int. Cl. B64U 10/60; B08B 3/02; B08B 5/04; B08B 13/00; B64U 50/30; B64U 101/29; B65H 75/42; B65H 75/44; G01S 17/933; G05D 1/229; G05D 1/689; G05D 105/10

(52) U.S. Cl. CPC B64U 10/60; B08B 3/024; B08B 5/04; B08B 13/00; B64U 50/30; B65H 75/425; B65H 75/4484; G01S 17/933; G05D 1/229; G05D 1/6895; B08B 2230/01; B64U 2101/29; B64U 2201/10; B65H 2701/34; G05D 2105/10

(57) ABSTRACT

An autonomous cleaning system includes an autonomous vehicle that is powered for movement within an area to be cleaned. The autonomous vehicle includes a robotic spray arm having an automated tool connector assembly and a plurality of spray nozzle assemblies that can be automatically connected to the robotic spray arm at the tool connector assembly. The autonomous vehicle further includes an automated reel assembly that includes a spool assembly for storing and deploying a supply hose that supplies pressurized fluid and air to the robotic spray arm as the autonomous vehicle moves about a facility during a cleaning procedure.

### CROSS-REFERENCE TO RELATED APPLICATIONS

This application is a continuation-in-part to U.S. application Ser. No. 19/314,718, filed Aug. 29, 2025, titled Automated Cleaning System and Device, which claims priority to Provisional Application No. 63/695,934, filed Sep. 18, 2024, and U.S. Provisional Application No. 63/757,396, filed Feb. 12, 2025, all of which are incorporated herein by reference in their entireties.

### FIELD OF THE DISCLOSURE

The present disclosure generally relates to an automated system for cleaning and/or sanitizing equipment and other items in food processing facilities and the like, and more specifically, to an automated vehicle that is configured to autonomously move along one or more predefined paths and perform various tasks as required.

### BACKGROUND OF THE DISCLOSURE

In many industries, sanitation crews are employed to clean facilities after the facilities have been used for processing materials. For example, the food industry may utilize trained sanitation crews to clean and sanitize the food processing facilities.

### SUMMARY OF THE DISCLOSURE

An aspect of the present disclosure is an autonomous cleaning system for performing cleaning and/or sanitization procedures. While processing facilities of the food industry are provided as an example in this disclosure, the present concept is not limited to the cleaning and sterilization of such an environment. Rather, an autonomous cleaning system according to the present disclosure can be used for cleaning and/or sanitization procedures at virtually any location or facility.

An autonomous cleaning system according to the present disclosure may be configured to utilize a constant supply of pressurized water and/or a constant supply of compressed air. In some parts of a process according to the present disclosure, the water may be used to physically remove soil and other matter from surfaces. In other parts of a process according to the present disclosure, water may be mixed with chemistry (chemical Attorney agents) to produce cleaning solutions. These solutions may be used in liquid form, or they can be combined with compressed air to generate foam. A process according to the present disclosure may utilize water to rinse one or more surfaces to remove any remaining cleaning solution or other matter.

An autonomous cleaning system according to the present disclosure may utilize water that is pressure boosted to several hundred PSI (e.g. up to 363 psi or more). The water may also have a high flow rate (e.g. 3-12 or more GPM) for efficient cleaning and/or sanitation. An autonomous cleaning system according to the present disclosure may also utilize a large amount (e.g. Cubic Feet per Minute) of compressed air to produce a cleaning foam.

An automated reel assembly according to an aspect of the present disclosure may be mounted on an automated vehicle such as a mobile robot or drone to supply boosted pressure water and/or compressed air to the robot via flexible conduit such as a hose as the robot navigates a facility during a cleaning procedure. The reel assembly may be configured to pay out a calculated amount of hose when needed and take up a calculated amount of hose when needed to thereby synchronize pay out and take up of the hose with the movement of the robot to allow the robot to traverse both linear and non-linear paths through a plant or other such environment. The automated reel assembly is preferably configured to be reliable, and resistant to tangles and jams during repeated automated cycles.

An autonomous cleaning system according to the present disclosure may be configured to complete a multi-step cleaning and sanitation process, while reaching all necessary areas of the sanitation target. A facility sanitation process may generally include the following steps: 1) Knockdown rinse-use a high flow rate of water to remove soils and/or other matter from surfaces; 2) Foam-use a chemical solution, in a foamed state, to loosen soils, residues or other matter from surfaces; 3) Rinse-use a lower flow rate of water to rinse away remaining foam and loosened soils, residues or other matter from surfaces; 4) Sanitize—use a chemical solution to wet the cleaned surfaces, kill any remaining bacteria, and provide a barrier to inhibit future bacterial growth. Different spraying nozzles may be used to efficiently perform these steps. For example, the foaming step may require a much larger nozzle in comparison to the sanitizing step. Additionally, it may be desirable to have the ability to automatically switch between different nozzle extensions (spray tools). For example, if the autonomous cleaning system comprises a sanitation robot having a robotic arm, different nozzle extensions may enable the robotic arm to position a stream of water or foam, whereby the stream reaches different areas of a sanitation target while maintaining an effective distance between the target surface and the spraying nozzle. If necessary, nozzle extensions having more than one length or spray pattern may be utilized to achieve this result within a given sanitation step. Thus, another aspect of the present disclosure is an automatic tool changer system that is specifically designed for use on or with a sanitation robot or drone.

An autonomous cleaning system according to another aspect of the present disclosure includes an autonomous vehicle having a spray arm with an articulating spray head. The autonomous vehicle is tethered to a base station via a tether assembly. The autonomous vehicle is supplied with one or more solutions from the base station through the tether assembly for applying to an area to be cleaned via the spray arm. The articulating spray head further includes a plurality of spray head tips that can be selectively chosen for application of a solution to the area to be cleaned.

An autonomous vehicle according to another aspect of the present disclosure includes a chassis or frame assembly that is configured to be moveably associated with a support surface. A robotic spray arm is supported on the frame assembly and includes a plurality of sections interconnected by a plurality of articulating joints and having a spray nozzle coupled to a distal end thereof. A tether assembly is operably coupled to one or more solution sources disposed on the frame assembly and fluidically interconnects the solution sources with the spray nozzle. A control system may include a control panel and user interface are configured to provide movement routines for the autonomous vehicle and robotic spray arm, wherein the control panel and user interface are further configured to regulate solutions as provided by the one or more solution sources to the spray nozzle.

An autonomous vehicle includes a chassis having a powered drive system that is configured to move the autonomous vehicle. A reel assembly includes a spool and a roller assembly. A power supply line is operably coupled to the roller assembly and at least partially housed on the spool. The power supply line is configured to electronically couple the autonomous vehicle to a power source that is not on the autonomous vehicle. A controller is configured to cause the roller assembly to: 1) pay out the power supply line from the spool when the autonomous vehicle moves away from the power source, and: 2) wind the power supply line onto the spool as the autonomous vehicle moves towards the power source.

An autonomous vehicle includes a chassis and a powered drive system supported by the chassis. The powered drive system is configured to selectively move the autonomous vehicle. A reel assembly includes a spool that houses a supply hose. Suction is supplied to the autonomous vehicle from a vacuum source that is fluidly connected to the supply hose. A portion of the supply hose extends between the spool and the vacuum source. A robotic arm includes a nozzle assembly that is coupled to the supply hose. A controller is configured to actuate the powered drive system to move the autonomous vehicle along a predefined path and pay out the supply hose as the autonomous vehicle moves in a first direction along the predefined path.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a perspective view of an autonomous cleaning system positioned within a facility;

FIG. 2 is a perspective view of another embodiment of an autonomous cleaning system positioned within a facility;

FIG. 3 is a perspective view of an autonomous vehicle and a tether assembly supported on a support member;

FIG. 4 is a perspective view of an autonomous vehicle and a tether assembly supported on another embodiment of a support member;

FIG. 5 is a fragmentary perspective view of component parts of a tether assembly;

FIG. 6 is a fragmentary perspective view of an autonomous vehicle and connector portions thereof;

FIG. 7 is a fragmentary perspective view of the autonomous vehicle of FIG. 6 as connected to the component parts of the tether assembly of FIG. 5;

FIG. 8 is a perspective view of an autonomous vehicle;

FIG. 9 is a fragmentary perspective view of another embodiment of an autonomous vehicle positioned on a base station;

FIG. 10 is a cross-sectional view of a tether assembly taken at line X of FIG. 8;

FIG. 11 is a perspective view of a spray arm;

FIG. 12 is a perspective view of the spray arm of FIG. 11;

FIG. 13 is a fragmentary perspective view of a spray head assembly of the spray arm of FIG. 12;

FIGS. 14-19 are top plan views of a processing facility having an autonomous cleaning system with an autonomous vehicle deployed along a predetermined flight path;

FIGS. 20A-20C are top perspective views of an autonomous vehicle illustrating various spray patterns emitted therefrom;

FIGS. 21A and 21B are perspective views of an autonomous vehicle according to another embodiment;

FIG. 22 is a partially schematic perspective view of a robotic spray arm;

FIG. 23 is a top plan view of a processing facility having an autonomous cleaning system showing relative movement of an autonomous vehicle deployed along predetermined travel paths;

FIG. 24 is a partially fragmentary zoomed-in perspective view of an autonomous vehicle having a rack supporting a plurality of spray nozzles for selection by a robotic spray arm;

FIG. 25 is a partially fragmentary zoomed-in perspective view of the autonomous vehicle of FIG. 24 showing the selection of a spray nozzle by the robotic spray arm;

FIG. 26 is a fragmentary view of a portion of a tether assembly having multiple components mounted thereto;

FIG. 27 is a top plan view of a processing facility having an autonomous cleaning system showing relative movement of an autonomous vehicle deployed along a predetermined travel path where the autonomous vehicle is shown in a home position.

FIG. 28 is a is a top plan view of the processing facility of FIG. 27 wherein the autonomous vehicle is shown having moved from the home position to a waypoint disposed along the travel path;

FIG. 29 is a partially fragmentary perspective view of an autonomous vehicle;

FIG. 30 is a partially fragmentary perspective view of the autonomous vehicle of FIG. 29 having a supply hose coupled to a facility;

FIG. 31 is a perspective view of a robotic spray arm;

FIG. 32 is a perspective view of another embodiment of an autonomous vehicle;

FIG. 33 is a partially fragmentary perspective view of an automated reel assembly;

FIG. 34 is a partially fragmentary perspective view of the automated reel assembly of FIG. 33;

FIG. 35 is a partially fragmentary perspective view of the automated reel assembly of FIG. 34 with the bracket removed to display the drive mechanism;

FIG. 36 is a perspective view of engagement wheel mechanism shown in an engaged position;

FIG. 37 is a perspective view of the engagement wheel mechanism of FIG. 36 shown in a released position;

FIG. 38 is a cross-sectional view of the automated reel assembly taken at line XXXVIII of FIG. 34;

FIG. 39 is a cross-sectional view of a roller taken at line XXXIX of FIG. 35;

FIG. 40 is a cross-sectional view of an engagement wheel taken at line XXXIX of FIG. 35;

FIG. 41 is a partially fragmentary perspective view of an autonomous vehicle;

FIG. 42 is a partially fragmentary perspective view of a tool holder assembly;

FIG. 43 is a perspective view of a connector assembly;

FIG. 44 is a perspective view of the connector assembly of FIG. 43 received in the holder assembly of FIG. 42;

FIG. 45 is a partially fragmentary perspective view of the tool connector assembly and a nozzle assembly;

FIGS. 46A-46E are side elevation views of a tool connector assembly engaging a nozzle assembly;

FIGS. 47A-47E are cross-sectional views of the tool connector assembly and nozzle assembly of FIGS. 46A-46E;

FIG. 48 is a side elevation view of a tool holder assembly partially engaged with a connector assembly;

FIG. 49 is a side elevation view of the tool holder assembly of FIG. 48 fully engaged with the connector assembly of FIG. 48;

FIG. 50 is a partially fragmentary diagram representation of a manifold for mixing fluids;

FIG. 51 is a partially fragmentary isometric view of an autonomous vehicle according to another aspect of the present disclosure;

FIG. 52 is a partially fragmentary isometric view of the autonomous vehicle of FIG. 51;

FIG. 53 is a partially fragmentary isometric view of the autonomous vehicle of FIG. 51;

FIG. 54 is a partially fragmentary side elevational view of the autonomous vehicle of FIG. 51;

FIG. 55 is a cross-sectional view taken along line LV of FIG. 54;

FIG. 56 is an elevational view of the autonomous vehicle of FIG. 51;

FIG. 57 is a cross-sectional view taken along line LVII of FIG. 56;

FIG. 58 is a partially fragmentary cross-sectional view taken along line LVIII of FIG. 56;

FIG. 59 is a partially fragmentary elevational view of the autonomous vehicle of FIG. 51;

FIG. 60 is a partially fragmentary cross-sectional view taken along the line LX of FIG. 59;

FIG. 61 is a partially fragmentary enlarged view of a portion of the autonomous vehicle of FIG. 55;

FIG. 62 is a partially fragmentary enlarged view of a portion of the autonomous vehicle of FIG. 57;

FIG. 63 is a partially fragmentary enlarged view of a portion of the autonomous vehicle of FIG. 58;

FIG. 64 is a partially fragmentary enlarged view of a portion of the autonomous vehicle of FIG. 60;

FIG. 65 is an isometric view of a sensor and air knife according to an aspect of the present disclosure;

FIG. 66 is a partially fragmentary cross-sectional view of the air knife of FIG. 65;

FIG. 67 is a partially fragmentary cross-sectional view of the air knife taken along the line LXVII of FIG. 66;

FIG. 68 is a partially fragmentary, enlarged view of the air knife taken along the line LXVIII of FIG. 67;

FIG. 69 is a block diagram of an autonomous vehicle according to an aspect of the present disclosure;

FIG. 70 is a flowchart showing set-up of an autonomous vehicle according to an aspect of the present disorder;

FIG. 71 is a schematic plan view of a facility showing a path of an autonomous vehicle according to another aspect of the present disclosure;

FIG. 72 is a partially fragmentary isometric view of an autonomous vehicle according to another aspect of the present disclosure;

FIG. 73 is a partially fragmentary perspective view of the autonomous vehicle of FIG. 72 having a tool holder;

FIG. 74 is a is a perspective view of another embodiment of the autonomous vehicle of FIG. 72 during a cleaning procedure;

FIG. 75 is a cross-sectional view taken along line LXXV of FIG. 72;

FIG. 76 is a cross-sectional view of a roller according to another embodiment;

FIG. 77 is a cross-sectional view of an engagement wheel according to another embodiment;

FIG. 78A is an isometric view of an autonomous vehicle according to another aspect of the present disclosure as connected to a base station;

FIG. 78B is an isometric view of the autonomous vehicle of FIG. 78A as moved away from the base station;

FIG. 79 is a cross-sectional view taken along line LXXIX of FIG. 78B;

FIG. 80 is an isometric view of an autonomous vehicle according to another aspect of the present disclosure; and

FIG. 81 is a cross-sectional view taken along line LXXXI of FIG. 80.

The components in the figures are not necessarily to scale, emphasis instead being placed upon illustrating the principles described herein.

### DETAILED DESCRIPTION

The present illustrated embodiments reside primarily in combinations of method steps and apparatus components related to an automated cleaning system and related autonomous vehicle. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

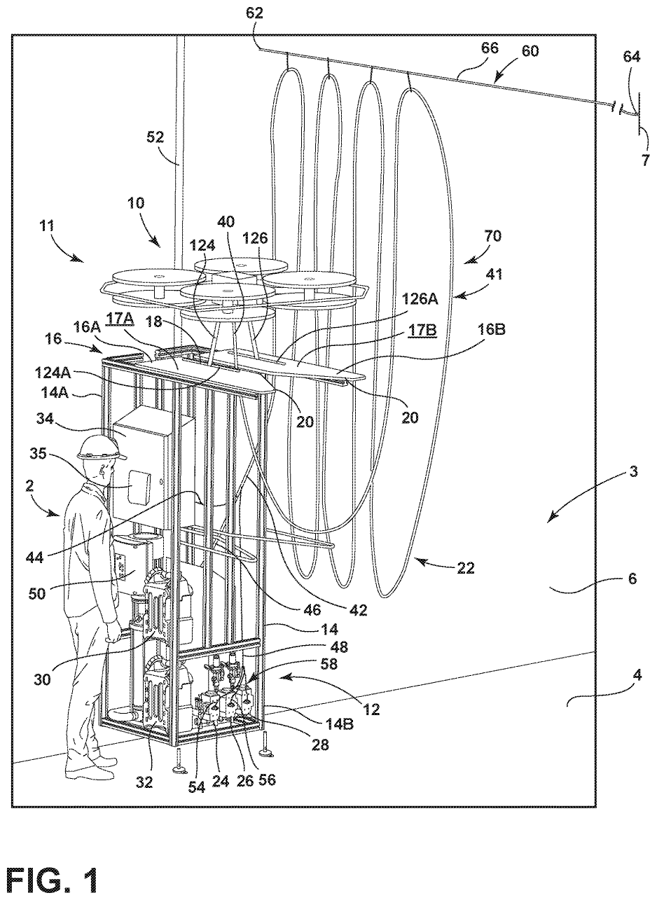

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a.” does not, without more constraints, preclude the existence of additional identical elements in the process, method, article, or apparatus that comprises the element.

As used herein, the term “autonomous” means that a device is capable of self-governing without outside control or human intervention during at least some aspect of operation. The vehicles described herein as being “autonomous vehicles” are capable of executing routines that are facilitated by onboard navigation sensors and software for executing onboard autonomy to allow the vehicle to move about a space in a preprogrammed manner.

As used herein, the term “vehicle” refers to a device that is configured for powered movement about an area. Such a vehicle may include an “unmanned aerial vehicle” (UAV), such as a rotorcraft or drone-type vehicle or may include a wheel-based vehicle supported on and configured for movement about a support surface, as further described below.

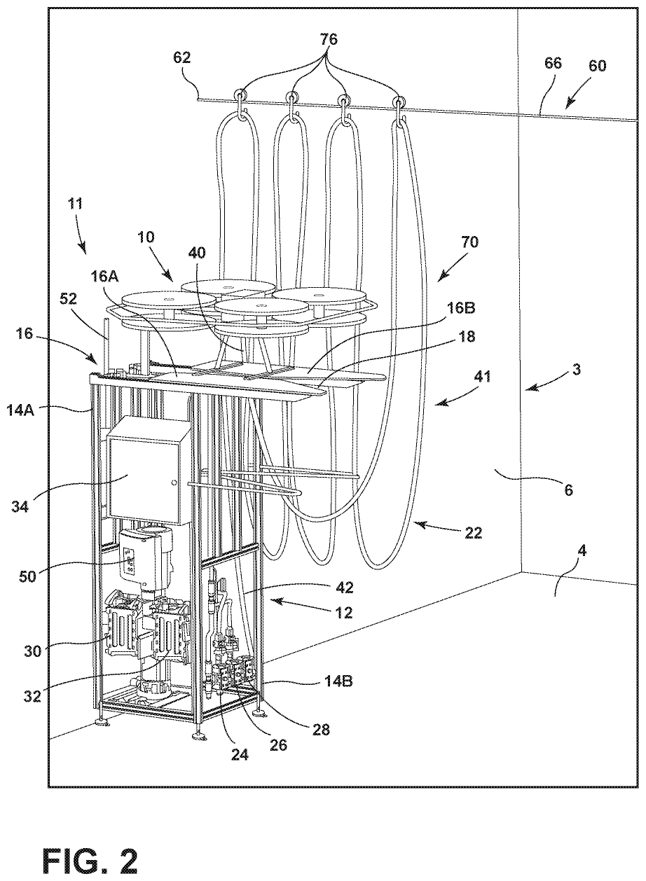

Referring now to FIGS. 1-2, the reference numeral 10 generally designates an autonomous vehicle configured for use with the present concept. In the embodiment shown in FIGS. 1-2, the autonomous vehicle 10 is shown in the form of a drone; however, the scope of the invention is not limited to a drone or rotorcraft-type vehicle, as further described below.

As shown in FIG. 1, a user 2 is illustrated adjacent to an autonomous cleaning system 11. As specifically shown in FIG. 1, user 2 is disposed adjacent to a base station 12 of autonomous cleaning system 11. As shown in FIGS. 1 and 2, base station 12 is positioned within a processing facility 3 and is supported in an upright position on a floor surface 4. In the embodiment shown in FIG. 1, base station 12 is also positioned adjacent to a wall 6 of the processing facility. Base station 12 includes a housing 14 having an upper portion 14A and a lower portion 14B. Autonomous vehicle 10 is shown supported on a landing platform 16 disposed at the upper portion 14A of base station 12. The landing platform 16 includes first and second portions 16A, 16B that are spaced-apart from each other to define a receiving area 18 positioned therebetween. The first and second portions 16A, 16B of the landing platform 16 each include tapered front ends 20 that are inwardly angled towards the receiving area 18. In use, the tapered front ends 20 are used to guide and corral a portion of a tether assembly 22 into the receiving area 18 when autonomous vehicle 10 is supported on the landing platform 16 in a home position. As shown in FIGS. 1 and 2, first and second portions 16A, 16B of the landing platform 16 include generally planar upper surfaces 17A, 17B, respectively, for supporting autonomous vehicle 10 in an upright position. Base station 12 further includes a plurality of valves illustrated as valves 24, 26 and 28 positioned near the lower portion 14B of the housing 14 of base station 12 which may be remotely controlled to open and close in order to selectively provide a specific liquid to the tether assembly 22 for application of the liquid on surfaces and equipment positioned within the processing facility 3 by autonomous vehicle 10, as further described below.

In the embodiment shown in FIGS. 1 and 2, base station 12 further includes first and second containers 30, 32. The first and second containers 30, 32 are contemplated to hold various cleaning and sanitizing compositions, such as a foaming solution and a sanitizing solution. In use, the first and second containers are fluidically coupled to one of the valves 24, 26 or 28 of base station 12 for selectively delivering the foaming solution or sanitizing solution to the tether assembly 22. The first and second containers 30, 32 are contemplated to be replaceable containers that can be easily replaced with full containers by user 2 when the solution in either container 30 or 32 is depleted. The first and second containers 30, 32 define solution sources for autonomous vehicle 10 to draw from when spraying within a facility, as further described below. Base station 12 further includes a controller such as control panel 34 that can be accessed by user 2 for controlling or programming autonomous cleaning system 11. Specifically, the control panel 34 may include a user interface 35 in the form of a touchscreen or other like interface for user 2 to access for programming or running autonomous cleaning system 11. It will be understood that virtually any suitable controller may be utilized according to the present disclosure.

As shown in FIG. 1, the tether assembly 22 includes first and second ends 40, 42 with a body portion 41 disposed therebetween. First end 40 of the tether assembly 22 is shown connected to autonomous vehicle 10. The second end 42 of the tether assembly 22 is shown connected to base station 12. In this way, the tether assembly 22 provides liquid to autonomous vehicle 10 through the tether assembly 22. The liquid provided from base station 12 to autonomous vehicle 10 may include a cleaning solution, such as a foaming agent, water or a sanitizing solution. As further shown in FIG. 1, the second end 42 of the tether assembly 22 includes a number of branched portions in the form of a data lead 44, power leads 46, and a supply line 48 as further described below. As shown in the embodiment of FIG. 1, the data lead 44 is operably coupled to base station 12 at the control panel 34. In use, it is contemplated that the data lead 44 provides programming data to autonomous vehicle 10 for controlling the various operations of autonomous vehicle 10, such as the movement of autonomous vehicle 10, and the cleaning or sanitizing procedures performed by autonomous vehicle 10, as further described below. The power lead 46 is contemplated to provide continuous power to autonomous vehicle 10, such that autonomous vehicle 10 of the present concept does not have to recharge during operations but rather is supplied with continuous power through the power lead 46 from base station 12. This allows autonomous vehicle 10 of the present concept to execute cleaning and sanitizing procedures without the need to disrupt such procedures for charging or battery replacement. Supply line 48 is shown coupled to the valves 24, 26 and 28 and is configured to supply various solutions to autonomous vehicle 10 for conducting sanitizing and cleaning procedures. As such, supply line 48 may include a plurality of ends 54, 56, and 58 that are directly coupled to the valves 24, 26 and 28, respectively. The valves 24, 26 and 28 are contemplated to be remotely operated between open and closed positions, such that the valves 24, 26 and 28 can be selectively open and closed as needed during the cleaning or sanitizing procedure, as further outlined below. Base station 12 may be provided with a pump 50 which can be configured to power the movement of the various solutions to autonomous vehicle 10 from base station 12 and may also power the spraying of the solutions from autonomous vehicle 10. As further shown in FIG. 1, base station 12 is operably coupled to an input line 52 disposed along the wall 6 of the processing facility 3 which is contemplated to include water and power supplies to base station 12. It is contemplated that autonomous cleaning system 11 can be powered by the water pressure provided from the input line 52 or could include supplemental spraying power, such as that provided by pump 50. In this way, the input line 52 further defines a source that autonomous vehicle 10 can draw from for spraying within the facility.

As further shown in FIGS. 1 and 2, body portion 41 of the tether assembly 22 is arranged in a festooned configuration 70 along a support member 60. Support member 60 includes first and second ends 62, 64 with a body portion 66 disposed therebetween. As shown in FIGS. 1 and 2, the first end 62 of support member 60 is coupled to wall 6 of the processing facility 3. Second end 64 of support member 60 is coupled to another wall 7 of the processing facility 3, as best shown in FIG. 1. It is contemplated that the first and second ends 62, 64 of support member 60 may be coupled to any structures within the processing facility 3, so long as support member 60 is suspended above the floor surface 4 in such a manner as to allow free movement of the tether assembly 22 along a length of body portion 66 of support member 60 between the first and second ends 62, 64. Specifically, it is contemplated that support member 60 is positioned strategically within the processing facility 3 such that autonomous vehicle 10 can reach all areas of the processing facility 3 set to be cleaned or sanitized by autonomous cleaning system 11. In the embodiment shown in FIGS. 1 and 2, support member 60 may be any support member, such as a rail, cable or other like support feature, which is capable of allowing movement of the tether assembly 22 along the length thereof. With specific reference to FIG. 2, the tether assembly 22 is shown coupled to support member 60 by a number of carrier assemblies 76 that are configured for sliding movement along support member 60, as further described below.

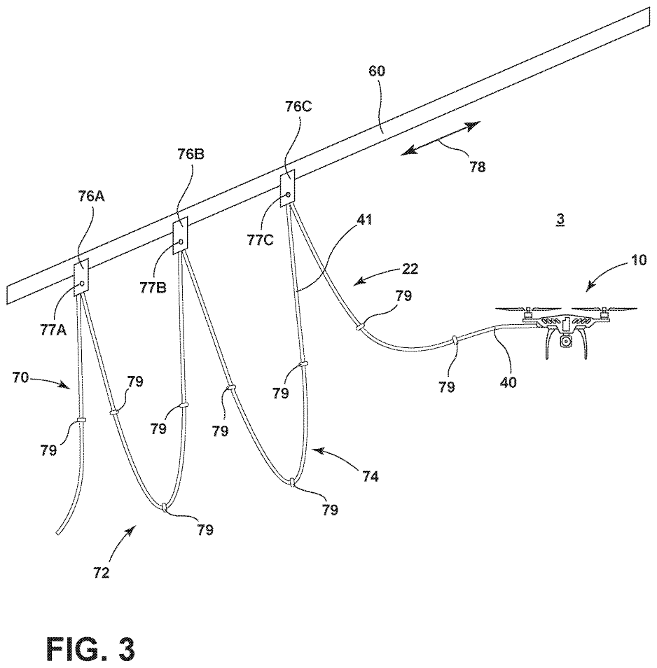

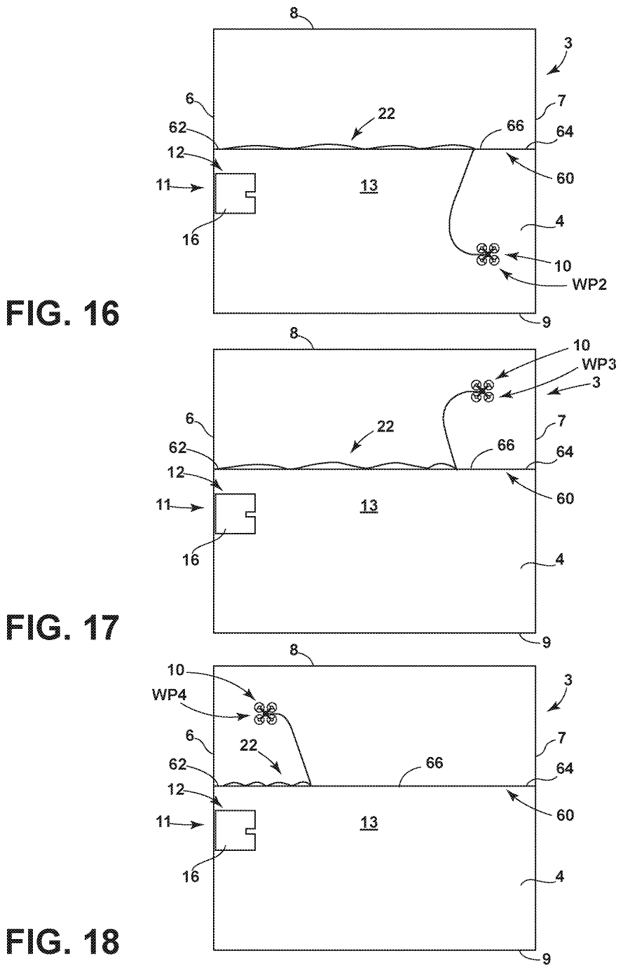

Referring now to FIG. 3, autonomous vehicle 10 is shown coupled to the tether assembly 22 at the first end 40 thereof. Body portion 41 of the tether assembly 22 is shown in the festooned configuration 70, wherein first and second loops 72, 74 are shown coupled to support member 60 by multiple carrier assemblies 76A-76C. The carrier assemblies 76A, 76B and 76C are configured to move along support member 60 in the direction as indicated by arrow 78 as the tether assembly 22 moves between a stowed position and a fully deployed position. When the tether assembly 22 is in the stowed position, as best shown in FIG. 2, the carrier assemblies 76A, 76B and 76C are positioned adjacent to base station 12. When the tether assembly 22 is in the fully deployed position, the carrier assemblies 76A, 76B and 76C are spaced-apart from one another along the length of support member 60 to allow autonomous vehicle 10 to reach the outer perimeters of a preprogrammed flight plan, as best shown in FIGS. 16 and 17. In the embodiment shown in FIG. 3, the tether assembly 22 is contemplated to be in a partially deployed position. It is contemplated that the carrier assemblies 76A, 76B and 76C can be supported on support member 60 by a wheeled configuration, a sliding hook or loop configuration (FIG. 2), or any other carrier configuration that allows the tether assembly 22 to be supported by support member 60 above the floor surface 4 of the processing facility 3 (as shown in FIGS. 1-2) and easily moved along support member 60. As further shown in FIG. 3, the carrier assemblies 76A, 76B and 76C may include optical sensors in the form of cameras 77A, 77B, and 77C that help to monitor the processing facility 3 for any objects, such as moving objects or personnel in the processing facility, that may require a cleaning or sanitizing procedure to temporarily shut down. Further, it is contemplated that the tether assembly 22 includes a plurality of engagement members 79 (FIG. 3) spaced-apart along a length of body portion 41 of the tether assembly 22 to bundle the first and second power leads 46A, 46B, the data lead 44 and the supply line 48 together at various intervals as necessary to keep the tether assembly 22 together during a cleaning or sanitizing procedure. The engagement members 79 may include clips, fasteners, straps or any other type of engagement feature capable of bundling the component parts of the tether assembly 22.

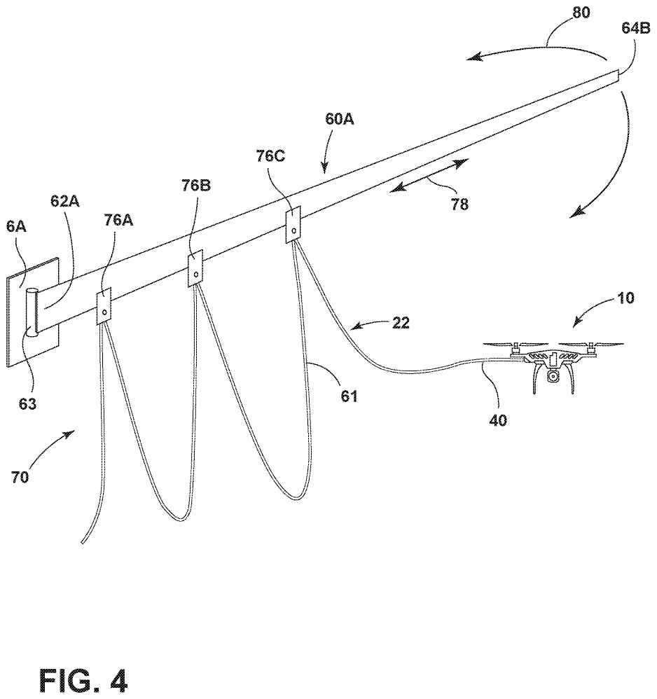

Referring now to FIG. 4, another embodiment of a support member 60A is shown, wherein support member 60A is a rigid member having first and second ends 62A, 62B. The first end 62A of support member 60A is contemplated to be mounted to a wall, such as wall 6 of the processing facility 3, by wall plate 6A in such a manner that support member 60A can pivot at the first end 62A thereof. Thus, it is contemplated that a hinge mechanism 63 provides for pivoting movement of support member 60A along the rotational path as indicated by arrow 80. In this way, support member 60A provides for a radius of coverage defined by the length of support member 60A for autonomous vehicle 10. The carrier assemblies 76A, 76B and 76C may be fixedly mounted to support member 60A, or the carrier assemblies 76A, 76B and 76C may move along the length of support member 60A as needed along the path as indicated by arrow 78. With respect to both FIGS. 3 and 4, it is contemplated that more or fewer carrier assemblies may be provided as necessary to properly support the tether assembly 22.

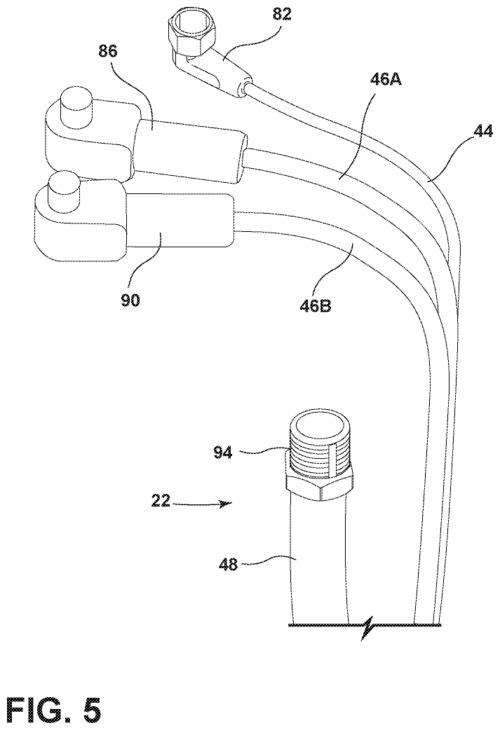

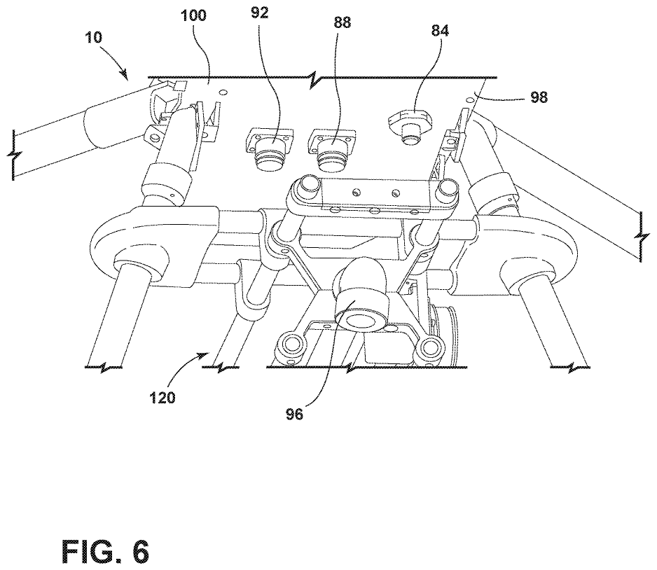

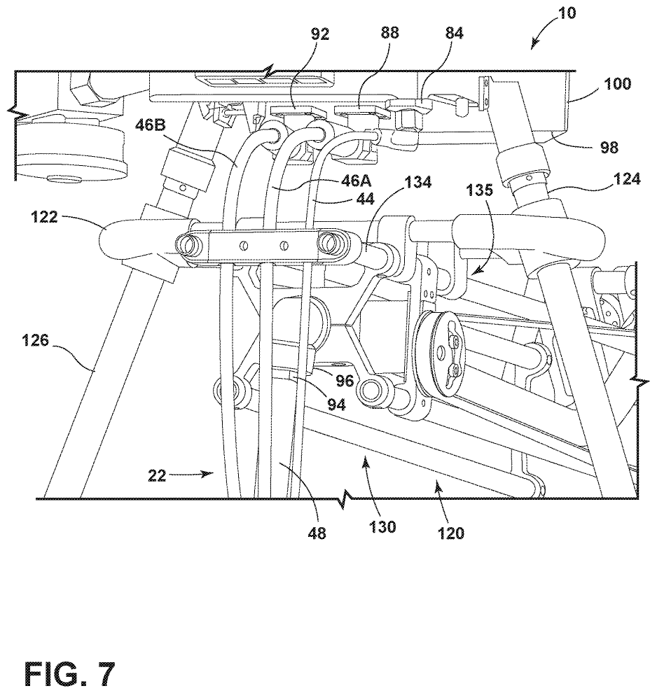

Referring now to FIGS. 5-7, the tether assembly 22 is shown as comprised of its component parts. As specifically shown in FIG. 5, the tether assembly 22 includes the data lead 44, the first and second power leads 46A and 46B, and the supply line 48. The data lead 44 includes a connector 82 that is configured to connect the data lead 44 to autonomous vehicle 10 at a data connector 84 of autonomous vehicle 10. The first and second power leads 46A and 46B are contemplated to be positive and negative DC power leads, respectively. The first power lead 46A includes a connector 86 that is configured to connect the first power lead 46A to autonomous vehicle 10 at a first power connector 88 of autonomous vehicle 10. The second power lead 46B includes a connector 90 that is configured to connect the second power lead 46B to autonomous vehicle 10 at a second power connector 92 of autonomous vehicle 10. While the power configuration for the tether assembly 22 is shown as having first and second power leads 46A, 46B, it is contemplated that a single power lead may be used to power autonomous vehicle 10. The first and second power connectors 88, 92 and the data connector 84 of autonomous vehicle 10 are shown provided on an underside 98 of body portion 100 of autonomous vehicle 10 in FIG. 6. The reciprocal connector 96 of autonomous vehicle 10 is further shown in FIG. 6 as positioned at a rear portion of a spray arm 120 of autonomous vehicle 10. The connections between the component parts of the tether assembly 22 and the connectors 84, 88, 92 and 96 of autonomous vehicle 10 are best illustrated in FIG. 7.

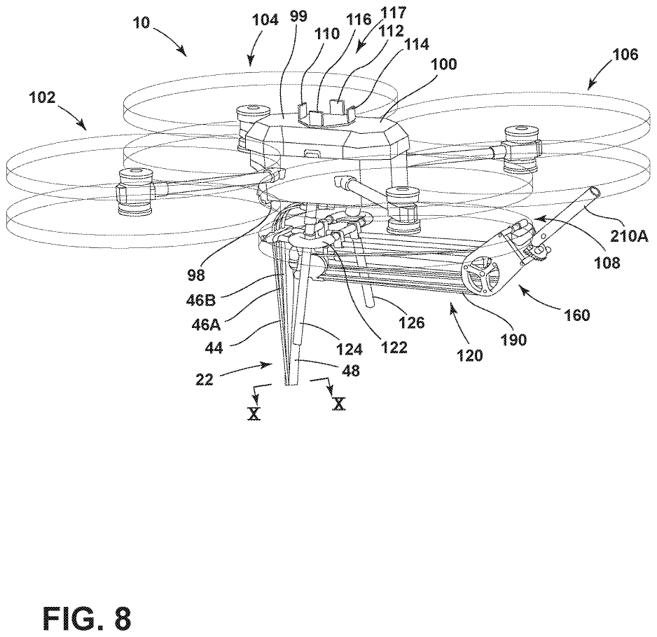

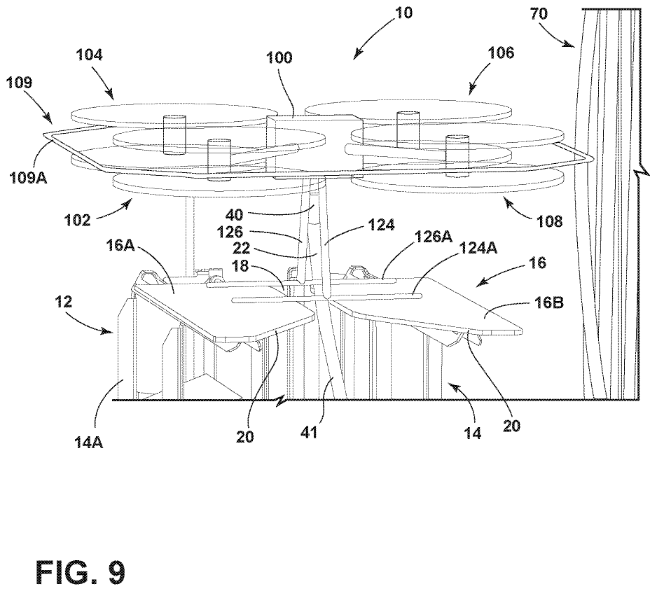

Referring now to FIG. 8, autonomous vehicle 10 is shown having body portion 100 thereof supporting a plurality of outwardly extending rotor assemblies indicated at reference numerals 102, 104, 106 and 108. It is contemplated that autonomous vehicle 10 may include more or fewer rotor assemblies as necessary to carry out a flight routine during a cleaning or sanitizing procedure. With reference to the embodiment shown in FIG. 9, autonomous vehicle 10 may also include a guard assembly 109 that includes a frame member 109A that surrounds the rotor assemblies 102, 104, 106 and 108 to protect the same from hitting objects during a cleaning or sanitizing procedure. As noted above, the data lead 44 and the first and second power leads 46A, 46B of the tether assembly 22 are shown coupled to body portion 100 of autonomous vehicle 10 at the underside 98 thereof. Along an upper surface 99 of body portion 100 of autonomous vehicle 10, a plurality of cameras 117 is positioned as indicated at reference numerals 110, 112, 114, and 116. The cameras 110, 112, 114, and 116 provide optical sensors for autonomous vehicle 10 for assisting in the cleaning and sanitizing of a processing facility, as further described below. More or fewer cameras may be provided on autonomous vehicle 10 as needed. It is contemplated that the tether assembly 22 and the cameras 110, 112, 114, and 116 may be coupled to other portions of body portion 100 of autonomous vehicle 10 without departing from the spirit of the present concept. As noted above, the supply line 48 of the tether assembly 22 is operably coupled to the spray arm 120 of autonomous vehicle 10 for providing a cleaning solution thereto.

As further shown in FIG. 8, the spray arm 120 of autonomous vehicle 10 is operably coupled to a bracket 122 that is positioned below body portion 100 of autonomous vehicle 10. The bracket 122 interconnects first and second legs 124, 126 that downwardly extend from the underside 98 of body portion 100 of autonomous vehicle 10. This configuration is best shown in FIG. 7. In use, the first and second legs 124, 126 are configured to support autonomous vehicle 10 in an upright position on a landing surface, such as the landing platform 16 of base station 12, as best shown in FIGS. 1 and 2. Specifically, as shown in FIGS. 1 and 2, the first leg 124 of autonomous vehicle 10 is shown supported on the first portion 16A of the landing platform 16, and the second leg 126 of autonomous vehicle 10 is shown supported on second portion 16B of the landing platform 16. Like the first and second portions 16A, 16B of the landing platform 16, the first and second legs 124, 126 of autonomous vehicle 10 are spaced-apart from each other to accommodate the receiving area 18 positioned between the first and second portions 16A, 16B of the landing platform 16. With reference to FIG. 9, first and second legs 124, 126 of autonomous vehicle 10 may also include footings 124A, 126A that allow for the first and second legs 124, 126 to span the receiving area 18, such that each of the footings 124A, 126A are abuttingly supported on the upper surfaces 17A, 17B of the first and second portions 16A, 16B of the landing platform 16. In the configuration shown in FIG. 9, the tether assembly 22 is shown received in the receiving area 18. It is contemplated that any number of legs may be provided on autonomous vehicle 10 to adequately support autonomous vehicle 10 in an upright position on the landing platform 16, or any other intended landing surface.

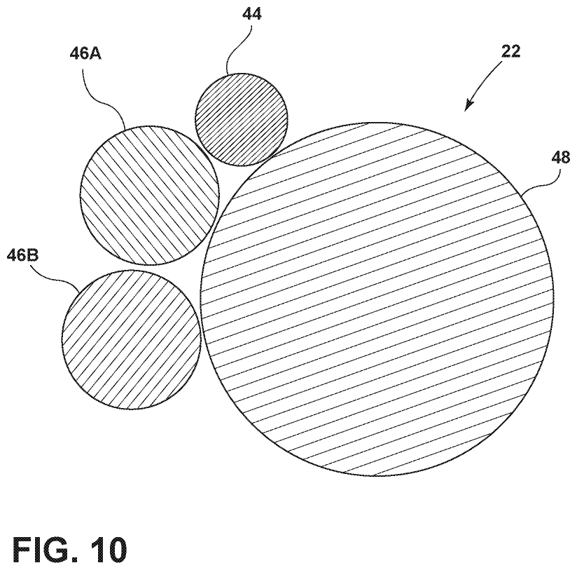

Referring now to FIG. 10, the tether assembly 22 is shown from a cross-sectional view wherein the first and second power leads 46A, 46B, the data lead 44 and the supply line 48 are shown in a bundled configuration. As noted above, the engagement members 79 are configured to retain the first and second power leads 46A, 46B, the data lead 44 and the supply line 48 in the bundled configuration as the tether assembly 22 moves between the deployed and stowed positions.

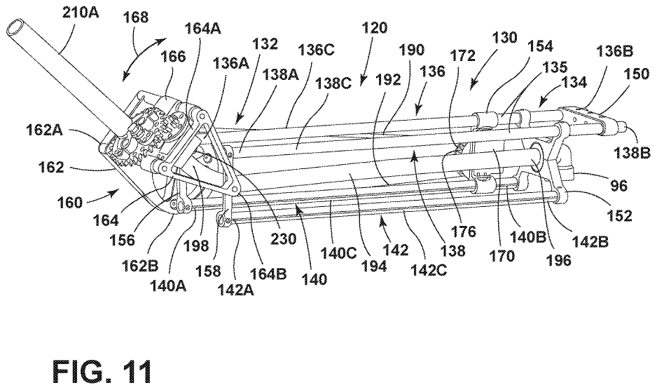

Referring now to FIG. 11, the spray arm 120 includes a frame assembly 130 having front and rear portions 132, 134. In assembly, the rear portion 134 of the frame assembly 130 of the spray arm 120 is generally positioned below body portion 100 of autonomous vehicle 10 and includes a connection point 135 for coupling the frame assembly 130 to autonomous vehicle 10, as best shown in FIG. 7. In the embodiment shown in FIG. 11, the frame assembly 130 includes first and second upper frame members 136, 138 that are spaced-apart from one another and that extend horizontally in a generally parallel manner relative to one another between the front and rear portions 132, 134 of the frame assembly 130. Specifically, the first upper frame member 136 includes first and second ends 136A, 136B with a body portion 136C disposed therebetween. Similarly, the second upper frame member 138 includes first and second ends 138A, 138B with a body portion 138C disposed therebetween. The frame assembly 130 further includes first and second lower frame members 140, 142 that are spaced-apart from one another and that extend horizontally in a generally parallel manner relative to one another between the front and rear portions 132, 134 of the frame assembly 130. As shown in FIG. 11, the first and second lower frame members 140, 142 are positioned below the first and second upper frame members 136, 138 and are generally parallel thereto. Like the first upper frame member 136, the first lower frame member 140 includes first and second ends 140A, 140B with a body portion 140C disposed therebetween. Similarly, the second lower frame member 142 includes first and second ends 142A, 142B with a body portion 142C disposed therebetween. As shown in FIG. 11, the frame assembly 130 extends in a generally horizontal manner between the front and rear portions 132, 134 thereof, such that the frame assembly 130 is an elongate frame assembly that allows for clearance from the rotor assemblies 102, 104, 106 and 108 of autonomous vehicle 10, as best shown in FIG. 8. In this way, the frame assembly 130 provides a means for autonomous vehicle 10 to spray cleaning or sanitizing solutions within a processing facility, without the spray being hindered by the rotor assemblies 102, 104, 106 and 108 of autonomous vehicle 10.

In the embodiment shown in FIG. 11, a bracket 150 interconnects the second ends 136B and 138B of the first and second upper frame members 136, 138 of the frame assembly 130. As further shown in the embodiment of FIG. 11, a rear bracket 152 interconnects the first and second upper frame members 136, 138 as well as the first and second lower frame members 140, 142. The rear bracket 152 also serves as a connecting location for the reciprocal connecting feature 96 of the spray arm 120 for connecting to the supply line 48 of the tether assembly 22, as described above. An intermediate bracket 154 interconnects the first upper frame member 136 and the first lower frame member 140. The frame assembly 130 further includes first and second front brackets 156, 158. The first front bracket 156 interconnects the first upper frame member 136 and the first lower frame member 140 at the first ends 136A, 140A thereof. The second front bracket 158 interconnects the second upper frame member 138 and the second lower frame member 142 at the first ends 138A, 142A thereof. In assembly, the first and second front brackets 156, 158 are configured to support a spray head assembly 160 of the spray arm 120 in an articulating manner, as further described below.

With further reference to FIG. 11, the spray head assembly 160 includes first and second frame members 162, 164 which each include front and rear portions 162A, 162B and 164A, 164B, respectively. The rear portion 162B of the first frame member 162 of the spray head assembly 160 is pivotally coupled to the first front bracket 156 of the frame assembly 130 of the spray arm 120. Similarly, the rear portion 164B of the second frame member 164 of the spray head assembly 160 is pivotally coupled to the second front bracket 158 of the frame assembly 130 of the spray arm 120. The spray head assembly 160 further includes a front frame member 166 that interconnects the first and second frame members 162, 164. The pivoting connections between the first and second frame members 162, 164 and the frame assembly 130 of the spray arm 120 allows for the spray head assembly 160 to pivot along the rotational path as indicated by arrow 168. In this way, the spray head assembly 160 can direct spray from autonomous vehicle 10 in an upward and downward directions, and all angled directions therebetween. Movement of the spray head assembly 160 is controlled using a drive assembly, as further described below.

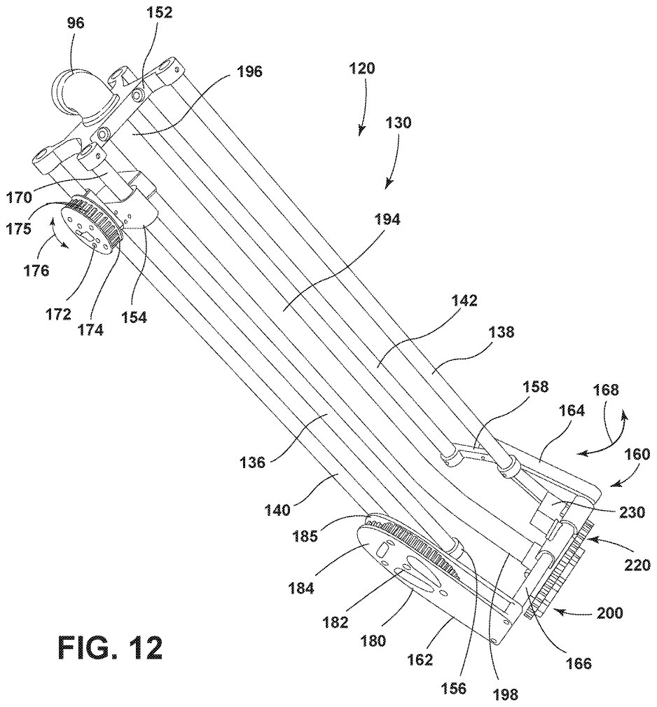

With reference to FIGS. 11 and 12, a motor 170 is coupled to the intermediate bracket 154 of the frame assembly 130 and is further coupled to a drive wheel 172. In use, the motor 170 is configured to drive rotation of the drive wheel 172 in forward and reverse directions along the path as indicated by arrow 176. The drive wheel 172 includes a track portion 174 having a plurality of teeth 175 disposed there around, as best shown in FIG. 12. With further reference to FIG. 12, the first frame member 162 of the spray head assembly 160 includes a circular member 180 that is pivotally coupled to the first front bracket 156 of the frame assembly 130 of the spray arm 120 at a generally centrally disposed location 182. Circular member 180 of the first frame member 162 of the spray head assembly 160 includes a track portion 184 having a plurality of teeth 185 disposed therearound. In assembly, the drive wheel 172 and the circular member 180 are operably coupled to one another using a belt member 190, as specifically shown in FIGS. 8 and 11. The belt member 190 includes an engagement side 192 having a plurality of teeth configured to engage the teeth 175 of the drive wheel 172 and to further engage the teeth 185 of the circular member 180 of the first frame member 162 of the spray head assembly 160. In this way, as the motor 170 powers rotational movement of the drive wheel 172 along the forward and rearward directions as indicated by arrow 176, the belt member 190 rotates and translates the rotational movement of the drive wheel 172 to the first frame member 162 of the spray head assembly 160. This movement further translates rotation of the spray head assembly 160 along the rotational path as indicated by arrow 168 between upward and downward directions. It is contemplated that the motor 170 is powered using power leads from autonomous vehicle 10. It is also contemplated that the motor 170 can be directly coupled between the frame assembly 130 of the spray arm 120 and the spray head assembly 160 for driving movement of the same.

As further shown in FIGS. 11 and 12, the reciprocal connector 96 of the spray arm 120 is shown coupled to a supply tube 194. Specifically, the reciprocal connector 96 of the spray arm 120 is coupled to a first end 196 of the supply tube 194. A second end 198 of the supply tube 194 is coupled to the front frame member 166 of the spray head assembly 160. In this way, the supply tube 194 provides solution (e.g. fluid) from supply line 48 of the tether assembly 22 through the frame assembly 130 of the spray arm 120 to the spray head assembly 160.

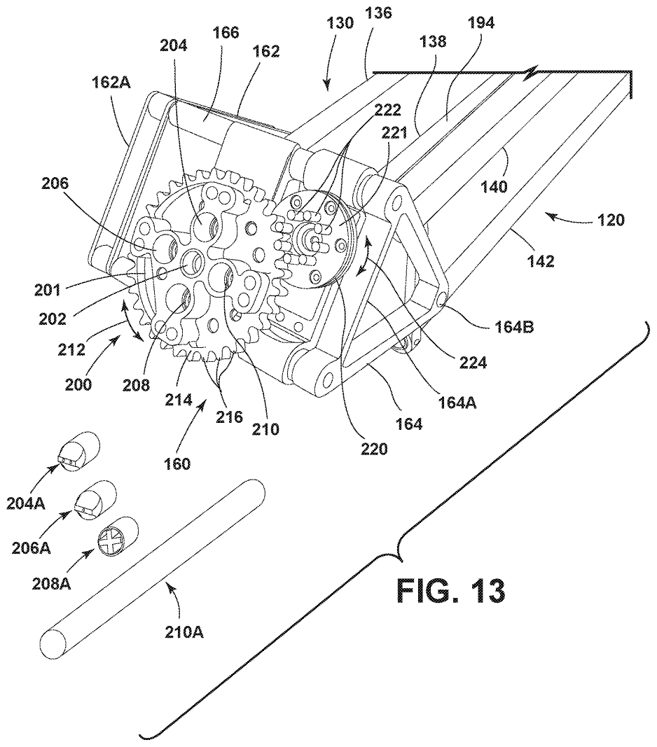

Referring now to FIG. 13, the spray head assembly 160 includes a plate 200 that is pivotally mounted to the front frame member 166 of the spray head assembly 160 in a generally central location 202. Plate 200 includes a plurality of receiving wells 204, 206, 208 and 210 disposed around a body portion 201 of plate 200. In assembly, the receiving wells 204, 206, 208 and 210 are configured to receive various spray head tips, such as the spray head tips identified at reference numerals 204A, 206A, 208A and 210A. In this way, plate 200 of the spray head assembly 160 can provide various spray patterns using the different spray head tips that may be specifically suited to handle particular solutions provided from the tether assembly 22. In the embodiment shown in FIG. 13, it is contemplated that the uppermost receiving well of plate 200 aligns with the second end 198 of the supply tube 194 of the spray arm 120. As such, in the configuration shown in FIG. 13, the receiving well 204 is positioned in alignment with the supply tube 194. The spray head tips 204A, 206A, 208A and 210A may be positioned in any one of the receiving wells 204, 206, 208 and 210 of plate 200 for providing various spray patterns. For purposes of this disclosure, it will be assumed that the spray head tips 204A, 206A, 208A and 210A are each located respectively in the receiving wells 204, 206, 208 and 210 of plate 200. As noted above, plate 200 is pivotally mounted to the front frame member 166 of the spray head assembly 160. Thus, as plate 200 rotates in a rotational direction as indicated by arrow 212, a different receiving well and associated spray head tip will be aligned with the supply tube 194 to provide a different spraying pattern. For instance, if plate 200 rotates in a clockwise direction from the position shown in FIG. 13, the next receiving well to align with the supply tube 194 will be receiving well 206. As such, in such a rotational movement, plate 200 will go from providing a spray pattern provided by spray head tip 204A to a spray pattern provided by spray head tip 206A. The different spray head tips can be used to provide different spray patterns or can be used to accommodate specific solutions provided from base station 12. Spray head tip 210A provides an elongated hollow tube that can be used to directionally spray a solution in a concentrated stream. Spray head tip 210A is best shown coupled to the spray head assembly 160 in FIGS. 8 and 11. Spray head tip 210A provides additional clearance from the rotor assemblies 102, 104, 106 and 108 of autonomous vehicle 10 by extending beyond a perimeter defined by the rotor assemblies 102, 104, 106 and 108 of autonomous vehicle 10. In this way, the spray head tip 210A can be used to spray an area vertically positioned above autonomous vehicle 10.

With further reference to FIG. 13, plate 200 includes an outer circumference 214 having a plurality of teeth 216 disposed therealong. As further shown in FIG. 13, a drive wheel 220 is coupled to the front frame member 166 includes a plurality of engagement members 222 extending outwardly from a body portion 221 thereof. As shown in FIG. 13, the engagement members 222 of the drive wheel 220 are engaged with the teeth 216 of plate 200 in a geared manner, such that rotation of the drive wheel 220 drives rotation of plate 200. The drive wheel 220 is configured to be driven in the rotational direction as indicated by arrow 224 by a motor 230 best shown in FIGS. 11 and 12. The motor 230 is configured to be powered by autonomous vehicle 10 via a power lead.

Thus, the spray arm 120 shown in FIGS. 11-13 includes an articulating spray head assembly 160 with a rotating selection of spray tip heads via the rotating plate 200. In this way, the spray arm 120 of the present concept can provide specific spraying configurations that are optimized for spraying a foaming agent, a sanitizer, water, any combination thereof, or any other solution provided from base station 12.

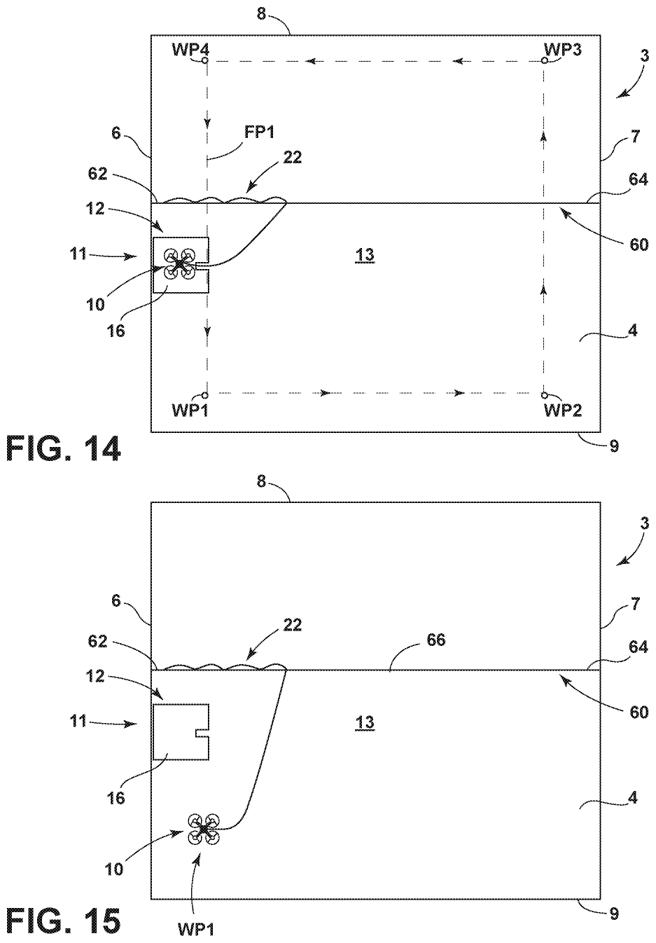

Referring now to FIGS. 14-18, the operation of autonomous cleaning system 11 will be described. With specific reference to FIG. 14, autonomous cleaning system 11 is shown positioned within a processing facility 3. Processing facility 3 includes walls 6, 7, 8 and 9 which define an area 13 to be cleaned and sanitized. It is contemplated that area 13 can include any configuration and have any amount of processing equipment positioned therein. Autonomous cleaning system 11 of the present concept is contemplated to clean not only area 13, but the equipment positioned therein. As further shown in FIG. 14, autonomous vehicle 10 is supported on the landing platform 16 of base station 12 in a home position. With autonomous vehicle 10 in the home position, the tether assembly 22 is in the stowed position. As shown in FIGS. 14-18, the tether assembly 22 is supported on support member 60 for movement between the stowed and deployed positions. As further shown in FIG. 14, a flight path FP1 is marked in broken lines around the processing facility 3. It is contemplated that flight path FP1 is a predetermined flight path that is programmed into autonomous cleaning system 11 by a user. There are a number of ways in which flight path FP1 can be programmed into autonomous cleaning system 11. In one method, a user can fly the drone along a flight path to create a routine. The routine can be saved in the control panel 34 and recalled by a user using user interface 35. Further, it is contemplated that autonomous vehicle 10 can navigate area 13 using one or more of the cameras 110, 112, 114 and 116 mounted thereon. For example, any combination of the cameras 110, 112, 114 and 116 can be used to perform visual inertial odometry wherein the state (i.e. the opposing velocity) of autonomous vehicle 10 is estimated using input from one or more of the cameras 110, 112, 114 and 116 plus one or more inertial measuring units that may be provided on autonomous vehicle 10. Thus, a user can pilot the drone along a flight path while the position of autonomous vehicle 10 is recorded in a log file. The log file can record not only the position of autonomous vehicle 10, but the position of the spray head assembly 160 and the position of the spray head plate 200. Further, the log file can record the state of the valves 24, 26 and 28 (open, closed or a position therebetween) to determine which solution, or combination thereof, will be provided to the spray arm 120. The training software for creating a flight path routine will take the log file and drop waypoints in select time intervals along the flight path. The waypoints become the flight path that is loaded onto autonomous vehicle 10, such that autonomous vehicle 10 can fly the flight path from waypoint to waypoint. One or more of the cameras 110, 112, 114 and 116 of autonomous vehicle 10 will utilize visual inertial odometry to ensure that autonomous vehicle 10 is reaching each waypoint of the flight path. In this way, autonomous vehicle 10 creates a predetermined flight path that can be repeated and stored within the control panel 34 for selective recall when needed.

In the example provided in FIG. 14, flight path FP1 includes four waypoints WP1, WP2, WP3 and WP4. In this simplified example, it is contemplated that autonomous vehicle 10 will fly to the waypoints in order. Autonomous vehicle 10 is positioned at the first waypoint WP1 in FIG. 15. Thus, it is contemplated that autonomous vehicle 10 has flown from the home position shown in FIG. 14 to the first waypoint WP1 shown in FIG. 15. Autonomous vehicle 10 is positioned at the second waypoint WP2 in FIG. 16. Thus, it is contemplated that autonomous vehicle 10 has flown from the first waypoint WP1 shown in FIG. 15 to the second waypoint WP2 shown in FIG. 16. Autonomous vehicle 10 is positioned at the third waypoint WP3 in FIG. 17. Thus, it is contemplated that autonomous vehicle 10 has flown from the second waypoint WP2 shown in FIG. 16 to the third waypoint WP3 shown in FIG. 17. Autonomous vehicle 10 is positioned at the fourth waypoint WP4 in FIG. 18. Thus, it is contemplated that autonomous vehicle 10 has flown from the third waypoint WP3 shown in FIG. 17 to the fourth waypoint WP4 shown in FIG. 18. At the various waypoints WP1-WP4 of flight path FP1, autonomous vehicle 10 can spray a solution within area 13 to clean or sanitize the same.

In an exemplary cleaning and sanitizing procedure, it is contemplated that autonomous cleaning system 11 will deploy autonomous vehicle 10 to rinse area 13 along flight path FP1. Thus, it is contemplated that the configuration of the valves 24, 26 and 28 of base station 12 will be such that clean water is supplied to autonomous vehicle 10 through the tether assembly 22 and sprayed from the spray arm 120 through the appropriate spray head tip of the spray head assembly 160. After the rinse cycle is completed, autonomous cleaning system 11 will deploy autonomous vehicle 10 to cover area 13 with a cleaning foam. Thus, it is contemplated that the configuration of the valves 24, 26 and 28 of base station 12 will be such that a foaming solution is supplied to autonomous vehicle 10 through the tether assembly 22 and sprayed from the spray arm 120 through the appropriate spray head tip of the spray head assembly 160. After the foaming solution is applied to area 13, autonomous cleaning system 11 will wait for a set time interval for the foaming solution to actively break down or loosen debris within the area. After the time interval has passed, autonomous cleaning system 11 will once again deploy autonomous vehicle 10 to rinse area 13 with clean water. Thus, it is contemplated that the configuration of the valves 24, 26 and 28 of base station 12 will revert to the setting providing the clean water to autonomous vehicle 10 through the tether assembly 22 and sprayed from the spray arm 120 through the appropriate spray head tip of the spray head assembly 160. After the cleaning procedure is completed, autonomous cleaning system 11 will begin a sanitizing cycle. For this, autonomous cleaning system 11 will once again deploy autonomous vehicle 10 to sanitize area 13 with a sanitizing solution. Thus, it is contemplated that the configuration of valves 24, 26 and 28 of base station 12 will be configured to a setting that provides a sanitizing solution to autonomous vehicle 10 through the tether assembly 22 and sprayed from the spray arm 120 through the appropriate spray head tip of the spray head assembly 160. When the sanitizing procedure is complete, autonomous vehicle 10 can return to the home position at landing platform 16 of base station 12.

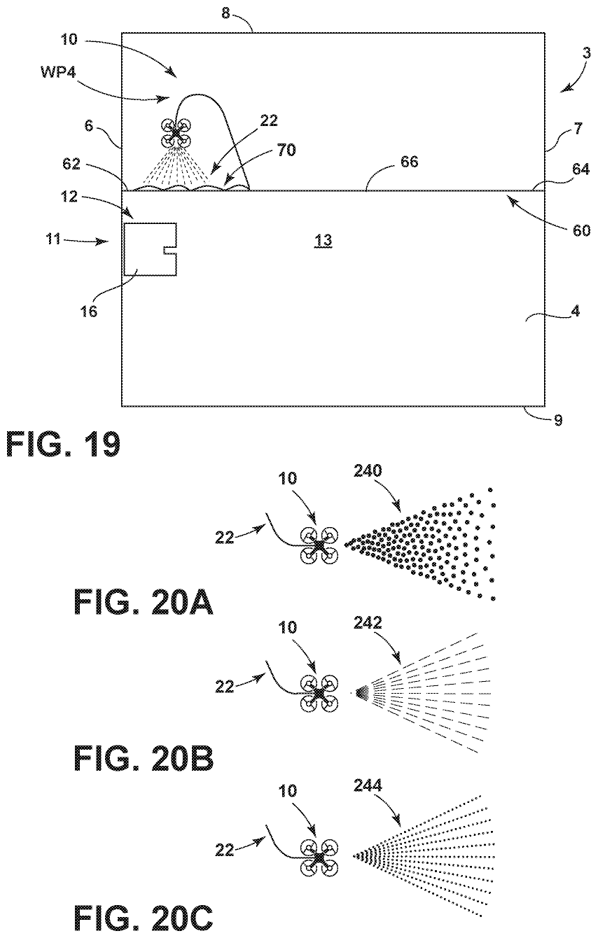

Referring now to FIG. 19, it is contemplated that autonomous vehicle 10 can also clean the tether assembly 22 after a cleaning or sanitizing procedure. As shown in FIG. 19, autonomous vehicle 10 is positioned facing the festooned configuration of the tether assembly 22. From here, autonomous vehicle 10 can rinse, foam, rinse and sanitize the tether assembly 22. In this way, autonomous cleaning system of the present concept provides a method for cleaning not only area 13 of the processing facility, but also the component parts of autonomous cleaning system 11.

Referring now to FIG. 20A, autonomous vehicle 10 is shown providing a foam spray pattern 240, wherein a foaming solution is sprayed from the spray arm 120 of autonomous vehicle 10 using the appropriate spray he go ad tip.

Referring now to FIG. 20B, autonomous vehicle 10 is shown providing a rinse spray pattern 242, wherein clean water is sprayed from the spray arm 120 of autonomous vehicle 10 using the appropriate spray head tip.

Referring now to FIG. 20C, autonomous vehicle 10 is shown providing a sanitizing spray pattern 244, wherein a sanitizing solution is sprayed from the spray arm 120 of autonomous vehicle 10 using the appropriate spray head tip.

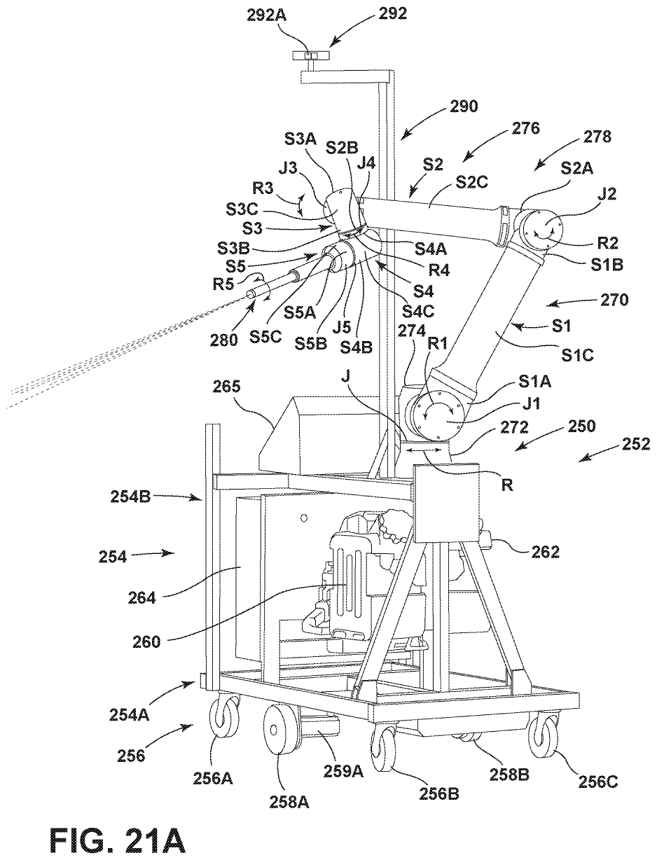

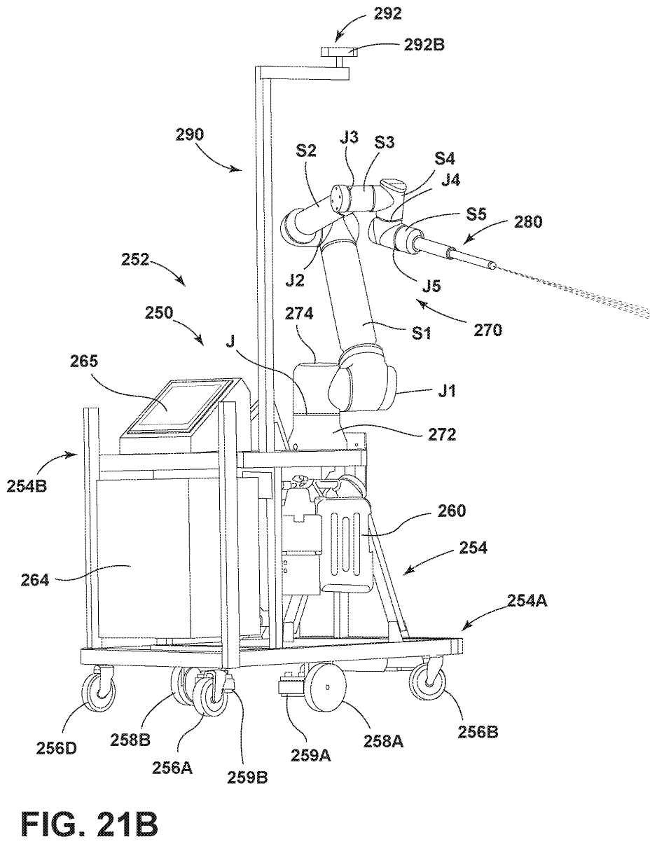

Referring now to FIG. 21A, the reference numeral 250 generally designates an autonomous vehicle according to another embodiment of the present invention. Autonomous vehicle 250 is in and of itself an autonomous cleaning system 252, in that autonomous vehicle 250 is the mobile unit that can carry with it features similar to those discussed above with reference to base station 12 (FIGS. 1, 2). Autonomous vehicle 250 includes a frame assembly 254 having a lower portion 254A and an upper portion 254B. A plurality of casters 256 are identified in FIGS. 21A and 21B as casters 256A-256D which are operably coupled to the lower portion 254A of the frame assembly 254. The casters 256A-256D may be fixed or freely rotating casters or any combination thereof, such that autonomous vehicle 250 can be movably supported on a support surface in all directions necessary to clean a facility. In the embodiment shown in FIGS. 21A, 21B, the casters 256A-256D are positioned adjacent corner portions of the lower portion 254A of the frame assembly 254. Drive wheels 258A and 258B are also supported on the lower portion 254A of the frame assembly 254 of autonomous vehicle 250 at an intermediate portion thereof. The drive wheels 258A, 258B define a powered drive system that is configured to power movement of autonomous vehicle 250 about a facility. In the embodiment shown in FIGS. 21A and 21B, the drive wheels 258A, 258B are positioned on opposite sides of the lower portion 254A of the frame assembly 254 at intermediate portions thereof but may be disposed at any location on the lower portion 254A of the frame assembly 254 in order to properly power movement of autonomous vehicle 250. Powered movement is contemplated to be provided by motors 259A, 259B which are associated with the drive wheels 258A, 258B, respectively, for driving forward and rearward rotation of the drive wheels 258A, 258B.

In the embodiment shown in FIGS. 21A and 21B, first and second containers 260, 262 are supported on the frame assembly 254. The first and second containers 260, 262 are akin to the first and second containers 30, 32 described above with reference to FIGS. 1 and 2. Thus, the first and second containers 260, 262 are contemplated to hold various cleaning and sanitizing compositions, as described above. In use, the first and second containers 260, 262 are fluidically coupled to one or more valves for selectively delivering a foaming solution or sanitizing solution to a robotic spray arm 270, as further described below. The first and second containers 260, 262 are contemplated to be replaceable containers that can be easily replaced with full containers by a user when the solution in either container is depleted. In this way, the first and second containers 260, 262 define solution sources for autonomous vehicle 250 to draw from when spraying within a facility. Like the first and second containers 30, 32, the first and second containers 260, 262 define one or more solution sources for autonomous vehicle 250.

A control panel 264 is supported on the lower portion 254A of the frame assembly 254 and can be accessed by a user for controlling or programming autonomous cleaning system 252. Specifically, the control panel 264 may include a user interface 265 in the form of a touchscreen or other like interface for a user to access for programming features of autonomous vehicle 250 or running autonomous cleaning system 252. In the embodiment shown in FIGS. 21A and 21B, user interface 265 is supported on the upper portion 254B of the frame assembly 254.

As further shown in FIGS. 21A and 21B, the embodiment of autonomous vehicle 250 illustrated therein includes a robotic spray arm 270 that is used to conduct a cleaning or sanitizing procedure, as further described below. In the embodiment shown in FIGS. 21A and 21B, the robotic spray arm 270 includes a base portion 272 that is supported on the upper portion 254B of the frame assembly 254. The base portion 272 is coupled to and supports a mounting portion 274 in a rotatable manner at joint J. As such, it is contemplated that mounting portion 274 can rotate relative to the base portion 272 in a programmable manner along the path as indicated by arrow R. The robotic spray arm 270 includes a plurality of sections 276 connected by a plurality of articulating joints 278. As specifically shown in the embodiment of FIGS. 21A and 21B, the plurality of sections 276 of the robotic spray arm 270 includes sections S1-S5. As further shown in the embodiment of FIGS. 21A and 21B, the plurality of articulating joints 278 of the robotic spray arm 270 includes articulating joints J1-J5 provided between the sections S1-S5. A first section S1 of the robotic spray arm 270 defines a proximal end of the robotic spray arm 270 and includes a first end S1A and a second end S1B with a body portion S1C disposed therebetween. The first end S1A of the first section S1 is operably coupled to mounting portion 274 at an articulating joint J1, thereby providing for rotating movement of the first section S1 along the path as indicated by arrow R1. The first section S1 is operably coupled to a second section S2 at an articulating joint J2. The second section S2 of the robotic spray arm 270 includes a first end S2A and a second end S2B with a body portion S2C disposed therebetween. The second end S1B of the first section S1 is operably coupled to the first end S2A of the second section S2 at articulating joint J2, thereby providing for rotating movement of the second section S2 of the robotic spray arm 270 along the path as indicated by arrow R2. The second section S2 is operably coupled to a third section S3 at an articulating joint J3. The third section S3 of the robotic spray arm 270 includes a first end S3A and a second end S3B with a body portion S3C disposed therebetween. The second end S2B of the second section S2 is operably coupled to the first end S3A of the third section S3 at articulating joint J3, thereby providing for rotating movement of the third section S3 of the robotic spray arm 270 along the path as indicated by arrow R3. The third section S3 is operably coupled to a fourth section S4 at an articulating joint J4. The fourth section S4 of the robotic spray arm 270 includes a first end S4A and a second end S4B with a body portion S4C disposed therebetween. The second end S3B of the third section S3 is operably coupled to the first end S4A of the fourth section S4 at articulating joint J4, thereby providing for rotating movement of the fourth section S4 of the robotic spray arm 270 along the path as indicated by arrow R4. The fourth section S4 is operably coupled to a fifth section S5 at an articulating joint J5. The fifth section S5 of the robotic spray arm 270 defines a distal end of the robotic spray arm 270 and includes a first end S5A and a second end S5B with a body portion S5C disposed therebetween. The second end S4B of the fourth section S4 is operably coupled to the first end S5A of the fifth section S5 at articulating joint J5, thereby providing for rotating movement of the fifth section S5 of the robotic spray arm 270 along the path as indicated by arrow R5. It is contemplated that the robotic spray arm 270 may include as many sections and articulating joints as necessary to provide the desired movement of the robotic spray arm 270 for adequately maneuvering during an autonomous cleaning or sanitizing procedure. As further shown in FIGS. 21A and 21B, the robotic spray arm 270 also includes a spray nozzle 280 that is coupled to the distal end of the robotic spray arm 270 at the fifth section S5.

The robotic spray arm 270 is contemplated to be an electronically powered device with motors positioned at each articulating joint J-J5 of the plurality of articulating joints 278. In this way, the robotic spray arm 270 can be programmed to move as needed to execute a cleaning or sanitizing procedure.

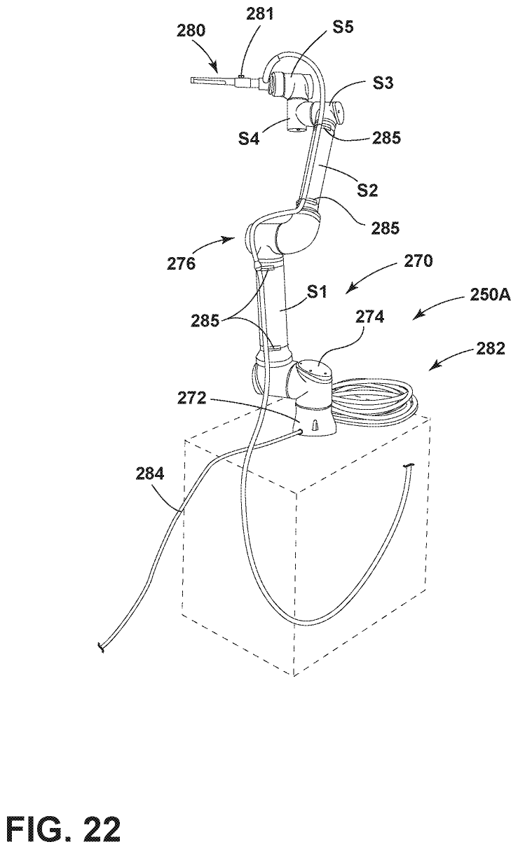

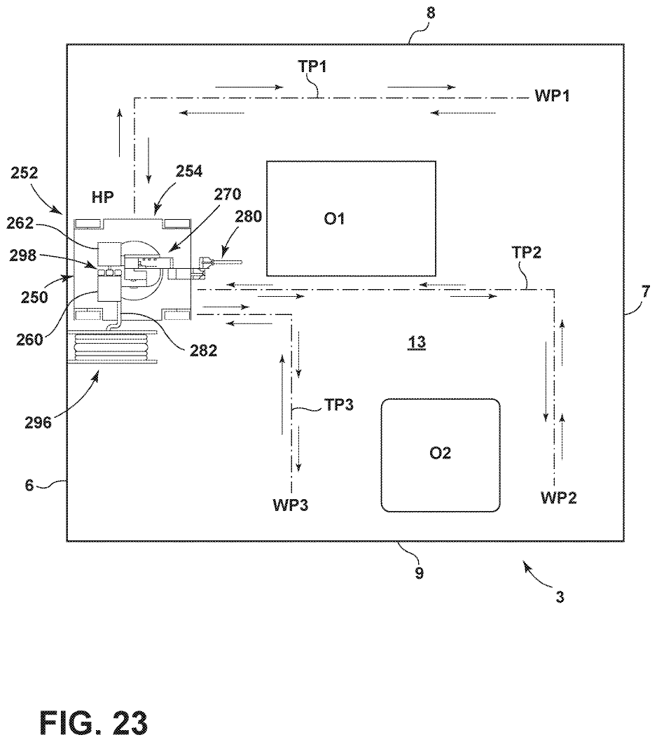

Referring now to FIG. 22, the robotic spray arm 270 is shown in another embodiment of autonomous vehicle 250A, wherein a tether assembly 282 is shown coupled to the plurality of sections 276 of the robotic spray arm 270 by clips 285. Specifically, the tether assembly 282 is shown coupled to and extending along from the first section S1 to the fifth section S5 of the robotic spray arm 270. At the fifth section S5, the tether assembly 282 is coupled to the spray nozzle 280. The tether assembly 282 is contemplated to provide water to the robotic spray arm 270. With reference to FIGS. 21A and 21B, the water supplied by the tether assembly 282 is contemplated to intermix with the first and second containers 260, 262 for spraying a foaming agent, a sanitizer, water, or any combination thereof during a cleaning or sanitizing procedure. As such, it is contemplated that a valve assembly, similar to the valves 24, 26 and 28 discussed above, is present on autonomous vehicle 250 to provide for selective access to various solutions for intermixing with the water provided by the tether assembly 282. The tether assembly 282 may be mounted to a surface of a facility in which autonomous vehicle 250 is located and may be provided on a retractable wheel that pays out the tether assembly 282 as autonomous vehicle 250 moves about the facility. Movement of autonomous vehicle 250 and the associated payout of the tether assembly 282 is further described below with particular reference to FIG. 23.

As further shown in FIG. 22, a power supply line 284 may be provided to power movement of the robotic spray arm 270. The power supply line 284 may be housed on the frame assembly 254 of autonomous vehicle 250 in a battery-powered version of autonomous vehicle 250 to interconnect the robotic spray arm 270 with a battery power source. Further, it is contemplated that the power supply line 284 may be provided in a coupled configuration with the tether assembly 282 for selective payout as autonomous vehicle 250 moves about a facility. Thus, it is contemplated that autonomous vehicle 250 may be a battery-powered vehicle that can move freely about a facility without the need for tethered power. It is also contemplated that autonomous vehicle 250 can be supplied power through the tether assembly 282, when the tether assembly 282 is directly connected to a power source of facility 3.

With further reference to FIGS. 21A and 21B, autonomous vehicle 250 is shown having a mast 290 with a camera array 292 mounted thereto. Further, it is contemplated that autonomous vehicle 250 can navigate an area using one or more of the cameras of the camera array 292. For example, any combination of cameras of the camera array can be used to perform visual inertial odometry, wherein the state (i.e. the opposing velocity) of autonomous vehicle 250 is estimated using input from one or more of the cameras of the camera array 292 plus one or more inertial measuring units that may be provided on autonomous vehicle 250. Thus, a user can pilot autonomous vehicle 250 along a travel path while the position of autonomous vehicle 250 is recorded in a log file. The log file can record not only the position of autonomous vehicle 250, but the position of the robotic spray arm 270 and the position of the spray nozzle 280. Further, the log file can record the state of the valves, much like valves 24, 26 and 28 described above, as being in open, closed or partially open position to determine which solution, or combination thereof, will be provided to the robotic spray arm 270. The training software for creating a travel path routine will take the log file and drop waypoints in select time intervals along the travel path. The waypoints become the travel path that is loaded onto autonomous vehicle 250, such that autonomous vehicle 250 can move along the course of the travel path from waypoint to waypoint. The cameras of the camera array 292 of autonomous vehicle 250 may utilize visual inertial odometry to ensure that autonomous vehicle 250 is reaching each waypoint recorded in the travel path. In this way, autonomous vehicle 250 can record a predetermined travel path for executing a cleaning or sanitizing procedure within the facility. This predetermined travel path is a repeatable program that can be stored within a log file of the control panel 264 of autonomous vehicle 250 for selective recall as needed for a cleaning or sanitizing procedure.

It is contemplated that autonomous vehicle 250 may include at least 3 cameras. A first scene camera 292A (FIG. 21A) may be directed in a forward direction relative to autonomous vehicle 250 to identify the pathway of autonomous vehicle 250 moving in a forward direction. The first scene camera 292A may also identify objects or surfaces to be sprayed by the robotic spray arm 270. A second scene camera 292B (FIG. 21B) may be directed in a rearward direction relative to autonomous vehicle 250 to identify the path traveled by autonomous vehicle 250. The first and second scene cameras 292A, 292B may be mounted to the mast 290 and are contemplated to be part of the camera array 292, as shown in FIGS. 21A and 21B. In this way, the first and second scene cameras 292A, 292B of the camera array 292 can provide unobstructed views above the robotic spray arm 270. It is further contemplated that autonomous vehicle 250 may include a wrist camera 281 (FIG. 22) which functions as an end of arm tool for the robotic spray arm 270. The wrist camera 281 is contemplated to be mounted at the fifth section S5, or the distal section of the robotic spray arm 270, adjacent the spray nozzle 280. The first and second scene cameras of the camera array 292 along with the wrist camera 281 are contemplated to be able to detect movement to provide a safety feature in the form of an anti-collision detection for both the robotic spray arm 270 and autonomous vehicle 250 itself. Further, as monitoring an area to be sprayed, the wrist camera 281 can make a determination if the robotic spray arm 270 is about to spray a person or other moving object detected by the wrist camera 281. By monitoring movement within an area to be cleaned, the cameras described above can provide information to a user and can also provide information to a system, such that a shutdown or operational pause can be initiated. Once the cameras determine that the area is clear of movement or that the spray area is clear, a cleaning procedure can re-commence.

Referring now to FIG. 23, the operation of autonomous cleaning system 252 will be described. With specific reference to FIG. 23, autonomous cleaning system 252 is shown positioned within a processing facility 3, that is contemplated to be the same or similar to processing facility 3 described above. As such, the processing facility 3 includes walls 6, 7, 8 and 9 which define an area 13 to be cleaned and sanitized. It is contemplated that area 13 can include any configuration and have any amount of processing equipment positioned therein. In the embodiment shown in FIG. 23, area 13 includes a first object 01 and a second object 02. The first and second objects 01, 02 may be tables, processing equipment or any other fixture that may be used in a processing facility. Autonomous cleaning system 252 of the present concept is contemplated to clean not only area 13, but the equipment positioned therein, such as the first and second objects 01, 02. As further shown in FIG. 23, autonomous vehicle 250 is supported on a support surface or floor of area 13 to be cleaned. Autonomous vehicle 250 is positioned adjacent to a reel assembly 296 that is mounted to wall 6 of facility 3. In this position, autonomous vehicle 250 is contemplated to be in a home position HP. With autonomous vehicle 250 in home position HP, tether assembly 282 is in a stowed position. As shown in FIG. 23, tether assembly 282 is supported on the reel assembly 296 for accommodating movement between stowed and deployed positions.

As further shown in FIG. 23, a first travel path TP1 is marked in broken lines within area 13 of the processing facility 3. It is contemplated that the first travel path TP1 is a predetermined travel path that is programmed into autonomous cleaning system 252 by a user.

As further shown in FIG. 23, a second travel path TP2 is marked in broken lines within area 13 of the processing facility 3. It is contemplated that the second travel path TP2 is a predetermined travel path that is programmed into autonomous cleaning system 252 by a user.

As further shown in FIG. 23, a third travel path TP3 is marked in broken lines within area 13 of processing facility 3. It is contemplated that the third travel path TP3 is a predetermined travel path that is programmed into autonomous cleaning system 252 by a user.

As shown in FIG. 23, the first travel path TP1 has autonomous vehicle 250 moving from the home position HP towards wall 8, and then towards wall 7 to reach the first waypoint WP1. In a reverse operation, autonomous vehicle 250 returns along the first travel path TP1 from the first waypoint WP1 to the home position HP. While autonomous vehicle 250 moves from the home position HP to the first waypoint WP1, it is contemplated that the tether assembly 282 is paid out by the reel assembly 296, such that the tether assembly 282 lies on the support surface of area 13 in a general configuration as indicated by the first travel path TP1 while the tether assembly 282 is in the deployed position. As shown in FIG. 23, the first travel path TP1 has autonomous vehicle 250 traveling around the first object O1. As the first travel path TP1 includes a first movement from the home position HP to the first waypoint WP1 and second movement from the first waypoint WP1 back to the home position HP, it is contemplated that the tether assembly 282 is paid out along the first movement, and it is further contemplated that the tether assembly 282 is retracted by the reel assembly 296 along the second movement of autonomous vehicle 250 to the home position HP. Thus, the reel assembly 296 may be biased toward retraction of the tether assembly 282, such that slack in the tether assembly 282 is taken up by the reel assembly 296 as available. Further, it is contemplated that the reel assembly 296 is a powered reel assembly that can be programmed by a user for paying out the tether assembly 282 as autonomous vehicle 250 moves away from the home position HP, and reels in the tether assembly 282 as autonomous vehicle 250 returns to the home position HP. In either scenario, the tether assembly 282 is managed so as to not disrupt objects positioned within area 13 to be cleaned. The successive first and second movements of autonomous vehicle 250 from the home position HP (to the first waypoint WP1) and back again is carried out in a similar manner with respect to the second travel path TP2 and the second waypoint WP2, as well as the third travel path TP3 and the third waypoint WP3, as indicated by the arrows in FIG. 23. In this way, the travel paths TP1, TP2 and TP3 can be configured with the deployment of the tether assembly 282 along a fixed travel path from and back to the home position HP in a round-trip manner, such that the tether assembly 282 does not disrupt any fixtures within the processing facility 3, such as the first and second objects O1 and O2. By starting each travel path from the home position HP, autonomous vehicle 250 can move about area 13 of the processing facility 3 without concern of the tether assembly 282 getting tangled or stuck in any object that may be positioned within the processing facility 3.

As noted above, autonomous vehicle 250 includes a frame assembly 254 that is movably associated with a support surface provided within a facility, such as facility 3 described above. In providing a method of autonomously cleaning a facility, a user will program the movement of autonomous vehicle 250 along one or more travel paths to various waypoints within facility 3 in a round-trip manner between an associated waypoint and the home position HP of autonomous vehicle 250, as described above. The tether assembly 282 will pay out as autonomous vehicle 250 moves from the home position HP to an associated waypoint. The tether assembly 282 will retract as autonomous vehicle 250 returns from a waypoint towards the home position HP. As such, not only is the movement of autonomous vehicle 250 programmable, but the payout and retraction of the tether assembly 282 can also be a programmed method step that is configured by a user. As autonomous vehicle 250 moves along the various travel paths, the position of the spray nozzle 280 can be programmed in a manner so as to execute a cleaning or sanitizing procedure. As described above, the spray nozzle 280 is positioned adjacent a distal end of the robotic spray arm 270. Thus, it is contemplated that a user can program the robotic spray arm 270 to move the plurality of sections 276 thereof using the plurality of articulating joints 278 thereof to properly position the spray nozzle 280 to spray a solution within area 13 of facility 3 to be cleaned. As noted above, area 13 of facility 3 may include objects that are to be cleaned, such as the first and second objects 01 and 02 shown in FIG. 23, or the reel assembly 296 also shown in FIG. 23. Further, it is contemplated that autonomous vehicle 250 can be programmed to clean the tether assembly 282, preferably after a facility cleaning or sanitizing procedure. Thus, as autonomous vehicle 250 moves along a predetermined travel path, a programmed routine will be executed for the robotic spray arm 270 to move the spray nozzle 280 into a proper position for cleaning a desired area or object within facility 3.

The method of autonomously cleaning a facility further includes the selection of a solution to be sprayed from the spray nozzle 280 as provided thereto by the tether assembly 282. For this, a series of valves 298 (FIG. 23) may be provided between the containers 260, 262 to provide a liquid mixture made up of water and container contents to the spray nozzle via the tether assembly 282. As noted above, the solution provided through the tether assembly 282 may be water alone, a foaming agent, a sanitizing solution or any mixture thereof as needed for a cleaning or sanitizing procedure. It is contemplated that a standard cleaning procedure would include rinsing an area within a facility with water alone, applying a foaming agent to the area, allowing the foaming agent to break down debris within the area, and rinsing the area with water. After the area has been clean, a standard sanitizing procedure would likely include spraying the area with a sanitizing solution to disinfect the area. It is further contemplated that after a cleaning or sanitizing procedure, autonomous vehicle 250 can clean not only the tether assembly 282, but the reel assembly 296 and autonomous vehicle 250 itself as needed.

Thus, it is contemplated that a user will program 1) movement of autonomous vehicle along a travel path; 2) positioning of the spray nozzle using the robotic spray arm; 3) spray routines including pressure variations, solutions to be sprayed and solution temperatures, as well as spray tip selection and spray duration; and 4) tether assembly management.

With the previously described cameras (110, 112, 114, 116 and 117) on autonomous vehicle 10 and the cameras (281, 292, 292A, 292B) on autonomous vehicle 250, the system provides a vision-based or camera-based self-positioning estimation technology that enables highly accurate and robust self-positioning recognition of autonomous vehicles 10, 250 within facility 3. The self-positioning and mapping capabilities of autonomous vehicles 10, 250 may be provided using Simultaneous Localization and Mapping (SLAM) technology that allows autonomous vehicles 10, 250 to map their environment and localize themselves within that environment at the same time. Further, Light Detection and Ranging (LIDAR) technology can be used by autonomous vehicles 10, 250, wherein light in the form of a pulsed laser is used to measure ranges to adjacent surfaces and variable distances within an environment. It is contemplated that the cameras described above can provide 360° views of the environment in which an autonomous vehicle is located and also include the components necessary to carry out navigation of autonomous vehicles using Light Detection and Ranging (LIDAR) or Simultaneous Localization and Mapping (SLAM) technologies, for example. Further, the cameras described above can also scan location Indicators such as Quick Response (QR) codes or other two-dimensional barcodes that can be positioned throughout a facility, to thereby update the control system with the position of the autonomous vehicle for mapping a facility, tracking progress of the cleaning procedure, or other like position monitoring needs.

In autonomous cleaning systems 11 and 252 described above, it is contemplated that an installer or trainer will first visit a facility to program the system. The installer will map the location, create travel paths and waypoints, and generally assess where autonomous vehicles will need to go in order to thoroughly clean the facility. The mapping of the facility can be done using a 3D scan of the facility that is loaded into a simulation. From the simulation, travel paths and waypoints can be created along with movements of parts on an autonomous vehicle, such as the robotic spray arm 270 on vehicle 250, and the movements of the spray arm 120 on autonomous vehicle 10. With the position of the autonomous vehicle and the associated spray arm coordinated throughout a travel path, autonomous cleaning systems 11, 252 will be set for cleaning a facility. It is contemplated that the installer can also program things such as pressure, flow, solution chemistry and other such parameters necessary to provide at any given point during a cleaning sequence. Further, it is contemplated that the installer can include spray nozzle configurations for the autonomous vehicle in the manners as described above. The installer can create individual tasks and missions for the autonomous vehicles to clean particular parts of the facility. In a combined manner, the tasks and missions can clean the entire facility. After the installer has mapped the facility and built the tasks, a user or operator can work with the autonomous cleaning system to clean the facility. It is contemplated that an operator will login to the system and select a mission and corresponding task or tasks. For instance, a mission may include cleaning a specific conveyor located within a facility. The mission may include a clean, rinse, rinse-foam-rinse, sanitize or other like cleaning procedure that is built into the mission. Certain tasks can then be selected by the operator to complete the mission. The tasks may include the input of certain waypoints that the operator would like for the autonomous vehicle to navigate to, selection of a particular spray tip, adjustment of the spray arm trajectory, a valve configuration for providing a specific solution chemistry, as well as adjusting the variable playback speed.

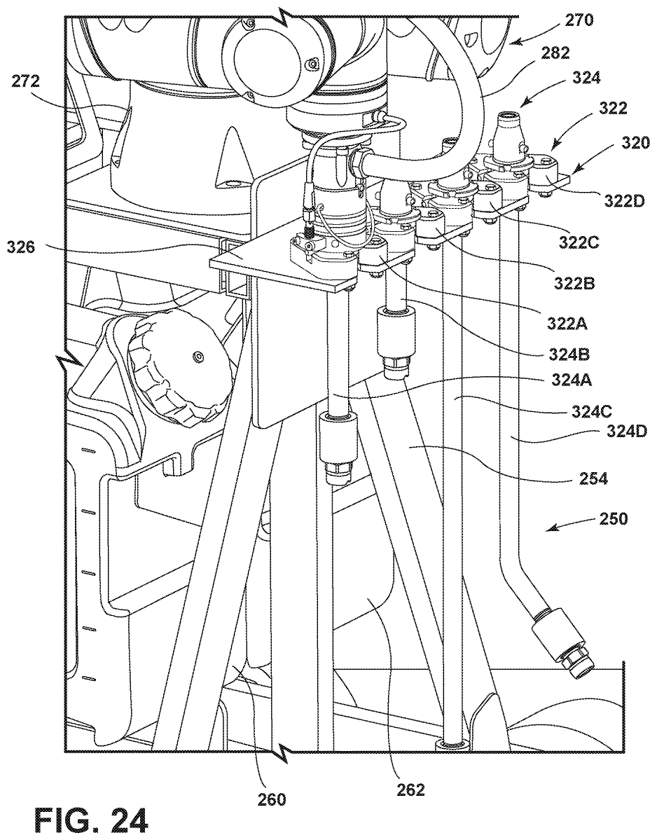

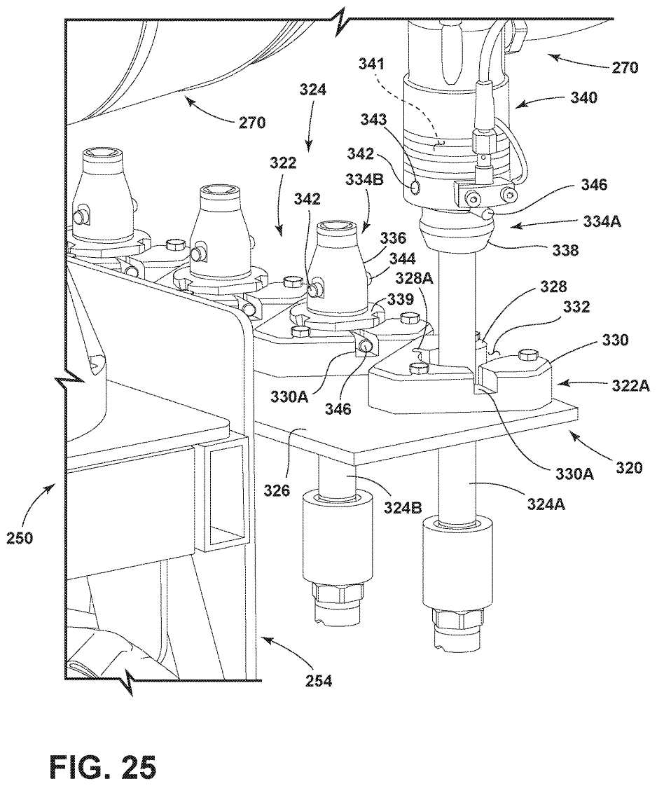

Referring now to FIG. 24, autonomous vehicle 250 may also include a rack 320 which includes a plurality of holder assemblies 322 configured to receive a plurality of spray nozzles 324. In the embodiment shown in FIG. 24, the rack 320 is mounted to a front portion of the frame assembly 254 of autonomous vehicle 250. The rack 320 generally includes a planar body portion 326, upon which the plurality of holder assemblies 322 are positioned. With reference to FIG. 25, each holder assembly 322A-322D includes first and second arms 328, 330 that are spaced-apart from one another to define a receiving area 332 disposed therebetween, as indicated on holder assembly 322A. In this way, each holder assembly 322A-322D includes a generally U-shaped configuration for receiving and holding an associated nozzle 324A-324D of the plurality of nozzles 324. As further shown in FIG. 25, the first and second arms 328, 330 of the holder assembly 322A each include a relief portion 328A, 330A. The description of the holder assembly 322A is an accurate description for all holder assemblies 322A-322D of the plurality of holder assemblies 322.

With further reference to FIG. 25, each nozzle 324A-324D of the plurality of nozzles 324 includes a connector assembly 334A-334D. Each connector assembly 334A-334D includes the features that will now be described with specific reference to connector assemblies 334A and 334B. Each connector assembly 334A-334D includes an upper portion 336, as shown on connector assembly 334B, and a lower portion 338, as shown on connector assembly 334A. The upper and lower portions 336, 338 are separated by an outwardly extending flange 339 that extends around the connector assembly 334B. The lower portion 338 of the connector assembly 334A is coupled to the associated nozzle, 324A. The upper portion 336 of the connector assembly 334B is configured to be received within a connector assembly 340 of the robotic spray arm 270. The upper portion 336 of the connector assembly 334B includes first and second connecting arms 342, 344 which outwardly extend from opposite sides of the upper portion 336 of the connector assembly 334B. In the embodiment shown in FIG. 25, the first connecting arm 342 is shown as being received within a receiving aperture 343 of the connector assembly 340 of the robotic spray arm 270. Thus, it is contemplated that the upper portion 336 of the connector assembly 334A is received within an interior portion 341 of the connector assembly 340 of the robotic spray arm 270. It is contemplated that this connection is provided by a quick-fit connection between the first and second connecting arms 342, 344 of the connector assembly 334A and the receiving apertures 343 of the connector assembly 340 of the robotic spray arm 270 which are contemplated to have a reciprocal configuration. The lower portion 338 of the connector assembly 334A includes first and second positioning arms 346 and 348 (not shown from the view in FIG. 25). The first and second positioning arms 346, 348 outwardly extend from opposite sides of the lower portion 338 of the connector assembly 334A, and are configured to be received within the relief portions 328A, 330A of the holder assembly 322A, when the nozzle 324A is received within the receiving area 332 of the holder assembly 322A. This configuration can be seen with nozzle 324B as received in holder assembly 322B as received. The first and second positioning arms 346, 348 ensure that the upper portion 336 of each connector assembly of each nozzle is in the proper position for connecting to the connector assembly 340 of the robotic spray arm 270 as the robotic spray arm 270 switches from one nozzle to another. The nozzles 324A-324D provide options with different configurations, as well as different spray tips that may be specifically configured to spray a foaming agent or a less viscous sanitizing solution. In this way, the autonomous cleaning system 252 can provide specialized options for optimally cleaning a facility.

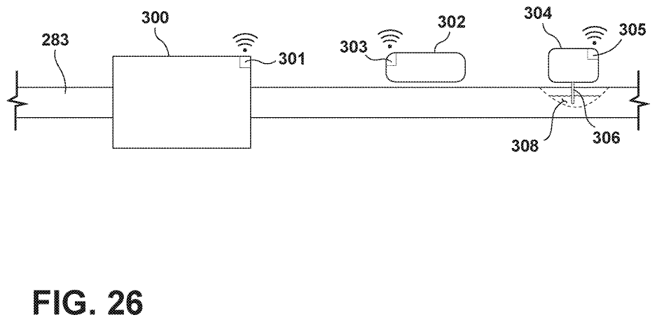

It is further contemplated that a number of components may be in communication with the tether assembly for determining different flow attributes of a solution provided through the tether assembly. The following description is applicable to any tether assembly described above, including tether assemblies 22 and 282. As shown in FIG. 26, a tether assembly 283 may include a flowmeter 300 which is contemplated to be configured to measure such metrics as real-time flow rate and cumulative total. In this way, it is contemplated that the flowmeter 300 can monitor and record solution usage at any given time during the cleaning procedure. It is further contemplated that a pressure gauge 302 may be included along any portion of the tether assembly 283 to monitor such metrics as real-time pressure, pressure averages and reduced pressure situations which may indicate a malfunction of the cleaning system. Further, it is contemplated that a conductivity meter 304 may be provided along a portion of the tether assembly 283. As shown in FIG. 26, the conductivity meter 304 includes a probe 306 that is in direct contact with a solution 308 being transmitted through the tether assembly 283. The conductivity meter 304, or conductivity sensor, measures the ability of the solution to conduct an electrical current. The presence of ions in the solution allows for the solution to be conductive. The greater the concentration of ions in the solution, the greater the conductivity of the solution. Thus, the solution 308 provided through the tether assembly 283 will have different conductivities when transporting water, foaming solution, sanitizing solution, and other mixtures thereof. Using a table of known conductivity of the solutions transported through the tether assembly 283, a user can get a reading from the conductivity meter 304 to measure whether the solution 308 being provided is within an acceptable range of conductivity as compared to the known conductivity. This comparison can also be provided in real time during a cleaning procedure as analyzed by the control panel 34, 264. Thus, the conductivity meter 304 allows a user to measure the chemistry of the solution 308 and can tell the titration of the chemistry of the solution 308 during any portion of a cleaning procedure. The data collected by the flowmeter 300, the pressure gauge 302 and the conductivity meter 304 can be continuously recorded and stored in a data log of a control panel and is also contemplated to be readily available in real-time to a user. In the embodiment shown in FIG. 26, the flowmeter 300 includes a transmitter 301, the pressure gauge 302 includes a transmitter 303 and the conductivity meter 304 includes a transmitter 305. In this way, each component can transmit relative metrics to the control panel, such as control panel 34 or control panel 264, for processing. While a wireless configuration is shown for transmitters 301, 303 and 305, it is contemplated that a wired connection can also be provided directly from the measurement devices 300, 302 and 304 to the control panel.

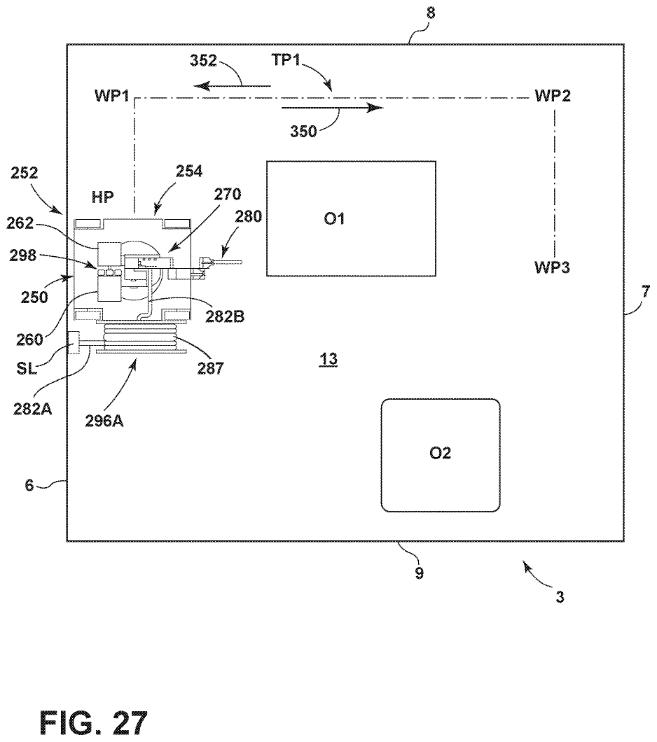

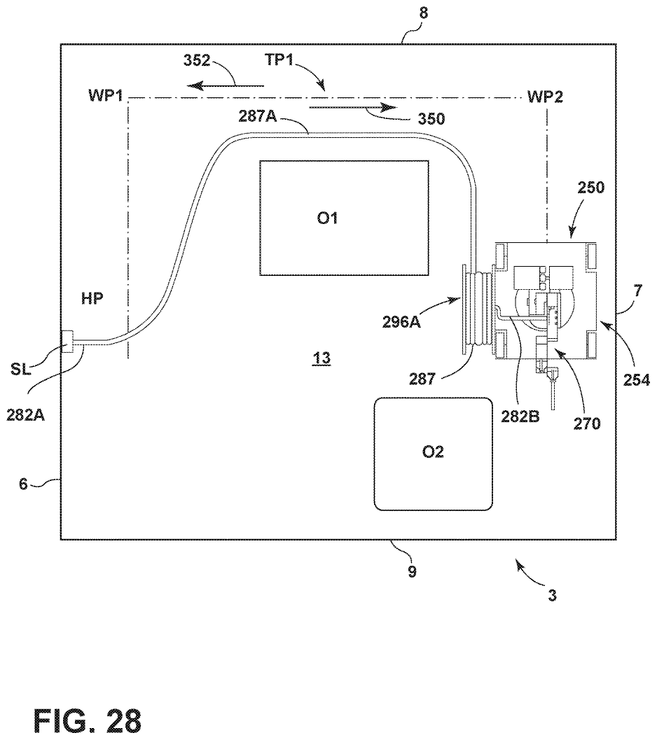

In the embodiment described above with reference to FIG. 24, the reel assembly 296 is illustrated as being mounted to the wall 6 of facility 3. It is also contemplated that a reel assembly may be mounted to the frame assembly 254 of autonomous vehicle 250 for travel with autonomous vehicle 250. Specifically, as shown in FIG. 27, a reel assembly 296A is mounted to the frame assembly 254 of autonomous vehicle 250. In this configuration, a first end 282A of the tether assembly 282 is coupled to supply lines SL of facility 3 at wall 6, while a second end 282B of the tether assembly 282 is coupled to the robotic spray arm 270, as described above with reference to FIG. 22. In this configuration, a body portion 287 of the tether assembly 282 is provided on the reel assembly 296A which is a powered reel assembly configured to pay out the tether assembly 282 along the floor surface of area 13 of the facility as autonomous vehicle 250 moves along a travel path TP1 in a first direction 350 as shown in FIG. 27. The reel assembly 296A is further configured to reel in the tether assembly 282 as autonomous vehicle 250 travels back along a portion of the travel path TP1 in a second direction 352 which is contemplated to be an opposite direction relative to the first direction 350. In this way, autonomous vehicle 250 can move around objects and other obstructions within area 13 of facility 3 and lay the tether assembly 282 directly along the travel path TP1 of autonomous vehicle 250 via the reel assembly 296A rotating in a payout direction as autonomous vehicle 250 moves along the travel path TP1 from the home position HP to the various waypoints indicated at WP1, WP2 and WP3. As illustrated in FIG. 27, autonomous vehicle 250 is shown in the home position HP within facility 3. With reference to FIG. 28, autonomous vehicle 250 has moved from the home position HP to the third waypoint WP3 along the travel path TP1. Thus, as autonomous vehicle 250 travels from the home position HP to the first waypoint WP1, the second waypoint WP2 and the third waypoint WP3, the reel assembly rotates in a first direction, or pay out direction, to deposit a portion 287A of body portion 287 of the tether assembly 282 on the floor surface of facility 3. As autonomous vehicle 250 returns along the same travel path TP1 in the second direction 352, the reel assembly 296A of autonomous vehicle 250 will retract the tether assembly 282 by rotating in a second direction, or retracting direction, which is contemplated to be an opposite rotational direction of the reel assembly 296A as compared to the first direction, or payout direction, of rotation. With synchronized movement between autonomous vehicle 250 and the payout and retraction of the tether assembly 282 along a travel path TP1 via the reel assembly 296A, the tether assembly 282 is never pulled or otherwise deviated from the travel path TP1 during a cleaning procedure. Such deviation can result in the tether assembly 282 becoming stuck or interfering with an object within area 13 to be cleaned of facility 3.

It is further contemplated that the cleaning procedure described above may include various levels of quality assurance. Some of the measures for quality assurance may include optical scanning using the cameras mounted on the autonomous vehicles. These cameras can be used to help determine whether a surface or area is clean and can further be used to record a cleaning procedure as part of a documentation process. Thus, in one example, the cameras can be used to provide a visual inspection of a surface. It is contemplated that a data log can be provided with images of a clean surface, and that same surface can then be compared to an image taken by the camera in real time after the cleaning procedure. Similarly, the cameras can be used to take a UV image of a surface after a cleaning procedure to see if any biofilms are detected. The UV image can then be compared to a UV image of that surface in a clean state stored in the data log. It is contemplated that artificial intelligence (AI) can be used to compare the images to detect whether a surface or object within a facility has been properly cleaned. Thus, the cameras can be used to determine whether a surface was cleaned (i.e. documentation that an actual cleaning procedure was conducted on the surface), and the cameras can also be used to determine whether that cleaning procedure was successful using a quality assurance manager in the form of image comparison between RGB color models and UV images.

Further, it is contemplated that autonomous vehicles according to the present disclosure can be used to provide adenosine triphosphate (ATP) swab samples. Using the robotic spray arm 270 or the spray arm 120, autonomous vehicles 10, 250 can swab surfaces for detection of ATP. ATP is a molecule found in living cells, such that ATP swabbing can quickly assess the cleanliness of surfaces and environments and can help prevent infection and contamination. Using autonomous vehicles to collect swabs of the facility can help with quality assurance that the areas and services tested are clean. Further, it is contemplated that the above-described quality assurance procedures can be used on the autonomous vehicle itself to ensure that the autonomous vehicle is clean and ready to move about a facility.

The invention disclosed herein is further summarized in the following paragraphs and is further characterized by combinations of any and all of the various aspects described therein.

According to one aspect of the present disclosure, an autonomous cleaning system includes an autonomous vehicle having a spray arm with an articulating spray head. The autonomous vehicle is tethered to a base station via a tether assembly. The autonomous vehicle is supplied with one or more solutions from the base station through the tether assembly for applying to an area to be cleaned via the spray arm. The articulating spray head further includes a plurality of spray head tips that can be selectively chosen for application of a solution to the area to be cleaned.

According to another aspect, an autonomous vehicle includes a frame assembly moveably associated with a support surface. A robotic spray arm is supported on the frame assembly and includes a plurality of sections interconnected by a plurality of articulating joints and having a spray nozzle coupled to a distal end thereof. A tether assembly is operably coupled to one or more solution sources disposed on the frame assembly and fluidically interconnects the solution sources with the spray nozzle. A control panel and user interface are configured to provide movement routines for the autonomous vehicle and robotic spray arm, wherein the control panel and user interface are further configured to regulate solutions as provided by the one or more solution sources to the spray nozzle.

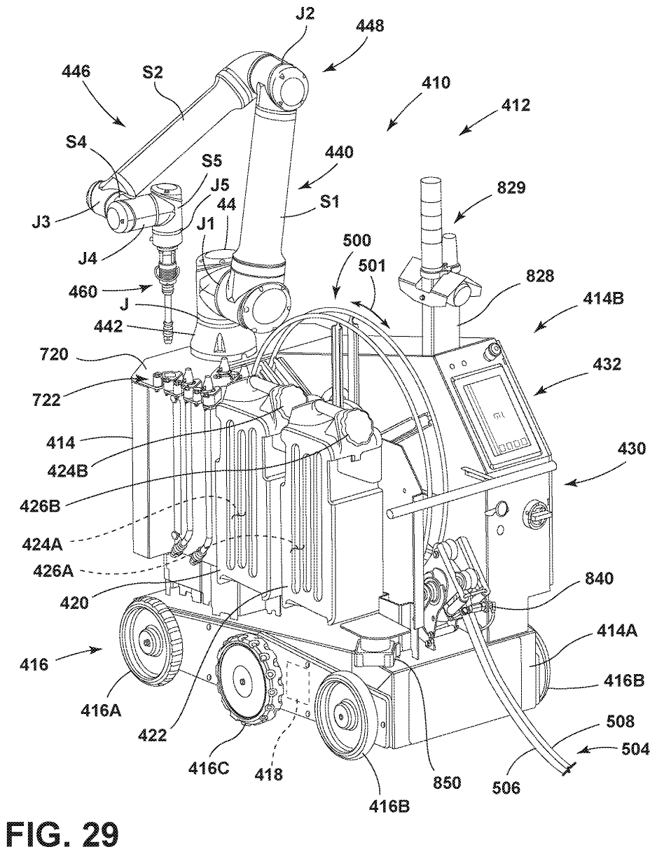

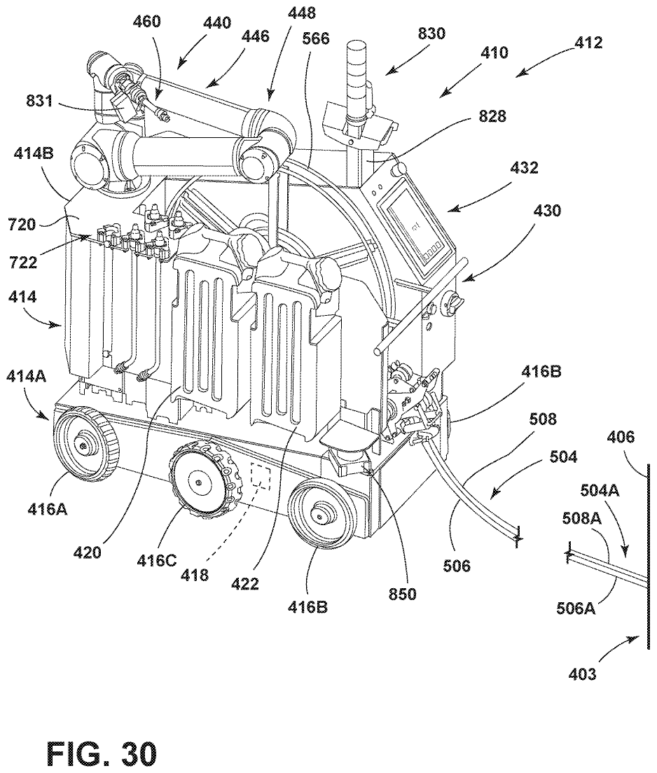

Referring now to FIGS. 29 and 30, the reference numeral 410 generally designates an autonomous vehicle according to embodiment of the present invention. Autonomous vehicle 410 is in and of itself an autonomous cleaning system 412, in that autonomous vehicle 410 is a mobile unit that is equipped with tools and features necessary to carry out an autonomous cleaning operation. Autonomous vehicle 410 may also be referred to herein as a mobile sanitation robot, an automated guided vehicle (AGV), or simply, a robot.

As shown in FIGS. 29 and 30, autonomous vehicle 410 includes a chassis 414 having a lower portion 414A and an upper portion 414B. The lower portion 414A of the chassis 414 may be referred to herein as a base portion 414A. A plurality of wheel assemblies 416 are identified in FIGS. 29 and 30 as wheel assemblies 416A-416C which are operably coupled to the lower portion 414A of the chassis 414. The wheel assemblies 416A and 416B may be fixed or freely rotating wheel assemblies or any combination thereof, such that autonomous vehicle 410 can be movably supported on a support surface in all directions necessary to clean a facility. Further, the wheel assemblies 416A and 416B may be powered wheel assemblies that are used to steer autonomous vehicle 410 along a cleaning path. In the embodiment shown in FIGS. 29 and 30, the wheel assemblies 416A and 416B include front and rear pairs of wheel assemblies that are positioned adjacent corner portions of the lower portion 414A of the chassis 414. The wheel assemblies 416C may comprise powered drive wheels that are supported on the lower portion 414A of the chassis 414 of autonomous vehicle 410 at an intermediate portion thereof. The drive wheels 416C are configured to power movement of autonomous vehicle 410 about a facility. In the embodiment shown in FIGS. 29 and 30, the drive wheels 416C are positioned on opposite sides of the lower portion 414A of the chassis 414 at intermediate portions thereof, but may be disposed at any location on the lower portion 414A of the chassis 414 in order to properly power movement of autonomous vehicle 410. Powered movement of autonomous vehicle 410 may be provided by motors 418 housed within the base portion 414A of the chassis 414. The motors 418 may be associated with any one of the wheel assemblies 416A-416C for driving forward and rearward rotational movement of the wheel assemblies 416A-416C. It is contemplated that individually controlled motors 418 may be individually associated with the wheel assemblies 416A-416C, such that forward and rearward rotational movement of each wheel assembly 416A-416C can be separately controlled. For example, each motor 418 may comprise an electric servomotor that is independently controlled by a controller 430 whereby the speed and direction of rotation of wheel assemblies 416C on opposite sides of autonomous vehicle 10 can be independently controlled a required to move autonomous vehicle 10 linearly and turn autonomous vehicle 10 to move autonomous vehicle 10 between waypoints of a predefined path. In this way, autonomous vehicle 410 is precisely maneuverable so that it can move along a predefined path and stop at predefined task locations, and also maneuver around equipment and other obstacles located within facility 403. Autonomous vehicle 410 may be powered by a suitable power such as a battery that powers all motorized features of autonomous vehicle 410, as further described below.

In the embodiment shown in FIGS. 29 and 30, first and second containers 420, 422 are supported on the chassis 414. The first and second containers 420, 422 are contemplated to hold various chemical compositions (e.g. fluids), which may include, for example, a foaming chemistry, a cleaning chemistry, or a sanitizing chemistry, or combinations thereof. The first and second containers 420, 422 are contemplated to be replaceable containers that can be easily replaced with full containers by a user when the solution in either container 420 or 422 is depleted. Further, the first and second containers 420, 422 can be refilled by a user without removing the first and second containers 420, 422 from the chassis 414. The first and second containers 420, 422 define solution sources for autonomous vehicle 410 to draw from when spraying solutions within a facility, as further described below. Specifically, as shown in FIG. 29, the first and second containers 420, 422 include interior volumes 424A, 426A, respectively, that are accessible via removable caps 424B, 426B, respectively. The selected liquid chemistries are stored within the interior volumes 424A, 426A of the first and second containers 420, 422. In use, the first and second containers 420, 422 are fluidically coupled to one or more valves for selectively delivering a desired chemical composition to a robotic spray arm 440, as further described below.

In the embodiment shown in FIGS. 29 and 30, a control panel 430 is supported on the lower portion 414A of the chassis 414 and can be accessed by a user for controlling or programming autonomous cleaning system 412. Specifically, the control panel 430 may include a user interface 432 in the form of a touchscreen or other like interface for a user to access when programming features of autonomous vehicle 410 or running autonomous cleaning system 412. In the embodiment shown in FIGS. 29 and 30, user interface 432 is positioned near the upper portion 414B of the chassis 414. As further shown in FIGS. 29 and 30, a mast 828 extending upward from the upper portion 414B of the chassis 414. The mast 828 supports an electronic system 829 which may include lights, antennas, receivers, cameras, and other equipment necessary to maneuver autonomous vehicle 410 around a facility and to communicate with autonomous vehicle 410 in a wireless manner. As further shown in FIGS. 29 and 30, a LIDAR sensor 850 is positioned on a lower portion 414A of the chassis 414 and is configured to assist autonomous vehicle 410 in navigating around a production floor of a facility. The LIDAR sensor 850 can also be used to localize autonomous vehicle 410 and provide feedback to a remote system.

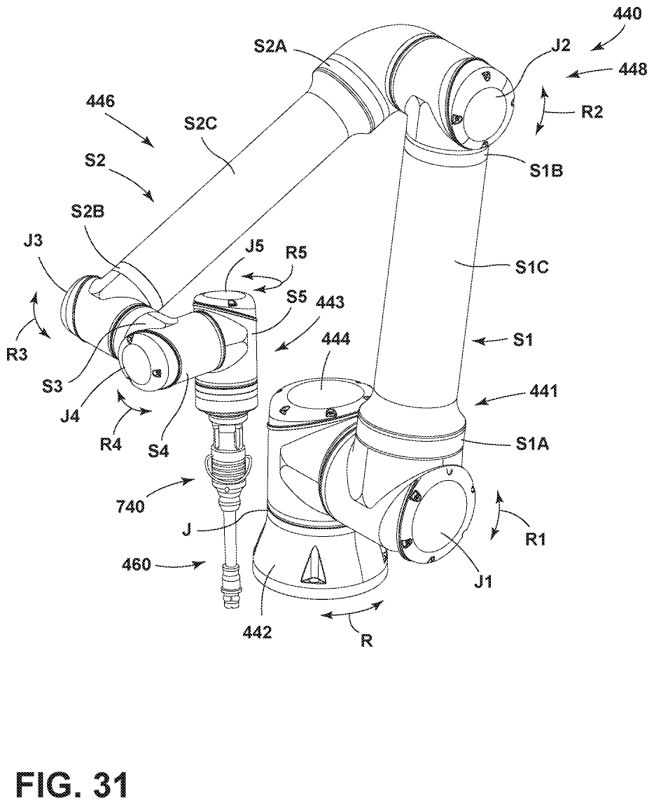

As further shown in FIGS. 29 and 30, autonomous vehicle 410 includes a robotic spray arm 440 that is used to conduct a cleaning or sanitizing procedure, as further described below. As specifically shown in the embodiment of FIG. 29, the robotic spray arm 440 includes a base 442 that is supported on the upper portion 414B of the chassis 414. Base 442 is coupled to and supports a mounting portion 444 in a rotatable manner at joint J. As such, it is contemplated that mounting portion 444 can rotate relative to the base 442 in a programmable manner along the path as indicated by arrow R. The robotic spray arm 440 includes a plurality of sections 446 that are interconnected to one another by a plurality of articulating joints 448. As specifically shown in the embodiment of FIG. 29 and FIG. 31, the plurality of sections 446 of the robotic spray arm 440 includes sections S1-S5. As further shown in the embodiment FIGS. 29-31, the plurality of articulating joints 448 of the robotic spray arm 440 includes articulating joints J1-J5 provided at or between sections S1-S5.

Referring now to FIG. 31, the first section S1 of the robotic spray arm 440 defines a proximal end 441 of the robotic spray arm 440 and includes a first end S1A and a second end S1B with a body portion S1C disposed therebetween. As shown in FIG. 31, the sections S1-S5 of the robotic spray arm 440 each include first and second ends which define proximal and distal ends of each respective section, with a body portion disposed therebetween. The number of sections, joints and the length of any one section can vary without departing from the spirit of the present concept. The first end S1A of the first section S1 is operably coupled to portion 444 at an articulating joint J1, thereby providing for rotating movement of the first section S1 along the path as indicated by arrow R1. The first section S1 is operably coupled to a second section S2 at an articulating joint J2. The second section S2 of the robotic spray arm 440 includes a first end S2A and a second end S2B with a body portion S2C disposed therebetween. The second end S1B of the first section S1 is operably coupled to the first end S2A of the second section S2 at articulating joint J2, thereby providing for rotating movement of the second section S2 of the robotic spray arm 440 along the path as indicated by arrow R2. The second section S2 is operably coupled to a third section S3 at an articulating joint J3. The third section S3 of the robotic spray arm 440 includes a first end and a second end with a body portion disposed therebetween. The second end S2B of the second section S2 is operably coupled to the first end of the third section S3 at articulating joint J3, thereby providing for rotating movement of the third section S3 of the robotic spray arm 440 along the path as indicated by arrow R3. The third section S3 is operably coupled to a fourth section S4 at an articulating joint J4. The fourth section S4 of the robotic spray arm 440 includes a first end and a second end with a body portion disposed therebetween. The second end of the third section S3 is operably coupled to the first end of the fourth section S4 at articulating joint J4, thereby providing for rotating movement of the fourth section S4 of the robotic spray arm 440 along the path as indicated by arrow R4. The fourth section S4 is operably coupled to a fifth section S5 at an articulating joint J5. The fifth section S5 of the robotic spray arm 440 defines a distal end 443 of the robotic spray arm 440 and includes a first end and a second end with a body portion disposed therebetween. The second end of the fourth section S4 is operably coupled to the first end of the fifth section S5 at articulating joint J5, thereby providing for rotating movement of the fifth section S5 of the robotic spray arm 440 along the path as indicated by arrow R5. It is contemplated that the robotic spray arm 440 may include as many sections and articulating joints as necessary to provide the desired movement of the robotic spray arm 440 for adequately maneuvering during an autonomous cleaning or sanitizing procedure. As further shown in FIG. 31, the robotic spray arm 440 also includes a spray nozzle 460 that is coupled to the distal end 443 of the robotic spray arm 440 at the fifth section S5. The spray nozzle 460 is an interchangeable tool and may include any nozzle configuration, such as found on nozzle assemblies 724A-724E, as further described below.

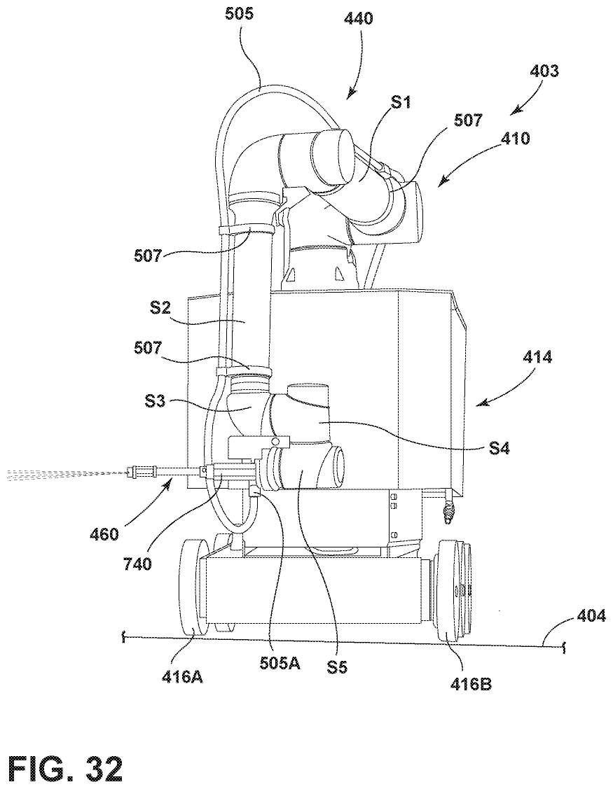

The robotic spray arm 440 may comprise a commercially available electronically powered device with motors (e.g. electric servomotors) positioned at each articulating joint J-J5 of the plurality of articulating joints 448. In this way, the robotic spray arm 440 can be programmed to move in predefined motion sequences as needed to execute a cleaning or sanitizing procedure. In this way, the robotic spray arm 440 is configured to move a nozzle assembly 724A-724E in predefined motion sequences that may include predefined non-identical 3D motion sequences as programmed per predefined task location. With reference to FIG. 32, the robotic spray arm 440 may include a mounted supply hose 505 that is mounted to various sections S1, S2 of the robotic spray arm 440 via mounting clamps 507. In this way, solutions to be sprayed by the spray nozzle 460 can be provided to the spray nozzle 460 through the mounted supply hose 505, which provides a large unobstructed fluid pathway for foam to pass through freely, requiring only a single 90° change in direction within a tool connector assembly 740, as further described below. With specific reference to FIG. 30, the camera 831 may be mounted on the robotic spray arm 440 near the spray nozzle 460. In use, the camera 831 can detect if a person is in the field of view, and if so detected, a spray procedure can be shut down. Further, the camera 831 allows for visual inspection of applied water or chemicals to a surface to ensure complete coverage, and can also provide confirmation that a surface viewed from the camera 831 is clean.

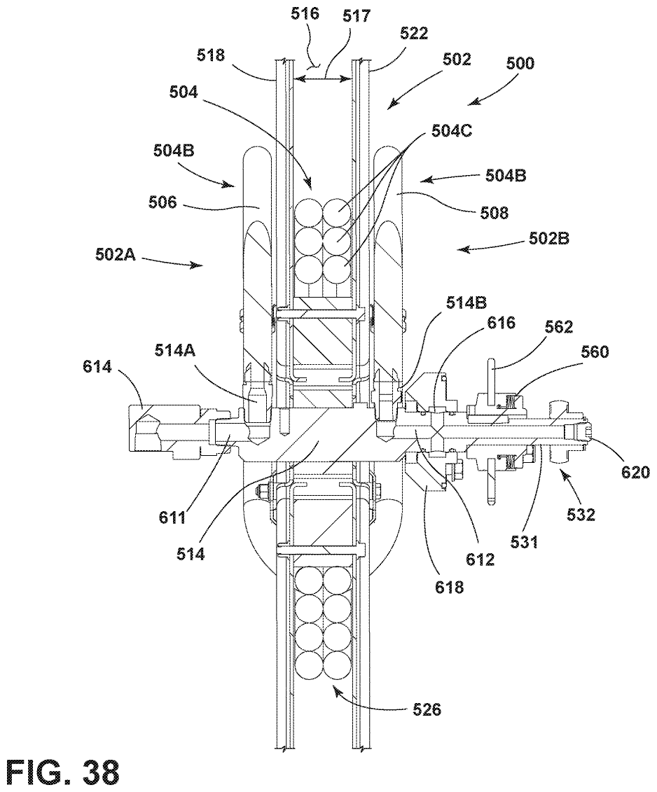

With further reference to FIGS. 29 and 30, autonomous vehicle 410 may include a reel assembly 500 that is mounted on the chassis 414. The reel assembly 500 is contemplated to be an automated reel assembly that includes a spool assembly 502 that is configured to rotate in both forward and reverse directions along a rotational path as indicated by arrow 501. The spool assembly 502 is configured to house a supply hose 504. The rotational movement of the spool assembly 502 occurs as the supply hose 504 is paid out or retracted during movement of autonomous vehicle 410. Movement of the supply hose 504 is caused by a roller assembly 530, as further described below. The supply hose 504 includes a first end 504A and a second end 504B. With specific reference to FIG. 30, the first end 504A of the supply hose 504 includes first ends 506A and 508A of the first and second sides 506, 508 of the supply hose 504. The first ends 506A and 508A of the first and second sides 506, 508 of the supply hose 504 are coupled to a wall 406 of a facility 403 in which autonomous vehicle 410 is located. In this way, facility 403 defines a source, which may comprise both pressurized water and air to the supply hose 504, such that the supply hose 504 can then carry the pressurized water and air to autonomous vehicle 410. The second end 504B of the supply hose 504 is coupled to the spool assembly 502 as best shown in FIG. 38.

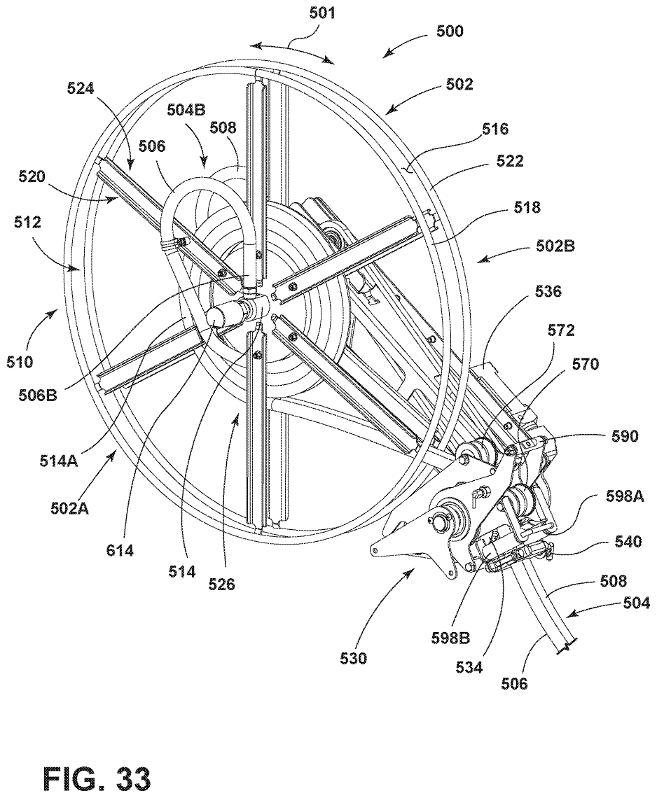

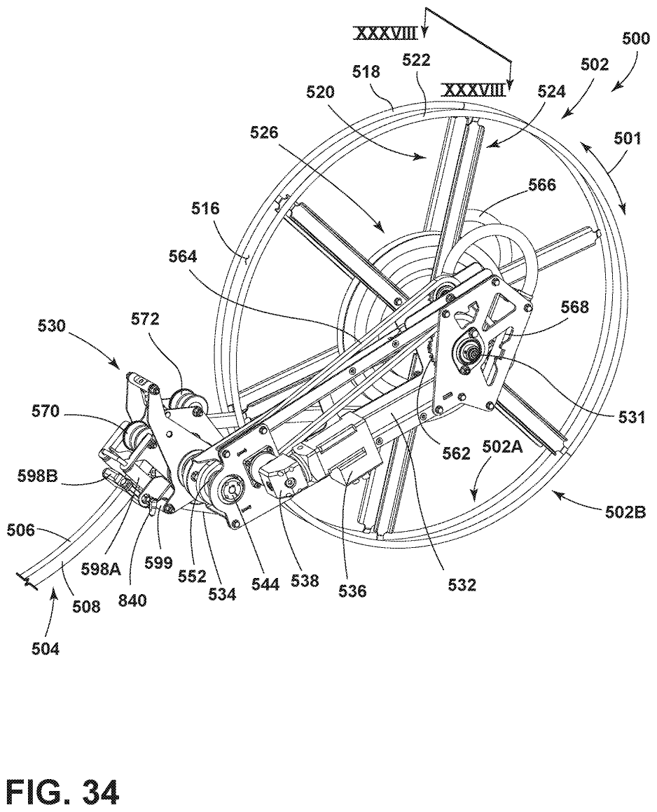

Referring now to FIGS. 33 and 34, the supply hose 504 may comprise a twin-line bonded supply hose that includes a first fluid conduit or side 506 and a second fluid conduit or side 508. The first side 506 of the supply hose 504 may be configured to carry liquid (e.g. pressurized water) to autonomous vehicle 410. The second side 508 of the supply hose 504 may be configured to carry gas (e.g. pressurized air) to autonomous vehicle 410. The supply hose 504 of the present concept can simultaneously carry both pressurized air and water in a separated manner to autonomous vehicle 410. Conduits 504 and 506 may optionally comprise separate lines that are not physically interconnected along the length of supply hose 504.

As further shown in FIGS. 33 and 34, the spool assembly 502 includes a first flange 510 and a second flange 512 that are interconnected by a structure as barrel 514 to define a receiving space 516 therebetween. The first flange 510 is positioned on a first side 502A of the spool assembly 502 and includes an outer rim 518 that is connected to the barrel 514 by a plurality of spokes 520 that radially extend outwardly from the barrel 514 to the outer rim 518. Similarly, the second flange 512 is positioned on a second side 502B of the spool assembly 502 and includes an outer rim 522 that is connected to the barrel 514 by a plurality of spokes 524 that radially extend outwardly from the barrel 514 to the outer rim 522. The receiving space 516 defined between the first and second flanges 510, 512 is appropriately sized having a width 517 (FIG. 28) to store the twin-line supply hose 504 in a stacked mono-spiral configuration 526 on the spool assembly 502, as best shown in FIG. 38. In this way, the supply hose 504 stacks in a single spiral configuration 526 along a depth of the receiving space 516 towards the outer rims 518, 522 as the supply hose 504 is retracted. The mono-spiral spool configuration 526 eliminates the need for a level-winder. A level-winder mechanism could be used to wrap several rows of the supply hose 504 per layer on the spool assembly 502. However, level-winder mechanisms may be complicated and fragile, and if they are not perfectly set up for the hose being used, they can lead to uneven wrapping of the hose on the spool and jamming of the system.

With specific reference to FIG. 33, the supply hose 504 is split at the second end 504B thereof into the first and second lines or sides 506, 508 which are disposed on opposite sides of the spool assembly 502. In FIG. 33, a second end 506B of the first side 506 of the supply hose 504 is shown coupled to a first inlet 514A of the barrel 514 of the spool assembly 502. A similar configuration is provided on the opposite side of the spool assembly 502, wherein a second end 508B of the second side 508 of the supply hose 504 is shown coupled to a second inlet 514B of the barrel 514 of the spool assembly 502, as best shown in FIG. 38.

As further shown in FIGS. 33 and 34, the spool assembly 502 includes a roller assembly 530 that is motorized to control pay-out and take-up operations for the supply hose 504. In this way, the roller assembly 530 defines a powered roller assembly. The roller assembly 530 is positioned in an outboard position relative to the outer rims 518, 522 of the first and second flanges 510, 512 of the spool assembly 502. As best shown in FIG. 34, the roller assembly 530 is maintained in this position by a support bracket 532 that interconnects the roller assembly 530 to a spool shaft 531. Support bracket 532 locates and supports the roller assembly 530 directly adjacent to the spool assembly 502 and further locates the spool shaft 531 relative to a roller shaft 550 of the roller assembly 530. The spool shaft 531 is positioned at the barrel 514 of the spool assembly 502 on the second side 502B of the spool assembly 502.

As further shown in FIGS. 33 and 34, a sensor 840 is positioned on the roller assembly 530 near the intake position of the supply hose 504. The sensor 840 can be used to detect the presence of the supply hose 504, detect an issue with the supply hose 504, detect any foreign objects on the supply hose 504, or help measure an amount of supply hose 504 deployed or retracted via the roller assembly 530. All sensors, and other electrical devices, provided on autonomous vehicle 410 are connected to a controller by either a hard wired or wireless connection, such that the control panel 430 can process data received from the electronic devices of autonomous vehicle 410. Further, it is contemplated that the control panel 430 can relay information to a remote operation system.

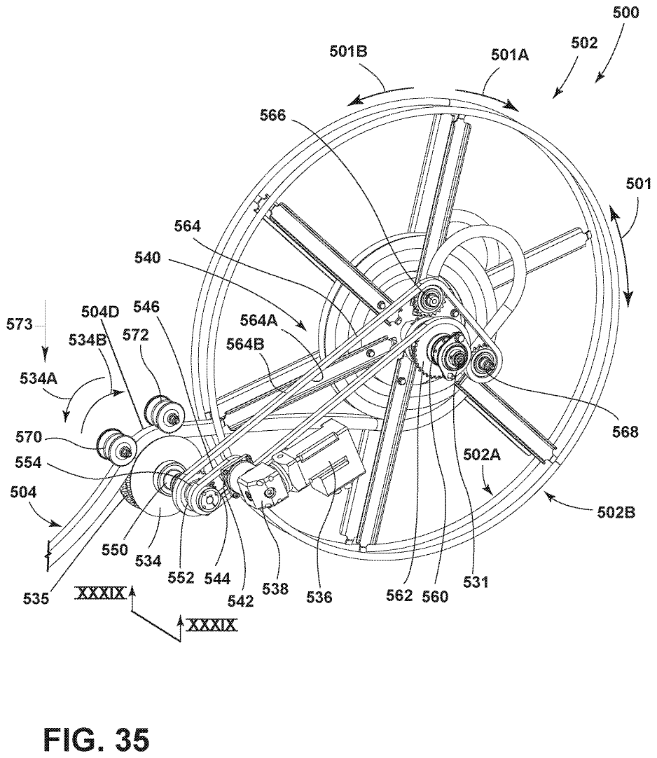

Referring now to FIG. 35, the roller assembly 530 includes a roller 534 that is driven by a motor 536. In this way, the roller 534 defines a motor-driven roller. As specifically shown in FIG. 35, the motor 536 is coupled to a planetary gear assembly 538 which is configured to power a drive system 540. The drive system 540 includes a first sprocket 542 that is driven for rotation in forward and reverse directions by the planetary gear assembly 538, as powered by the motor 536. Rotation of the first sprocket 542 drives rotation of a second sprocket 544 that is interconnected to the first sprocket 542 by a first interconnecting member 546. The first interconnecting member 546 may include a chain configured to engage the first and second sprockets 542, 544. The second sprocket 544 is positioned on a roller shaft 550 that is further coupled to the roller 534. As such, rotation of the second sprocket 544 drives rotation of the roller 534 in both a payout direction, as indicated by arrow 534A, and a take-up direction, as indicated by arrow 534B.

As further shown in FIG. 35, a drive sprocket 552 is positioned on the roller shaft 550 in a spaced-apart relationship relative to the second sprocket 544. The drive sprocket 552 includes a one-way clutch assembly 554 that limits rotation of the drive sprocket 552 to a single direction. Thus, the drive sprocket 552 only rotates in the take-up direction 534B when the roller shaft 550 is driving rotational movement of the roller 534 in the take-up direction 534B. Thus, when autonomous vehicle 410 receives a command to take up the supply hose 504, the motor 536 drives the roller shaft 550 in the take-up direction 534B which further drives rotation of the drive sprocket 552 in the same direction. Rotation of the drive sprocket 552 further drives rotation of the spool assembly 502 via the drive system 540. Specifically, a slip hub 560 includes a driven sprocket 562 mounted on the spool shaft 531. The slip hub 560 is configured to apply torque to the spool assembly 502 at the spool shaft 531 only during a supply hose take-up procedure. As noted above, the spool assembly 502 is configured to rotate along the path as indicated by arrow 501. As such, the spool assembly 502 can rotate in both a payout direction, as indicated by arrow 501A, and a take-up direction, as indicated by arrow 501B. The drive sprocket 552 is interconnected to the driven sprocket 562 by interconnecting member 564 which may include a chain or belt assembly that gearingly engages both the drive sprocket 552 and the driven sprocket 562. Specifically, the drive sprocket 552 engages a first side 564A of the interconnecting member 564 and the driven sprocket 562 engages a second side 564B of the interconnecting member 564. In this way, rotational movement of the drive sprocket 552 in the take-up direction 534B drives rotation of the driven sprocket 562 in an opposite direction as indicated by arrow 501B. This rotational movement of the driven sprocket 562 drives rotation of the spool assembly 502 in the take-up direction as indicated by arrow 501B. Thus, the spool assembly 502 rotates in a driven manner in the take-up direction 501B only, and, conversely, the spool assembly 502 rotates freely in the payout direction 501A as the supply hose 504 is pulled from the spool assembly 502 by the roller assembly 530.

As further shown in FIG. 35, the drive system 540 further includes first and second idler wheels 566, 568 that freely rotate as mounted on support bracket 532 as best shown in FIG. 34. The first and second idler wheels 566, 568 are engaged with the first side 564A of the interconnecting member 564 so as to be driven in the same direction as the drive sprocket 552 during a supply hose take-up procedure.

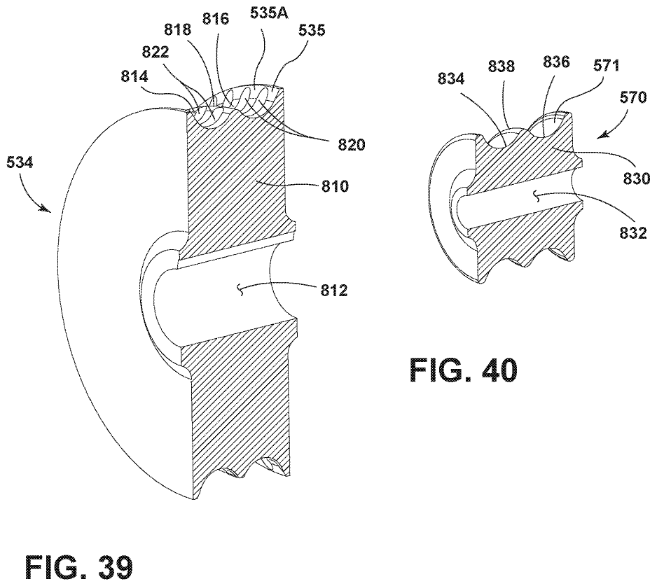

During a supply hose payout procedure, the motor 536 drives the first and second sprockets 542, 544 to drive the roller shaft 550 in the payout direction 534A. This rotation of the roller shaft 550 and the payout direction drives rotation of the roller 534 in the payout direction 534A, but the drive sprocket 552 does not rotate with the roller shaft 550 in this direction due to the one-way clutch mechanism 554. During a supply hose payout procedure, the supply hose 504 is engaged with the roller 534 along an annular bearing surface 535. It is contemplated that the annular bearing surface 535 of the roller 534 is a tractioned or textured surface that can readily grip the outer surface of the supply hose 504 for both payout and take-up procedures, as best shown in FIG. 39. During a payout procedure, the spool assembly 502 rotates freely in the payout direction as indicated by arrow 501A, while the drive sprocket 552, the driven sprocket 562 and the interconnecting member 564 remain static. To better ensure engagement of the supply hose 504 with the roller 534, the roller assembly 530 includes first and second engagement wheels 570, 572 are operable between engaged and disengaged positions relative to the roller 534. Specifically, the first and second engagement wheels 570, 572 define pinch wheels which can be brought into and out of engagement with the roller 534. In the engaged position, the first and second engagement wheels 570, 572 apply vertical pressure in the direction as indicated by arrow 573 to a portion 504D of the supply hose 504 disposed over the roller 534, as shown in FIG. 35, to partially wrap the supply hose 504 around the annular bearing surface 535 of the roller 534. This pressure supplied by the first and second engagement wheels 570, 572 generates sufficient friction between the supply hose 504 and the roller 534, to minimize slippage and produce consistent results when conducting both supply hose payout and supply hose take-up procedures.

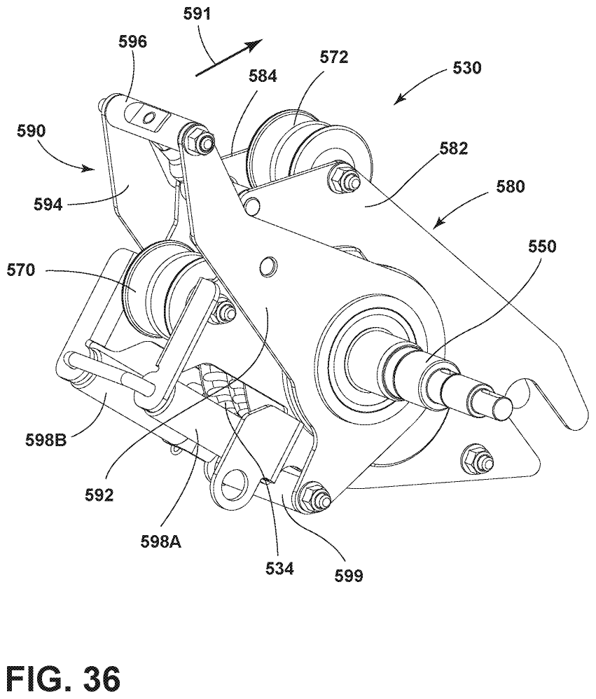

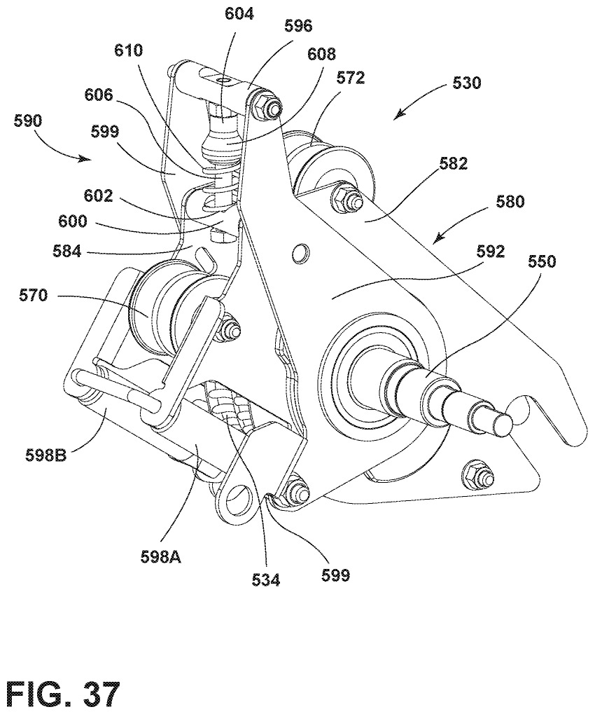

Referring now to FIG. 36, the roller assembly 530 is shown as removed from autonomous vehicle 410. The roller assembly 530 includes a bracket system 580 having first and second plates 582, 584 that are spaced-apart from one another. The first and second engagement wheels 570, 572 are mounted to and positioned between the first and second plates 582, 584. A release lever 590 includes first and second arms 592, 594 that are operably coupled to the roller shaft 550, at lower portions thereof, on opposite sides of the roller 534. Along upper portions of the first and second arms 592, 594, a handle 596 interconnects the first and second arms 592, 594. The release lever 590 is operable between first and second positions. In FIG. 36 the release lever 590 is shown in a first position which equates to an engaged position for the first and second engagement wheels 570, 572. Thus, with the release lever 590 in the first position, the first and second engagement wheels 570, 572 are brought down towards the roller 534 in order to engage the supply hose 504 with the bearing surface 535 of the roller 534. When the release lever 590 is raised in the direction as indicated by arrow 591, the release lever 590 moves from the first position, as illustrated in FIG. 36, to a second position, as illustrated in FIG. 37. With the release lever 590 in the second position, or the release position, the first and second engagement wheels 570, 572 are raised and moved away from the roller 534. Thus, when the release lever 590 is in the second position, the first and second engagement wheels 570, 572 are pulled upward to a position where the first and second engagement wheels 570, 572 move away from and disengage the supply hose 504. In the disengaged position, the first and second engagement wheels 570, 572 allow for manual take-up or payout of supply hose 504 in the event of a system failure or power loss, as well as easier installation and removal of the supply hose 504 during routine maintenance.

As further shown in FIG. 37, a first pin 600 interconnects the first and second plates 582, 584 of the bracket system 580 of the roller assembly 530 at upper portions thereof. A second pin 604 is coupled between the handle 596 of the release lever 590 and the first pin 600. Specifically, the second pin 604 is received through an aperture 602 disposed through the first pin 600 and is displaceable relative to the first pin 600 through the aperture 602. The second pin 604 includes a shaft 606 having a compression spring 610 disposed therearound. An engagement member 608 is also positioned on the shaft 606 of the second pin 604, such that the compression spring is engaged with the engagement member 608 and the first pin 600. As the release lever 590 moves from the second position (FIG. 37) to the first position (FIG. 36), the second pin 604 compresses the compression spring 610 against the first pin 600, such that the first and second engagement wheels 570, 572 are spring loaded into engagement with the supply hose 504.

As further shown in FIGS. 36 and 37, the roller assembly 530 includes first and second guide wheels 598A, 598B that help to guide the supply hose 504 onto the roller 534 and restrict lateral movement of the supply hose 504 during supply hose payout and take-up procedures. As shown in FIGS. 36 and 37, the first and second guide wheels 598A, 598B are coupled to the first and second plates 582, 584 of the bracket assembly 580, respectively. A third guide wheel 599 helps to vertically support the supply hose 504 as the supply hose 504 engages the roller 534. The third guide wheel 599 is interconnected between the first and second arms 592, 594 of the release lever 590 at the lower portion thereof.

Referring now to FIG. 38, the spool assembly 502 is shown in a cross-sectional view with the first flange 510 spaced-apart from the second flange 512 to define the receiving space 516 therebetween. In FIG. 38, the receiving space 516 is shown having a width 517 that is configured to accommodate single stacks 504C of the supply hose 504 and a mono spiral configuration 526. As shown in FIG. 38, the second end 504B of the supply hose 504 has the first and second sides 506, 508 of the supply hose 504 separated from one another. At the second end 504B of the supply hose 504, the first side 506 of the supply hose 504 is shown coupled to the first inlet 514A of the barrel 514 of the spool assembly 502, which leads to a fluid pathway 611 disposed within the spool shaft 531 for water to flow to the robotic spray arm 440. At the second end 504B of the supply hose 504, the second side 508 of the supply hose 504 is shown coupled to the second inlet 514B of the barrel 514 of the spool assembly 502, which leads to an air pathway 612 disposed within the spool shaft 531 for air to travel to the robotic spray arm 440. As noted above, the fluid side, or first side 506, of the supply hose 504 is connected to the spool assembly 502 at the spool shaft 531 to supply pressurized water through the fluid pathway 611 of the spool shaft 531 and to a swivel coupling 614 or outlet affixed to an unsupported end of the spool shaft 531. Similarly, the compressed air side, or the second side 508, of the supply hose 504 is connected to a separate internal air pathway 612 on the same spool shaft 531. Pressurized air flows through cross drilled holes along the air pathway 612 and into an annular jacket 616 incorporated into a support bearing 618 that is also positioned on the spool shaft 531. Support bearing 618 allows for continuous rotation of the spool assembly 502. A plug 620 is a removable member positioned at a terminal end of the spool shaft 531 on the second side 502B of the spool assembly 502.

Referring now to FIG. 39, the roller 534 is shown in a cross-sectional view. The roller 534 includes a body portion 810 having an interior bore 812 disposed therethrough. In assembly, the roller shaft 550 is received through the interior bore 812 of the roller 534. Along the outer portion of the roller 534, the annular bearing surface 535 is provided. As shown in FIG. 39, the annular bearing surface 535 includes first and second receiving channels 814, 816 separated by an upwardly extending portion 818 therebetween. The first and second receiving channels 814, 816 of the roller 534 are outwardly opening U-shaped channels which are configured to receive the first and second sides 506, 508 of the supply hose 504, as the supply hose 504 is engaged by the roller 534 in a supply hose payout or take-up procedure. The first and second sides 506, 508 of the supply hose 504 are rounded at exterior surfaces thereof, as best shown in FIG. 6. In this way, the first and second sides 506, 508 of the supply hose 504 can nest within the respective first and second receiving channels 814, 816 of the roller 534 during engagement therewith. This nesting feature ensures that the supply hose 504 does not move laterally along annular bearing surface 535 of the roller 534 and stays properly positioned while engaged with the roller 534. As further shown in FIG. 39, the annular bearing surface 535 of the roller 534 includes a tractioned or textured upper surface 535A having a plurality of grooves 820 disposed thereon. The spaced-apart grooves 820 are inset grooves which define outwardly extending ridges 822 along the annular bearing surface 535 of the roller 534. In this way, the textured upper surface 535A of the roller 534 can better grip or engage the supply hose 504, which may be provided as a rubberized member that is easily gripped or engaged by the textured upper surface 535A of the roller 534.

Referring now to FIG. 40, engagement wheel 570 is shown in a cross-sectional view. The description of engagement wheel 570 provided herein will also describe engagement wheel 572. The engagement wheel 570 includes a body portion 830 having an interior bore 832 disposed therethrough. In assembly, a shaft is received through the interior bore 832 of the engagement wheel 570, such that the engagement wheel 570 can spin freely on the shaft. Along the outer portion of the engagement wheel 570, an annular bearing surface 571 is provided. As shown in FIG. 40, the annular bearing surface 571 includes first and second receiving channels 834, 836 separated by an upwardly extending portion 838 therebetween. The first and second receiving channels 834, 836 of the engagement wheel 570 are outwardly opening U-shaped channels which are configured to receive the first and second sides 506, 508 of the supply hose 504, as the supply hose 504 is engaged by the engagement wheels 570, 572 in a supply hose payout or take-up procedure. As noted above, the first and second sides 506, 508 of the supply hose 504 are rounded at exterior surfaces thereof, such that the first and second sides 506, 508 of the supply hose 504 can nest within the respective first and second receiving channels 834, 836 of the engagement wheel 570 during engagement therewith. This nesting feature ensures that the supply hose 504 does not move laterally along annular bearing surface 535 of the roller 534 and stays properly positioned while engaged with the roller 534, as the engagement wheel 570, 572 engage the supply hose 504 against the roller 534, as best shown in FIG. 35.

When autonomous vehicle 410 moves along a cleaning path, a navigation computer decides how much of the supply hose 504 to pay out and the speed at which the supply hose 504 is to pay out based on the actual distance that autonomous vehicle 410 travelled, and the speed of autonomous vehicle 410. When autonomous vehicle 410 is travelling in a straight line, a speed of supply hose 504 being paid out (e.g. a speed of supply hose 504 exiting roller assembly 530 relative to roller assembly 530) may be substantially or approximately equal to a linear velocity of the autonomous vehicle 410. Other factors can also be accounted for when determining an amount and speed of supply hose 504 to pay out. For example, when navigating autonomous vehicle 410 around corners, an extra amount (length) of the supply hose 504 relative to the length of a path at a corner may be paid out to compensate for the sweeping arc path that the rear portion (e.g. roller assembly 530) of autonomous vehicle 410 travels when cornering. In general, this extra hose may have a shape that is somewhat similar to a question mark (?). The controller 430 may be configured to pay out and take up an additional length of hose 504 at corners or other turns in a path of autonomous vehicle 410. As shown in FIGS. 29 and 30, the rear portion of autonomous vehicle 410 is where the supply hose 504 exits autonomous vehicle 410 and is deposited onto a floor surface 404 of facility 403 (FIG. 32). Thus, the motor 536 receives commands from the controller (e.g. control panel 430) and rotates the roller 534 to pay out the desired amount of supply hose 504 at the desired speed. When autonomous vehicle 410 has completed its outbound path it stops, and then travels in reverse along substantially the same path. The motor 536 turns the roller 534 in the opposite direction (534B) to take up the supply hose 504 from the floor surface 404 of facility 403 and wind the supply hose 504 on the spool assembly 502.

As the supply hose 504 is taken up from the floor surface 404 of facility 403, the motor 536 also applies a preset amount of torque to the spool assembly 502, so as to maintain some tension in the length of supply hose 504 suspended between the roller 534 and the spool assembly 502 as the supply hose 504 is wound onto the spool assembly 502. This tension is provided to prevent slack from occurring in the supply hose 504 between the roller assembly 530 and the spool assembly 502. This is accomplished by the drive system 540 and the one-way bearing 554 on the drive sprocket 552 mounted to the roller shaft 550. The drive system 540 has a carefully selected reduction ratio, such that the spool assembly 502 is always being driven at a rotational speed which provides a take-up rate for the spool assembly 502 that is greater than a take-up rate of the roller 534. The take-up rate of the spool assembly 502 may vary non-linearly with the quantity of supply hose 504 (number of layers or stacks 504C) that is on the spool assembly 502 at the given time. To compensate for the different and continuously varying take-up rates of the roller assembly 530 and the spool assembly 502, and to produce a constant torque on the spool assembly 502, the slip hub 560 is provided to couple the driven sprocket 562 to the spool shaft 531 of the spool assembly 502.

With further reference to FIGS. 29 and 30, autonomous vehicle 410 may also include a rack 720 which includes a plurality of holder assemblies 722 configured to receive a plurality of nozzle assemblies 724 which define various cleaning tools for autonomous vehicle 410. In the embodiment shown in FIGS. 29 and 30, the rack 720 is mounted to a front portion of the chassis 414 of autonomous vehicle 410.

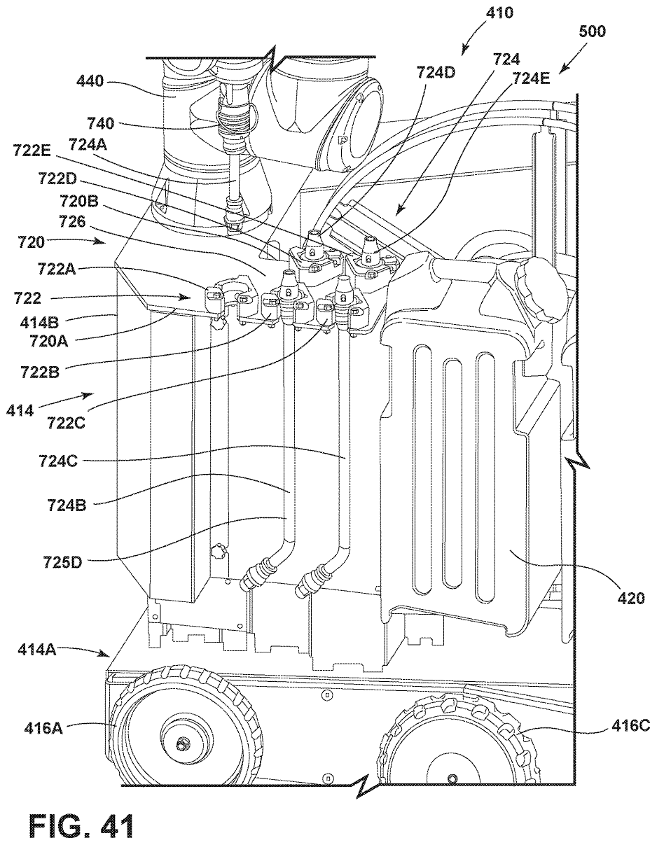

Referring now to FIG. 41, the rack 720 generally includes a planar body portion 726, upon which the plurality of holder assemblies 722 are positioned. Specifically, as shown in FIG. 41, the rack 720 includes three holder assemblies 722A-722C positioned on a first side 720A of the rack 720, and two holder assemblies 722D-722E positioned on a second side 720B of the rack 720. The plurality of nozzle assemblies 724 includes nozzle assemblies 724A-724E that are each associated with a respective holder assembly 722A-722E. As such, autonomous vehicle 410 shown in FIG. 41 includes five different nozzle assemblies 724A-724E that can be selected during a cleaning procedure, thereby allowing autonomous vehicle 410 use of the various unique features associated with each nozzle assembly 724A-724E. Such unique features may include stem length, angles provided in the stem of a selected nozzle assembly, specialized spray tips provided in a selected nozzle assembly providing unique spray patterns or the ability to spray different compositions (foam, cleaning solution, water), and other like features. Thus, the different nozzle assemblies 724A-724E define unique cleaning tools for use in specific cleaning, foaming or sanitizing procedures. It is contemplated that more or fewer nozzle assemblies may be provided on an autonomous vehicle as necessary for an autonomous vehicle to properly clean a facility. Further, other cleaning tools besides spraying tools can be supported on the rack 720 and used by the autonomous vehicle 410 to perform cleaning tasks. Such tools may include scrapers, brushes, rotary brushes, swabs for confirming cleanliness of surfaces, sponges and other like cleaning tools.

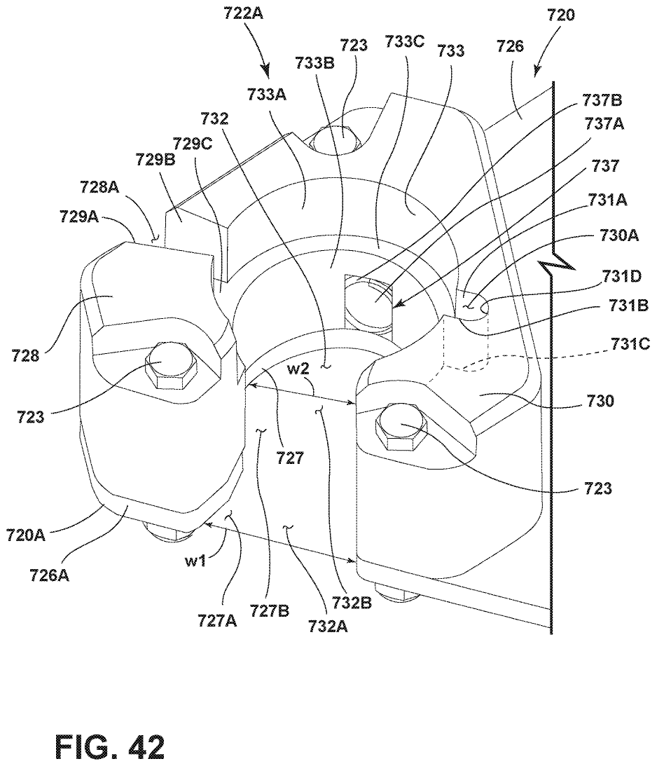

Referring now to FIG. 42, a zoomed in view of a holder assembly 722A is shown. As provided herein, the description of the holder assembly 722A is an accurate description for all holder assemblies 722A-722E of the plurality of holder assemblies 722. As shown in FIG. 42, holder assembly 722A includes first and second arms 728, 730 that are spaced-apart from one another to define a receiving area 732 disposed therebetween. The receiving area 732 includes a first portion 732A and a second portion 732B. The first portion 732A of the receiving area 732 defines an entryway into the receiving area 732. The second portion 732B of the receiving area 732 has a width W2 that is larger than width W1 of the first portion 732A of the receiving area 732. In this way, the receiving area 732 defined by the holder assembly 722A has a generally keyhole-shaped configuration. Similarly, the planar body portion 726 of the rack 720 includes a relief portion 727 that is disposed through the planar body portion 726 and aligns with the receiving area 732 of the holder assembly 722A. Thus, the relief portion 727 includes first and second portions 727A, 727B that have similar configurations and widths as the first and second portions 732A, 732B of the receiving area 732 described above. As specifically shown in FIG. 42, the relief portion 727 of the planar body portion 726 is disposed along an edge portion 726A of the planar body portion 726 along the first side 720A thereof.

As noted above, and with further reference to FIG. 42, holder assembly 722A includes first and second arms 728, 730 that are spaced-apart from one another to define the receiving area 732 disposed therebetween. In this way, each holder assembly 722A-722E includes a generally U-shaped configuration for receiving and holding an associated nozzle 724A-724E of the plurality of nozzles 724. The holder assembly 722A is coupled to the rack 720 using fasteners 723. As further shown in FIG. 42, the first and second arms 728, 730 of the holder assembly 722A each include a relief portion 728A, 730A, respectively. Specifically, the relief portion 728A is disposed through the first arm 728 and includes a U-shaped configuration having first and second sidewalls 729A, 729B which are interconnected by a bottom wall 729C. The relief portion 730A is disposed on the second arm 730 and terminates within the second arm 730 to thereby include a U-shaped configuration having first and second sidewalls 731A, 731B which are interconnected by a bottom wall 731C and a curved end wall 731D.

As further shown in FIG. 42, the receiving area 732 defined between the first and second arms 728, 730 of the holder assembly 722A is defined by a sidewall 733 disposed along the first and second arms 728, 730. The sidewall 733 includes an upper portion 733A and a lower portion 733B. The upper portion 733A of the sidewall 733 is inset from the lower portion 733B, such that a stepped configuration exists between the upper portion 733A and the lower portion 733B to define a ledge 733C disposed therebetween. The lower portion 733B of the sidewall 733 includes a plurality of retractable detent assemblies 737. In use, the relief portions 728A and 730A, the ledge 733C and the plurality of detent assemblies 737 help to locate and support a connector assembly of a nozzle in a manner as further described below.

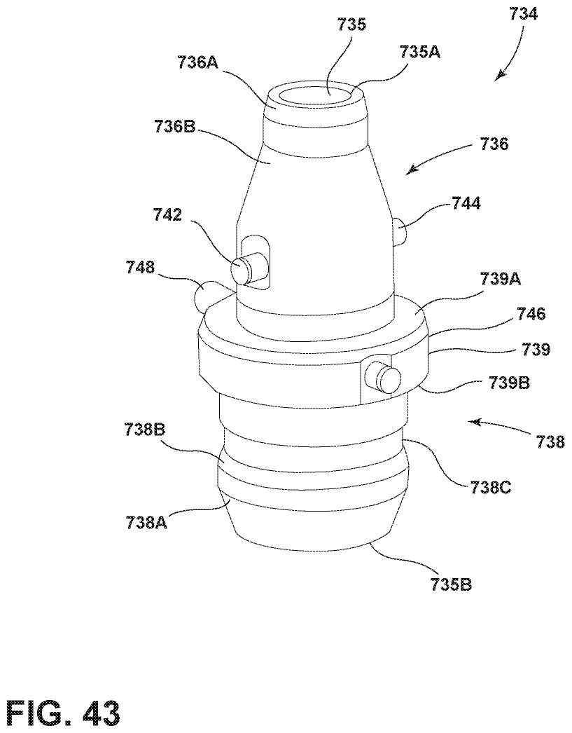

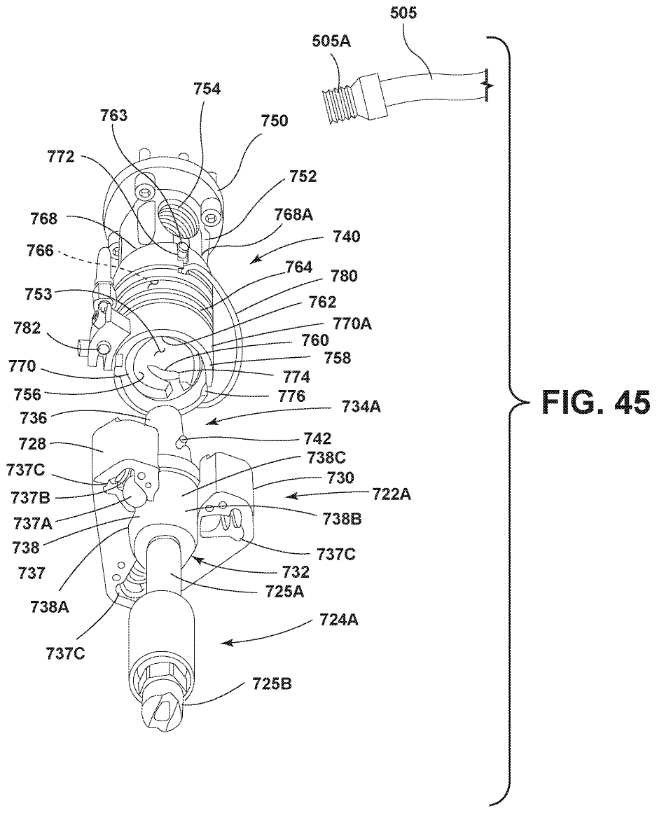

Referring now to FIG. 43, a connector assembly 734 is shown. The connector assembly 734 shown in FIG. 43 is representative of all connector assemblies associated with each nozzle assembly 324A-324E of the plurality of nozzle assemblies 324. As shown in FIG. 43, the connector assembly 734 includes an aperture 735 disposed therethrough having an upper opening 735A and a lower opening 735B. An upper portion 736 of the connector assembly 734 surrounds the aperture 735 and includes a tapered upper edge 736A disposed at the upper opening 735A of the aperture 735 for sealing against a tool connector assembly 740 of the robotic spray arm 440, as further described below. A lower portion 738 of the connector assembly 734 also surrounds the aperture 735 and includes a tapered lower edge 738A. The upper portion 736 of the connector assembly 734 further includes a conical shaped portion 736B that is used to guide the connector assembly 734 into engagement with the tool connector assembly 740 and center the connector assembly 734 within the tool connector assembly 740, as further described below. The lower portion 738 of the connector assembly 734 includes an indented ring portion 738C which includes an angled portion 738B. The upper and lower portions 736, 738 of the connector assembly 734 are separated by an outwardly extending flange 739 that extends around the connector assembly 734 at a mid-portion thereof. The outwardly extending flange 739 includes upper and lower surfaces 739A, 739B. In use, the upper surface 739A of the outwardly extending flange 739 is configured to seal against a lower rim portion 370A (FIG. 45) of the tool connector assembly 740, and the lower surface 739B is configured to abuttingly support the connector assembly 734 at the ledge 733C of an associated holder assembly, such as holder assembly 722A described above. The lower portion 738 of the connector assembly 734 is configured to couple to a stem portion of an associated nozzle, as best shown in FIG. 45. Thus, it is contemplated that the lower opening 735B of the lower portion 738 of the connector assembly 734 is a threaded opening for threadably engaging the stem of a nozzle. The upper portion 736 of the connector assembly 734B is configured to be received within a tool connector assembly 740 of the robotic spray arm 440 in a manner as further described below.

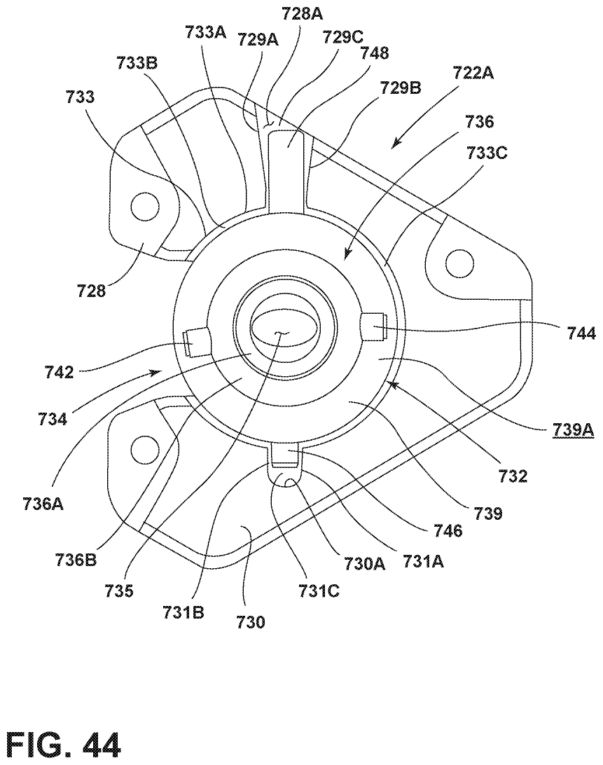

As further shown in FIG. 43, the upper portion 736 of the connector assembly 734 includes first and second connecting arms 742, 744 which radially extend in outward directions from opposite sides of the upper portion 736 of the connector assembly 734. Similarly, the outwardly extending flange 739 includes first and second retaining pins 746, 748 which radially extend in outward directions therefrom on approximately opposite sides of the outwardly extending flange 739. The first and second retaining pins 746, 748 are vertically disposed below the first and second connecting arms 742, 744 of the upper portion 736 of the connector assembly 734. Further, the first and second retaining pins 746, 748 are positioned on opposite sides of the connector assembly 734 and are generally positioned between the first and second connecting arms 742, 744 of the upper portion 736 of the connector assembly 734, as best shown in FIG. 44.

Referring now to FIG. 44, the connector assembly 734 is shown received within the receiving area 732 of the holder assembly 722A. With the connector assembly 734 received within the receiving area 732 of the holder assembly 722A, the first and second retaining pins 746, 748 of the connector assembly 734 are shown received within the relief portions 730A and 728A, respectively, of the holder assembly 722A. Thus, FIG. 44 represents how a nozzle assembly would be received in a holder assembly as positioned on autonomous vehicle 410. With the connector assembly 734 received within the receiving area 732 of the holder assembly 722A, the upper portion 736 of the connector assembly 734 is accessible for connecting to a tool connector assembly 740. With the connector assembly 734 received within the receiving area 732 of the holder assembly 722A, it is contemplated that the lower surface 739B of the outwardly extending flange 739 is supported on the ledge 733C defined by the side wall 733 of the holder assembly 722A.

With the first and second retaining pins 746, 748 of the connector assembly 734 received within the relief portions 730A and 728A of the holder assembly 722A, it is ensured that the upper portion 736 of the connector assembly 734 is in the proper position for connecting to the tool connector assembly 740 of the robotic spray arm 440 as the robotic spray arm 440 switches from one nozzle to another. Thus, the first and second retaining pins 746, 748 of the connector assembly 734 ensure proper positioning of a nozzle assembly when stored on the rack 720. Further, the first and second retaining pins 746, 748 of the connector assembly 734 retain the connector assembly 734 in the proper position by engagement of the second retaining pin 748 with the first and second sidewalls 729A, 729B of the relief portion 728A of the holder assembly 722A when a twisting force is imparted on the connector assembly 734 during a tool changing procedure. Similarly, engagement of the first retaining pin 746 with the first and second sidewalls 731A, 731B of the relief portion 730A of the holder assembly 722A when a twisting force is imparted on the connector assembly 734 during a tool changing procedure ensures that the connector assembly 734 does not rotate, but remains properly positioned. As best shown in FIG. 44, the second retaining pin 748 is longer than the first retaining pin 746, such that the second retaining pin 748 will only fit in the relief portion 728A of the first arm 728 of the holder assembly 722A. Said differently, the second retaining pin 748 is too large to fit in the relief portion 730A of the second arm 730 of the holder assembly 722A. In this way, the second retaining pin 748 serves as a keying feature for positioning the connector assembly 734 in the holder assembly 722A. Thus, reception of the second retaining pin 748 within the relief portion 728A of the holder assembly 722A further ensures that the connector assembly 734 is properly positioned for connecting to the tool connector assembly 740, particularly with regards to the orientation of the first and second connecting arms 742, 744.

Referring now to FIG. 45, nozzle assembly 724A is shown as being received in the holder assembly 722A at a connector assembly 734A thereof. With the connector assembly 734A received in the holder assembly 722A, the upper portion 736 of the connector assembly 734A is in the proper position to be received by the tool connector assembly 740. The nozzle assembly 724A includes the connector assembly 734A which is connected to a stem portion 725A, which is further connected to a spray tip or nozzle 725B. Each nozzle assembly 724A-724E serves to extend the reach of the robotic spray arm 440, and/or allow the robotic spray arm 440 to position the attached spray nozzle, such as spray nozzle 724C, at locations and angles that would not otherwise be achievable by the robotic spray arm 440 alone. The stem portion of each nozzle assembly 724A-724E, such as stem portion 725A, are hollow members for carrying liquid or foam and may be made of pipe or tubing. The stem portions may be long, such as stem portion 725D shown in FIG. 41, or short, such as stem portion 725A shown in FIG. 45. Further, the stem portion of an associated nozzle assembly may be straight (like stem portion 725A, FIG. 45) or have bends in them (like stem portion 725D, FIG. 41) to position the affixed nozzle at an angle relative to the axis of the tool connector assembly 740.

In FIG. 45, three detent assemblies 737 are shown disposed in the holder assembly 722A. Each detent assembly 737 includes a detent member 737A and a compression spring 737B received within a receiving well 737C disposed on an underside of the holder assembly 722A. In the embodiment shown in FIG. 45, the detent member 737A is shown in the form of a ball that is urged towards an extended position by the compression spring 737B. In this way, a portion of the detent member 737A is received in the receiving area 732 of the holder assembly 722A. Thus, it is contemplated that as a spray nozzle is received within a holder assembly, the tapered lower edge 738A urges the detent member 737A towards a retracted position as the connector assembly 734A moves vertically downward within the receiving area 732 of the holder assembly 722A. The detent member 737A extends outward towards an extended position, as urged thereto by the compression spring 737B and shown in FIG. 45, when the detent member 737A aligns with the indented ring portion 738C of the connector assembly 734A. In this way, the holder assembly 722A provides a snap-fit engagement for the connector assembly 734A as received therein by the plurality of detent assemblies 737. Further, the angled portion 738B of the indented ring portion 738C imparts a downward axial force to secure the connector assembly 734A in the holder assembly 722A and prevent rocking movement of the nozzle 724A when autonomous vehicle 410 is moving. Engagement of multiple detent assemblies 737 with the indented ring portion 738C in a triangulated manner centers the connector assembly 734 within the holder assembly 722A and also allows up to 1 mm of radial float when a radial force is applied. Thus, the tool changing system described above allows for a reasonable amount of alignment error during tool changes and is not so rigid that only perfect alignment will suffice.

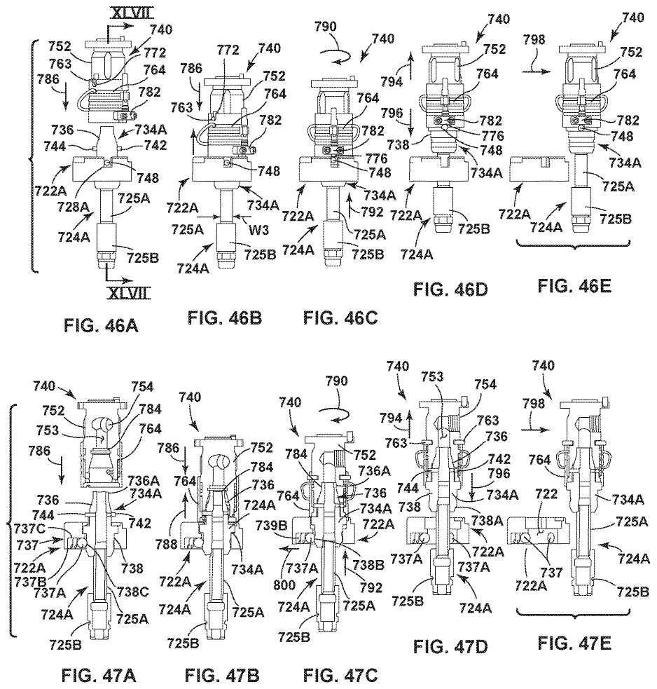

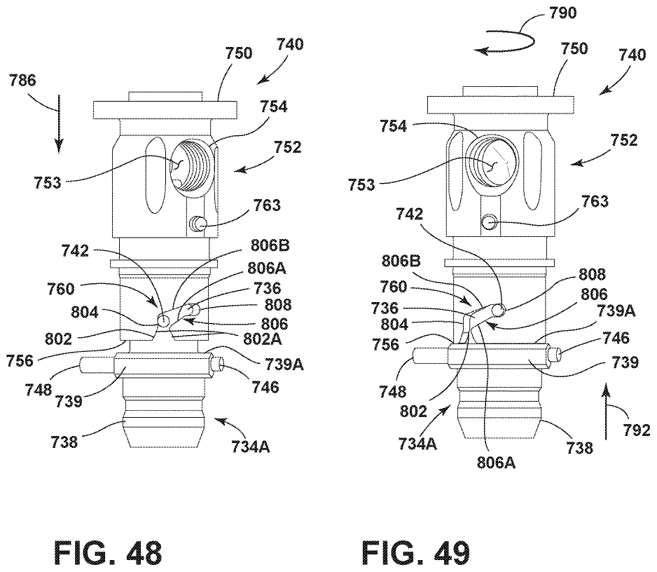

As further shown in FIG. 45, the tool connector assembly 740 attaches to the end of the robotic spray arm 440 via an integrated flange 750 which defines a solid top portion of the tool connector assembly 740. Thus, the tool connector assembly 740 is an end of arm tool used to connect various nozzle assemblies to the robotic spray arm 440. An interior cylinder 752 extends outwardly from a lower surface of the integrated flange 750 and includes an inlet 754 which is contemplated to be a threaded inlet used to connect to a threaded connector 505A disposed on a distal end of the mounted supply hose 505. As noted above, the mounted supply hose 505 provides pressurized liquid or a foam chemical solution to the nozzle 724A through the tool connector assembly 740 and the connector assembly 734A of the nozzle assembly 724A, as best shown in FIG. 32. The interior cylinder 752 includes a hollow interior portion 753 having a lower opening 756 with a rim portion 758. The inlet 754 opens into the hollow interior portion 753, as best shown in FIG. 46A, where a single 90° turn in the fluid pathway is provided. Two helical slots 760, 762 are cut through the interior cylinder 752 at the lower opening 756. The helical slots 760, 762 define ramp features which engage with connecting arms 742, 744, respectively, as best shown in FIGS. 48 and 49. This type of connection is commonly referred to as a “bayonet” connection. The helical slots 760, 762 ramp features are unequally spaced-apart from one another on the interior cylinder 752, such that the tool connector assembly 740 will only fit in one direction on the connector assembly 734A. As further shown in FIG. 45, interior cylinder 752 includes a guide pin 763 outwardly extending in a radial manner from an outer surface thereof. It is contemplated that the interior cylinder 752 may include multiple guide pins, as shown in FIG. 47D, that are used to guide movement of a lock sleeve 764, as further described below.

As further shown in FIG. 45, the tool connector assembly 740 further includes a lock sleeve 764 which is disposed around the interior cylinder 752 for sliding movement therealong. The lock sleeve 764 is contemplated to be a spring biased member that is operable between extended and retracted positions. In FIGS. 45, 46A and 47A the lock sleeve 764 is shown in the extended position. The extended position of the lock sleeve 764 is contemplated to be a locked position to which the lock sleeve 764 is biased. In FIGS. 46B and 47B, the lock sleeve 764 is shown in the retracted position. The lock sleeve 764 moves from the extended position to the retracted position as the lock sleeve 764 contacts the holder assembly 722A during a tool changing procedure, as further described below. The lock sleeve 764 includes a hollow interior portion 766 having upper and lower openings 768, 770 with associated rim portions 768A, 770A, respectively. In assembly, the interior cylinder 752 is received within the hollow interior portion 766 of the lock sleeve 764. The lock sleeve 764 includes an upper slot 772 disposed on the rim portion 768A of the upper opening 768 in which the guide pin 763 of the interior cylinder 752 is slidably received. In this way, the guide pin 763 guides vertical movement of the lock sleeve 764 along the interior cylinder 752. The lock sleeve 764 further includes first and second lower notches 774, 776 disposed on the rim portion 770A of the lower opening 770 in which the first and second retaining pins 746, 748 of the connector assembly 734A are received, respectively, when the tool connector assembly 740 is coupled to the connector assembly 734A of the nozzle assembly 724A. In this way, the first and second retaining pins 746, 748 of the connector assembly 734A prevent rotation of the connector assembly 734 relative to the tool connector assembly 740 once the lock sleeve 764 is extended to the locked position. As further shown in FIG. 45, the tool connector assembly 740 further includes a handle 780 disposed on an outer surface of the lock sleeve 764 that can be used to manually move the lock sleeve 764 when manual connection or release of a nozzle assembly is required. As further shown in FIG. 45, the tool connector assembly 740 further includes a sensor 782 disposed on an outer surface of the lock sleeve 764 that is configured to sense when a nozzle assembly is properly connected to the tool connector assembly 740, and also senses when the lock sleeve 764 is in the locked position.

Making a connection between the connector assembly 734A and the tool connector assembly 740 of the robotic spray arm 440 will now be described with reference to FIGS. 46A-46E and 47A-47E.

In FIG. 46A, nozzle assembly 724A is shown as being received in the holder assembly 722A. In a tool connecting or tool changing procedure, the robotic spray arm 440 brings the tool connector assembly 740 into a position that is vertically aligned along an axis of a target tool assembly which, in this case, is the nozzle assembly 724A as shown in FIG. 46A.

In a tool connecting or tool changing procedure, the rotational position of the tool connector assembly 740 is such that openings 802 (FIGS. 48, 49) on the tool connector assembly 740, which lead to the helical slots 760, 762, are vertically aligned with the first and second connecting arms 742, 744 of the connector assembly 734A of the nozzle assembly 724A, as best shown in FIGS. 46A and 47A.

The robotic spray arm 440 moves the tool connector assembly 740 coaxially along the axis of the of the connector assembly 734A and a downward direction as indicated by arrow 786, until the upper portion 736 of the connector assembly 734A is mostly received within the hollow interior portion 753 of the interior cylinder 752 of the tool connector assembly 740. When the tool connector assembly 740 is in this position, the lock sleeve 764 engages an upper surface of the holder assembly 722A, at the first and second arms 728, 730 thereof, until the lock sleeve 764 is displaced upwardly along the interior cylinder 752 from the extended position to the retracted position in the direction as indicated by arrow 788, which brings the first and second connecting arms 742, 744 of the connector assembly 734A of the nozzle assembly 724A to the respective entries of the helical slots 760, 762 of the interior cylinder 752. This position of the tool connector assembly 740 relative to the connector assembly 734A is best shown in FIGS. 46B, 47B and 48A. Thus, the connection method includes an axial entry and exit movement, which is advantageous for generating the axial force necessary to displace the lock sleeve 764 during tool changes.

From the position shown in FIGS. 46B, 47B and 48 the robotic spray arm 440 rotates the tool connector assembly 740 clockwise 45 degrees in the direction as indicated by arrow 790. This rotation of the tool connector assembly 740 forces the first and second connecting arms 742, 744 of the connector assembly 734A to engage the helical slots 760, 762, respectively, of the interior cylinder 752 and thus partially withdraw the spray nozzle 724A from the holder assembly 722A in the direction as indicated by arrow 792 (FIGS. 46C, 47C and 48) and draw the connector assembly 734A into the hollow interior portion 753 of the interior cylinder 752 as the first and second connecting arms 742, 744 of the connector assembly 734A slide up the ramps of the helical slots 760, 762, as best shown in FIGS. 48 and 49. As the connector assembly 734A of the nozzle assembly 724A is drawn into the hollow interior portion 753 of the interior cylinder 752 in the direction as indicated by arrow 792, the tapered upper edge 736A of the upper opening 735A engages a seal member 784, provided in the form of an O-ring as shown in FIG. 47A, located within the hollow interior portion 753 of the interior cylinder 752 to form a radial seal around the upper opening 735A of the connector assembly 734A, thereby creating a pressure tight seal between the nozzle assembly 724A and the tool connector assembly 740. This engagement between the seal member 784 of the interior cylinder 752 and the tapered upper edge 736A of the upper opening 735A of the connector assembly 734A is best shown in FIG. 47C.

The robotic spray arm 440 then moves the tool connector assembly 740 coaxially along the axis of the nozzle assembly 724A in an upward direction as indicated by arrow 794 (FIGS. 46D and 47D) away from the holder assembly 722A, which allows the lock sleeve 764 to move downward in the direction as indicated by arrow 796 from the retracted position to the extended or locked position, as biased thereto, such that the first and second retaining pins 746, 748 of the connector assembly 734A of the nozzle assembly 724A are respectively received in the first and second lower notches 774, 776 disposed on the rim portion 770A of the lower opening 770 the tool connector assembly 740, thereby preventing unintended rotation of the nozzle assembly 724A. As shown in FIG. 46D, the sensor 782 attached to the lock sleeve 764 is vertically aligned with the second retaining pin 748 and the sensor 782 is drawn closer to the second retaining pin 748 as the lock sleeve 764 is moved to the locked position. The sensor 782 can now sense the second retaining pin 748 of the connector assembly 734A which informs the computer or control panel 430 that the nozzle assembly 724A is present and properly engaged with the tool connector assembly 740, and further indicates that the lock sleeve 764 is in the locked position. Once the proper engagement between the tool connector assembly 740 and the connector assembly 734A of the nozzle assembly 724A, the robotic spray arm 440 continues its upward trajectory in the direction as indicated by arrow 794 for some distance until the connector assembly 734A of the nozzle assembly 724A is clear of the holder assembly 722A, as best shown in FIGS. 46D and 47D.

The robotic spray arm 440 then moves the tool connector assembly 740 with nozzle assembly 724A radially outward from the holder assembly 722A in the direction as indicated by arrow 798. Moving the nozzle assembly 724A away from the holder assembly 722A involves the stem portion 725A being aligned with the first portion 732A (FIG. 42) of the receiving area 732 of the holder assembly 722A. The stem portion of any selected nozzle assembly includes a width, such as with W3 shown in FIG. 46B that is less than width W1 of the opening defined at the first portion 732A of the receiving area 732 of the holder assembly 722A. In this way, a nozzle assembly can pass through the opening defined at the first portion 732A of the receiving area 732 of the holder assembly 722A to fully remove the desired nozzle assembly from the rack 720.

To remove a nozzle assembly within an associated holder assembly, the above-described connecting steps are repeated in reverse order. Thus, the tool connector assembly 740 is configured to connect and disconnect with nozzle assembly as called for by a command signal from the controller 430. The system provided and described above with reference to FIGS. 46A-47E provides for a tool connection system that can withstand simultaneous axial forces (compressive or tensile) and rotational forces (clockwise or counterclockwise) applied to a connector assembly, such as connector assembly 734A, without risk of accidental disengagement. Further, the tool connector assembly 740 of the present concept can securely engage and disengage a nozzle assembly without any additional energy source or actuator. As described above, the tool connector assembly 740 engages and disengages a nozzle assembly solely via a combination of translational and rotational motion provided by the articulating joints 448 of the robotic spray arm 440.

With further reference to FIG. 47A, the detent assembly 737 of the holder assembly 722A is shown having the detent member 737A received in the indented ring portion 738C of the connector assembly 734A in a snap-fit engagement. As noted above, a plurality of detent assemblies can be provided in a single holder assembly. As the connector assembly 734A moves away from the holder assembly 722A, the angled portion 738B of the indented ring portion 738C acts on the detent member 737A to drive the detent member 737A towards the retracted position within the receiving well 737C of the holder assembly 722A against the force of the compression spring 737B. Movement of the detent member 737A towards the retracted position is indicated by arrow 800, as shown in FIG. 47C. In this way, the connector assembly 734A is released from the snap-fit engagement of the detent assemblies 737 of the holder assembly 722A.

Similarly, as the connector assembly 734A of the nozzle assembly 724A enters the receiving area 732 of the holder assembly 722A, the tapered lower edge 738A of the connector assembly 734 acts on the detent members 737A to urge the detent members 737A to the retracted position until the detent members 737A align with the indented ring portion 738C disposed around the lower portion 738 of the connector assembly 734A. As noted above, when the detent members 737A align with the indented ring portion 738C, the detent members 737A move to the extended position as urged by the compression springs 737B for engagement with the indented ring portion 738C of the connector assembly 734A.

With further reference to FIGS. 46A and 46B, the guide pin 763 of the interior cylinder 752 is slidably received by the upper slot 772 of the lock sleeve 764. Specifically, in FIG. 46A, the lock sleeve 764 is shown in the extended or locked position, such that the guide pin 763 is disposed at an upper portion of the upper slot 772. In FIG. 46B, the lock sleeve 764 has moved upward in the direction as indicated by arrow 788 to the retracted position, such that the guide pin 763 is fully received within the upper slot 772 of the lock sleeve 764 at a lower portion thereof. In this way, the guide pins 763 guide vertical movement of the lock sleeve 764 along the interior cylinder 752 between the locked and retracted positions.

Referring now to FIGS. 48 and 49, the interior cylinder 752 is shown having the connector assembly 734A in a partially engaged position (FIG. 48), and a fully engaged position (FIG. 49). With the lock sleeve 764 removed from the interior cylinder 752, helical slot 760 is shown. Helical slot 760 is one of two helical slots (760, 762) disposed on the interior cylinder 752. The description of helical slot 760 and its engagement with connecting arm 742 provided herein also accurately describes helical slot 762 and its engagement with connecting arm 744. As shown in FIGS. 48 and 49, the helical slot 760 includes an opening 802 disposed at the lower opening 756 of the interior cylinder 752. The opening 802 of the helical slot 760 includes angled portions 802A on either side thereof which help to guide the connecting arm 742 into the helical slot 760. From the opening 802 of the helical slot 760, a substantially vertical portion 804 of the helical slot 760 is provided. With specific reference to FIG. 48, the connecting arm 742 is positioned at an upper portion of the substantially vertical portion 804 of the helical slot 760. As the tool connector assembly 740 moves downward in the direction as indicated by arrow 786 to connect with the connector assembly 734A, the alignment of the connector assembly 734A and a respective holder assembly, such as holder assembly 722A, ensures that the first and second connecting arms 742, 744 will align with the first and second helical slots 760, 762. In this way, the connecting arm 742 shown in FIG. 48 is moved to the upper portion of the substantially vertical portion 804 of the helical slot 760 by the downward movement of the interior cylinder 752 onto the upper portion 736 of the connector assembly 734A. The helical slot 760 further includes a ramped portion 806 which leads to a distal end 808. The ramped portion 806 includes upper and lower ramped surfaces 806A, 806B which tapered towards one another as the ramped portion 806 approaches the distal end 808 of the helical slot 760. To get the connector assembly 734A into the fully engaged position with the tool connector assembly 740, the connecting arm 742 must be received at the distal end 408 of the helical slot 760. This engagement is provided by rotation of the interior cylinder 752 of the tool connector assembly 740 in the direction as indicated by arrow 790. Thus, as the interior cylinder 752 rotates in the direction as indicated by arrow 790, the connecting arm 742 engages the lower ramped surface 806A of the ramped portion 806 of the helical slot 760, such that the connecting arm 742 bears down on the lower ramped surface 806A of the ramped portion 806 of the helical slot 760 to draw the connector assembly 734A upward in the direction as indicated by arrow 792 until the connecting arm 742 is seated at the distal end 808 of the helical slot 760. Thus, while the interior cylinder 752 remains in the same vertical position, the rotational movement of the interior cylinder 752 in the direction as indicated by arrow 790 draws the connector assembly 734A upward in the direction as indicated by arrow 792 until the lower opening 756 of the interior cylinder 752 engages the upper surface 739A of the outwardly extending flange 739 of the connector assembly 734A. In this way, the helical slots 760, 762 serve to convert torque into axial force for engaging the connector assembly 734A.

As shown in FIGS. 48 and 49, different angles are provided on the upper and lower ramped surfaces 806A, 806B. As noted above, the connecting arm 742 engages the lower ramped surface 806A of the helical slot 760 when the tool connector assembly 740 rotates in the direction as indicated by arrow 790 to engage the connector assembly 734A. When the tool connector assembly 740 rotates in an opposite direction from the direction indicated by arrow 790, the connecting arm 742 engages the upper ramped surface 806B of the helical slot 760 to disengage the connector assembly 734A from the tool connector assembly 740. The different angles provided along the upper and lower ramped surfaces 806A, 806B creates a tapered pathway along the ramped portion 806, which is wider (taller) at the start than it is at the distal end 808. This allows the tool connector assembly 740 to tolerate up to (for example) 1 mm of vertical (z-axis) misalignment before rotating to engage the pins of the connector assembly 734A. It also allows for a shallower helix pitch on the exit ramp for greater mechanical advantage during connector assembly 734A disengagement, which helps to minimize upward vertical forces on the robotic spray arm 440 which could otherwise cause faults.

Further, when the connector assembly 734A is positioned within a holder assembly, such as holder assembly 722A, reverse rotation of the tool connector assembly 740 provides for a forceful disengagement of the connector assembly 734A from the seal member 784 of the interior cylinder 752. Thus, the helical ramp features of the helical slots 760, 762 of the tool connector assembly 740 provide an axial clamping feature in combination with a separate anti-rotation mechanism in the engagement of the first and second retaining pins 746, 748 with the lock sleeve 764.

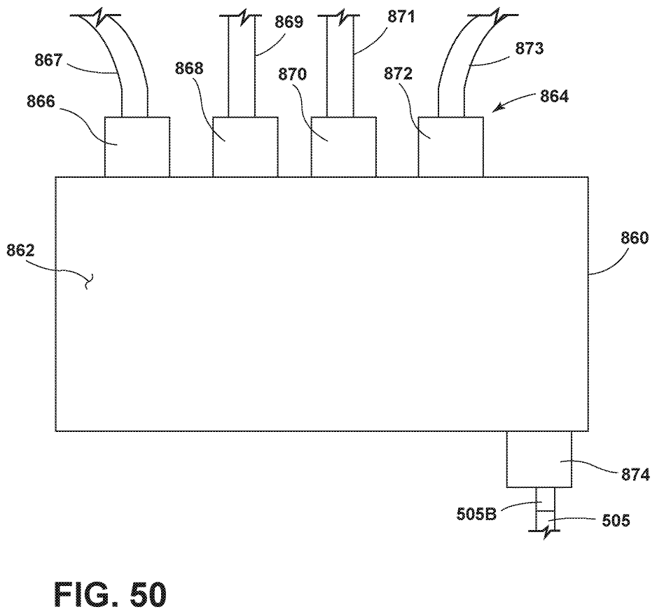

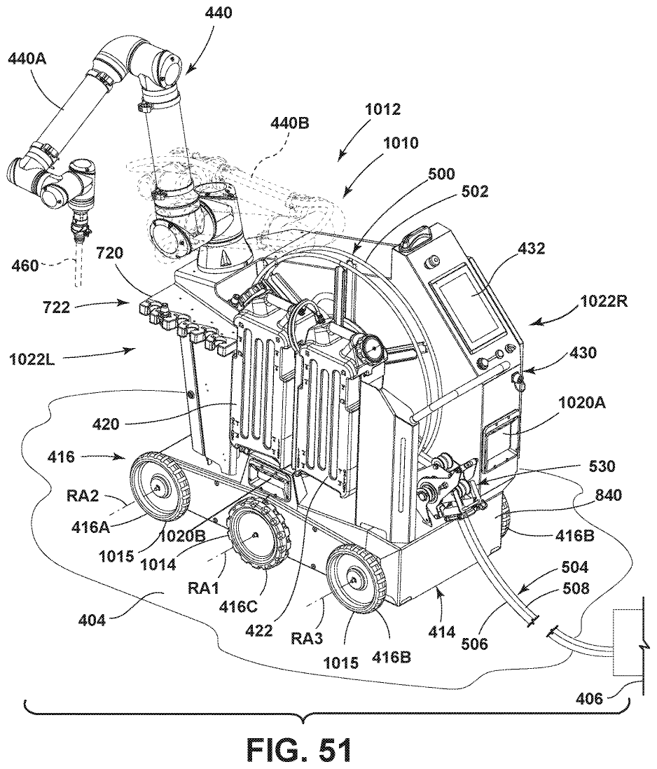

As noted above, the robotic spray arm 440 is configured to spray a solution from a nozzle 460, or any other available nozzle assembly 724A-724E. The solutions may include clean water, pressurized water, pressurized air, a cleaning solution, a foaming agent or solution in a foamed state, a sanitizing solution, or any mixture thereof. Pressurized or boosted water and compressed air are provided by the supply hose 504, and various liquid chemistries are provided by the first and second containers 420, 422, such that, these sources are able to come together at a mixing manifold 860 as shown in FIG. 50 to mix with one another and provide a precise mixture called for by a specific cleaning or sanitizing procedure. As specifically shown in FIG. 50, the manifold 860 includes an interior volume 862 and a plurality of valves 864 opening into the interior volume 862 of the manifold 860. In the embodiment shown in FIG. 50, the plurality of valves 864 includes valves 866, 868, 870 and 872. As shown in FIG. 50, valve 866 is coupled to a supply line 867 which is contemplated to couple to the outlet shown in the form of a swivel coupling 614 disposed on the spool shaft 531, as best shown in FIG. 38. In this way, the supply line 867 is fluidly connected to the fluid pathway 611 of the spool shaft 531 where water is supplied thereto by the first side 506 of the supply hose 504. As further shown in FIG. 50, the valve 868 is coupled to a supply line 869 which is contemplated to couple to an outlet provided on the spool shaft 531 to connect the supply line 869 in a fluid manner to the air pathway 612 of the spool shaft 531 where pressurized air is supplied by the second side 508 of the supply hose 504. In this way, both pressurized air and water can be introduced into the interior volume 862 of the manifold 860. As further shown in FIG. 50, valve 870 is coupled to a supply line 871 which is contemplated to couple to the first container 420 in a fluid manner to provide a first liquid chemistry to the interior volume 862 of the manifold 860. As further shown in FIG. 50, the valve 872 is coupled to a supply line 873 which is contemplated to couple to the second container 422 in a fluid manner to provide a second liquid chemistry to the interior volume 862 of the manifold 860. The valves 866, 868, 870 and 872 of the plurality of valves 864 may include powered actuators (e.g. solenoids) that form inlet valves that are electronically controlled between open and closed conditions to provide a precise solution to the manifold 860 as dictated by a specific cleaning or sanitizing procedure. The opening and closing of the valves 866, 868, 870 and 872 is contemplated to be provided by electronic commands provided by the controller/control panel 430. Together, the plurality of valves 864 and manifold 860 define a fluid control system where various solutions are created and provided to a nozzle assembly on the robotic spray arm 440. The solutions may include water that is substantially free of chemicals, that may be provided directly from the fluid source. Such a clean water supply could be used to provide knock down cleaning of dirt and debris on surfaces of a facility or equipment housed therein when applied as a high volume of water at a high flow rate. The substantially chemical free water could also be applied at a reduced flow rate in a rinsing procedure. The various solutions may also include chemical solutions where water is combined with the liquid chemistries of the first and second containers 420, 422 to form a cleaning solution. With an appropriate nozzle assembly, such a cleaning solution could also be provided in a foamed state. Still further, the various solutions may also include a sanitizing solution that is provided by one of the first and second containers 420, 422 with little to no water added from the source. Various solutions could also be sequentially supplied to a nozzle assembly in a combined cleaning and sanitizing procedure.

As further shown in FIG. 50, a valve 874 is shown as coupled to the manifold 860, and further coupled to the mounted supply hose 505 at a connector 505B. As noted above, the mounted supply hose 505 is coupled to the robotic spray arm 440, as shown in FIG. 32, for supplying a desired solution from the manifold 860 to a selected nozzle assembly. On the other end of the supply hose 505, a connector 505A is coupled to the tool connector assembly 740, is best shown in FIG. 45, to provide a solution to a nozzle assembly. Like the valves 866, 868, 870 and 872, valve 874 is contemplated to be electronically controlled between open and closed conditions to provide a precise solution from the manifold 860 to a selected nozzle assembly, such as one of the nozzle assemblies 724A-724E, as dictated by a cleaning program. The valves may include a spring that returns the valve to an open or closed position when power to a solenoid or other actuator is turned off. Thus, valve 874 may be considered an outlet valve controlled between open and closed conditions by electronic commands provided by the control panel 430.

FIG. 51 is an isometric view of an autonomous cleaning system 1012 including an autonomous vehicle 1010. Autonomous vehicle 1010 may include a chassis 414, robotic spray arm 440, reel assembly 500, and spool assembly 502 that are substantially similar to the corresponding components described in more detail above in connection with FIGS. 29-50. Autonomous cleaning system 1012 further includes containers 420 and 422 that supply cleaning and/or disinfecting chemicals or solutions as described above in connection with FIGS. 29-50. Autonomous cleaning system 1012 further includes one or more spray nozzles 460 that can be positioned in holder assembly 722 of the rack 720 as described above in connection with FIGS. 29-50. Still further, autonomous cleaning system 1012 may include a control panel or controller 430 and user interface 432 as discussed above in connection with FIGS. 29-50. Autonomous cleaning system 1012 further includes a powered roller assembly 530 that selectively pays out and takes in a supply hose 504 having first and second sides or conduits 506 and 508, respectively that connect to a source of fluid such as wall 406. Wall 406 may supply, for example, compressed air and water to the supply hose 504 as discussed in more detail above in connection with FIGS. 29-50.

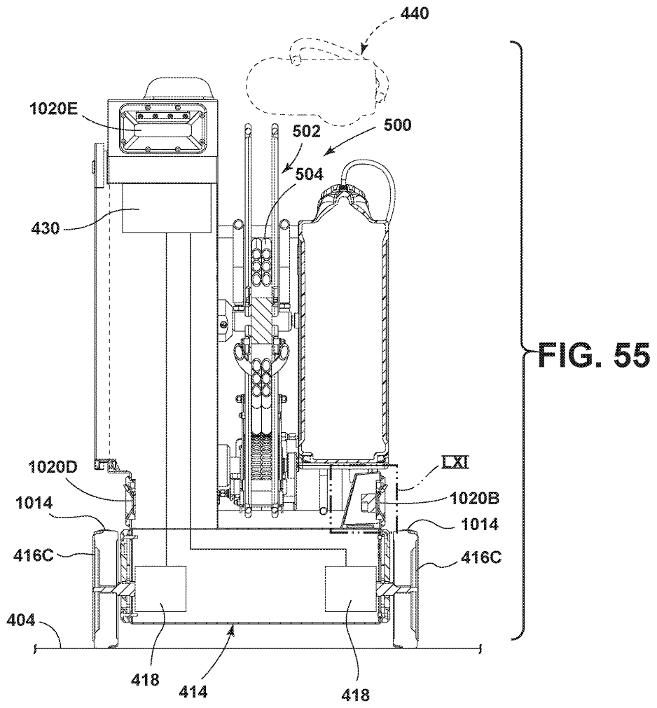

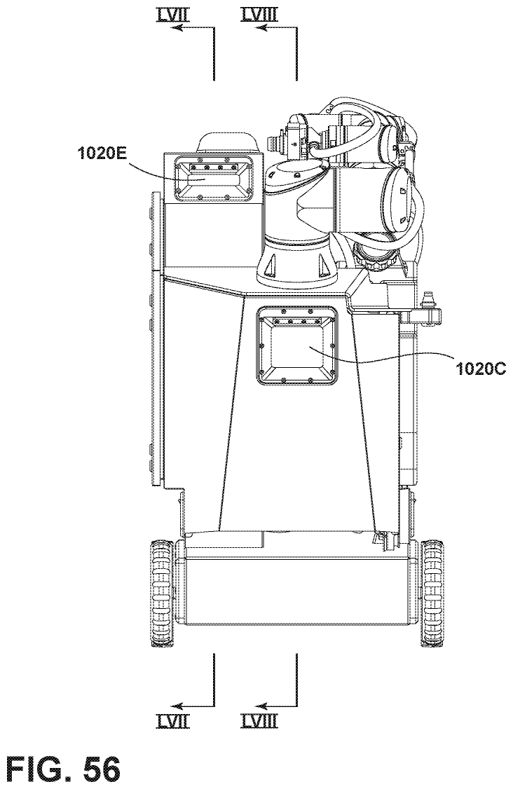

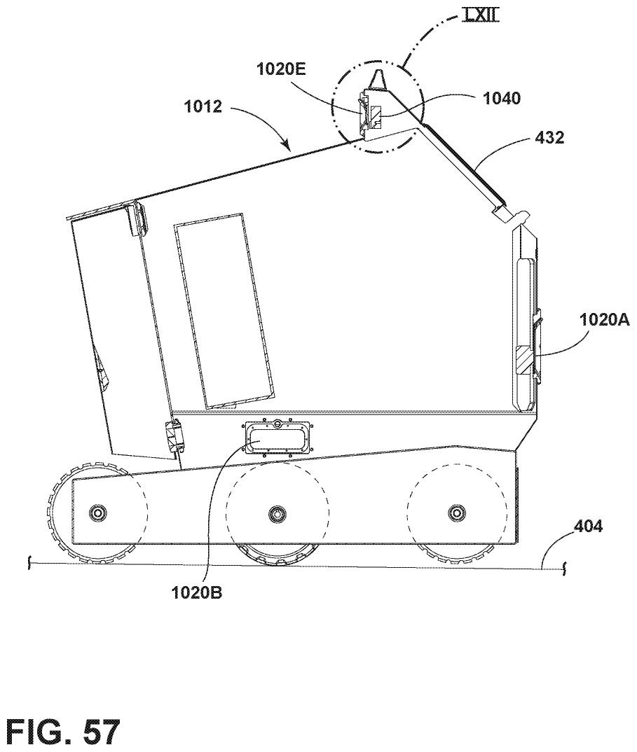

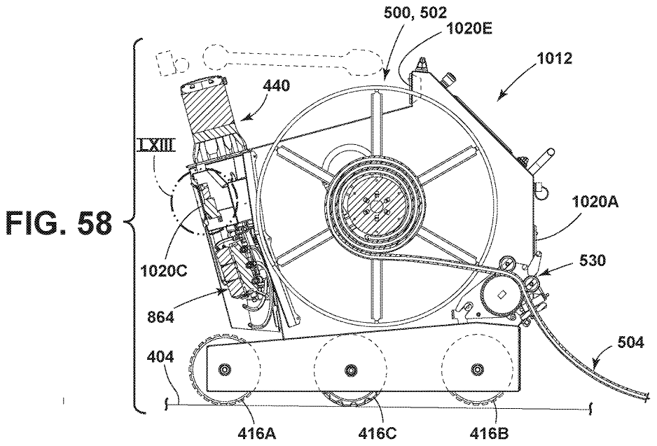

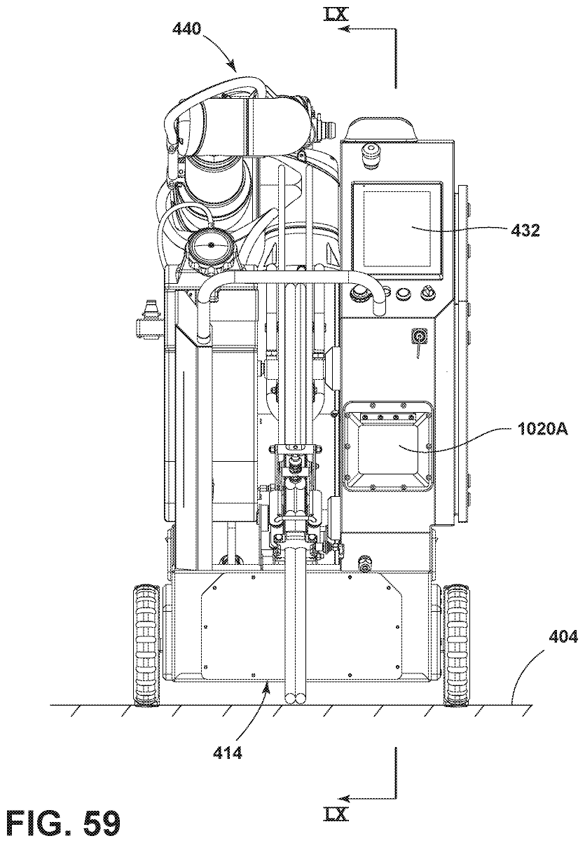

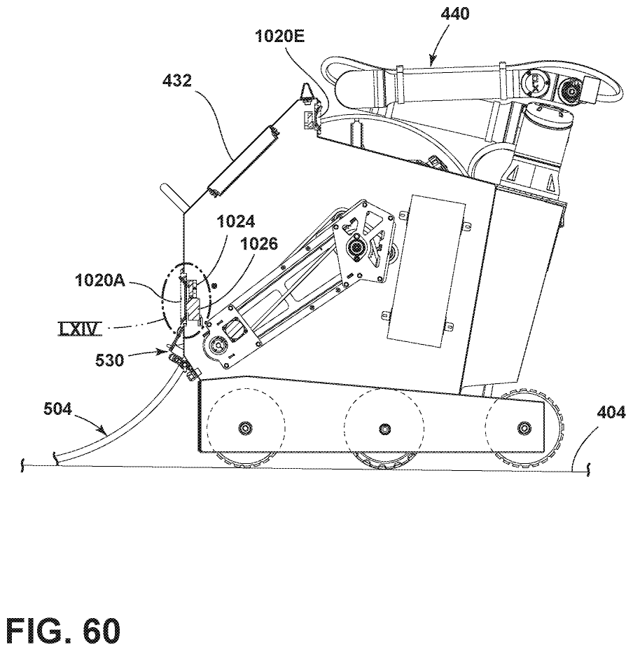

As discussed above, the controller 430 may be configured (e.g. programmed) to move the robotic spray arm 440 to a plurality of positions 440A, 440B etc. As discussed above, a supply hose 505 is configured to supply air and/or liquids as required to a tool such as a spray nozzle 460 (FIG. 51) as required for a particular cleaning or sanitation task. As discussed in more detail above in connection with FIGS. 29-50, the left and right center wheels 416C may be selectively rotated by several motors 401A (FIG. 55). Outer surfaces of the wheels 1014 of wheels 416 may comprise a resilient high friction material (e.g. rubber or other suitable materials) whereby the driven wheels 416C have increased grip on floor surface 404. In contrast, the outer surfaces 1015 of wheels 416A and/or 416B may optionally comprise polymer or other low friction material whereby the wheels 416A and 416B can slide on floor surface 404 if, for example, autonomous vehicle 1010 is turning. In general, the electric service motors 401 (FIG. 55) may be driven at different or unequal rotational rates and/or in different rotational directions by controller 430 to precisely control the direction and speed of autonomous vehicle 1010 (e.g. to provide differential steering). Also, one or more of the wheels may have powered rotation about a vertical axis in addition to powered rotation about the rotational axis of the wheel to provide swerve steering. Thus, the controller 430 is configured to cause the first and second drive wheels 416C to rotate at equal angular rates to move the autonomous vehicle 1010 along a linear path segment, and cause the first and second drive wheels 416C to rotate at unequal rotational rates to move the autonomous vehicle 1010 along a curved or nonlinear path segment.

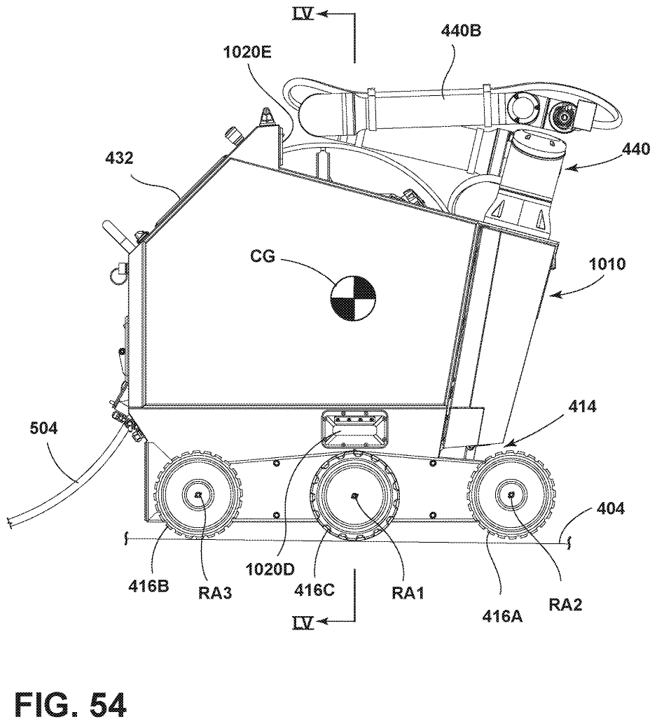

The diameter of center wheels 416C may be somewhat larger than the diameter of wheels 416A and 416B and/or the rotational axis RA1 of the center wheels 416C may be somewhat lower than the rotational axes RA2 and RA3 of wheels 416A and 416B, respectively, whereby the wheels 416C remain in secure contact with floor surface 404, whereas wheels 416A and 416B contact the floor with less force and/or form gaps relative to the floor. The gaps are preferably small whereby tipping about wheels 416C results in minimal movement (e.g. less than 0.5 inches) of the distal end and cleaning tool of the robotic spray arm 440. With reference to FIG. 54, the center of gravity CG of autonomous vehicle 1010 may be directly above the axis RA1 of center wheels 416, or approximately above the axis RA1. The center of gravity CG may be offset a small distance (e.g. 0.5-1.0 inches) fore or aft of axis RA1 when the robotic spray arm 440 is in a stowed position whereby one set of wheels 416A or 416B tend to remain in contact with the floor surface. In a preferred embodiment, all three wheels 416A, 416B, and 416C on one side of autonomous vehicle 1010 are driven at the same rotational rate. However, not all wheels need to be driven. For example, center wheels 416 may be the only wheels that are driven. Also, the present disclosure is not limited to wheel-based arrangements. For example, flexible belts or tracks (not shown) may be utilized if required for a particular application.

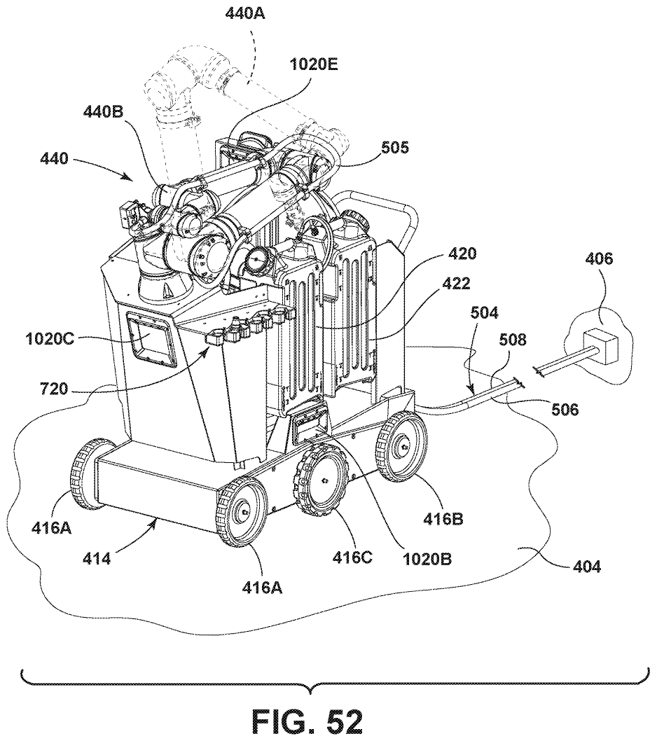

Referring again to FIGS. 51-53, autonomous cleaning system 1012 may include a plurality of sensors 1020A-1020E. As discussed in more detail below, each sensor 1020A-1020E may comprise a LIDAR unit 1026, a 2D camera, a three-dimensional (3D) camera, or combinations thereof. In the illustrated example, the sensors 1020B and 1020D comprise three-dimensional (3D) stereo cameras 1024 that are capable of measuring distances between autonomous vehicle 1010 and objects located adjacent to the opposite sides 1022L and 1022R of autonomous vehicle 1010. The sensors 1020A, 1020C, and 1020E may comprise conventional (2D) cameras that are configured to transmit signals remotely, whereby a remote operator can view the surroundings of autonomous vehicle 1010. Sensors 1020A and 1020C may comprise LIDAR units 1026 in combination with a 2D or 3D camera 1024. In a preferred embodiment each sensor 1020A and 1020C comprises a LIDAR unit 1026 and a 2D camera 1024. It will be understood, however, that the present disclosure is not limited to any specific sensor arrangement, and various sensors may be utilized as required for a particular application.

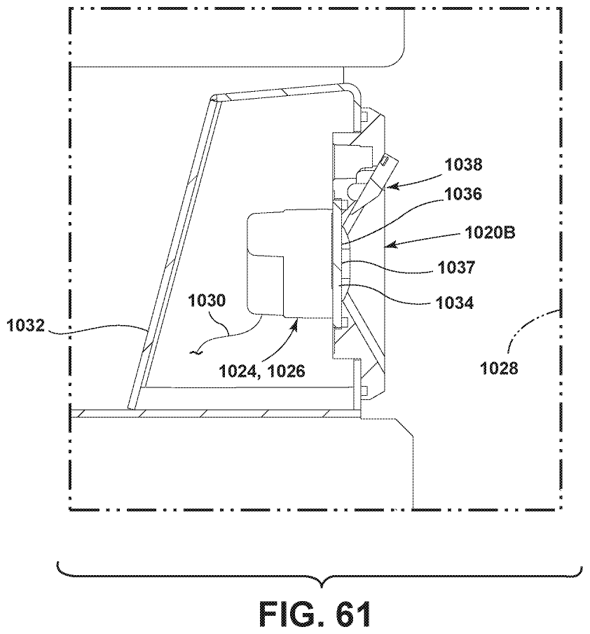

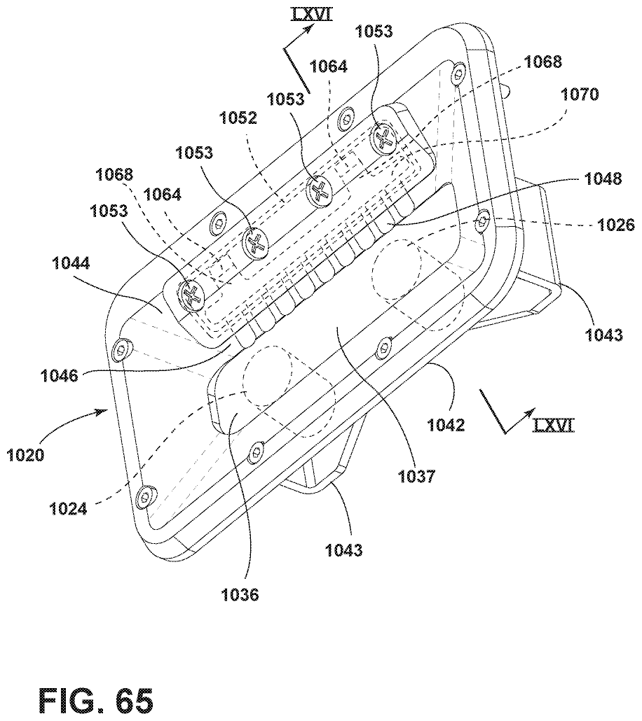

With further reference to FIG. 61, sensor 1020B may comprise a three-dimensional camera 1024 that is capable of providing data that can be used to determine a distance to an object or surface 1028 adjacent to the vehicle. Sensor 1020B may optionally further comprise a LIDAR unit 1026 that is capable of determining a distance to surface 1028 (see also FIG. 65) if required for a particular application. The camera 1024 and LIDAR unit 1026 may be operably connected to controller 430 by power and/or data lines 1030. The camera 1024 and LIDAR unit 1026 may be mounted in a housing 1032 with front sides 1034 of camera 1024 and LIDAR unit 1026 positioned behind a light-transmitting sheet 1036. Sheet 1036 may comprise polymer (e.g. transparent polycarbonate) or other suitable material. The sheet 1036 defines a layer of protective material that protects the camera 1024 and LIDAR unit 1026 from liquids or other materials that may be in the environment adjacent to autonomous cleaning system 1012. As discussed in more detail below, in connection with FIGS. 65-68, the sensors 1020A-1020E may include an air knife 1038 that directs air downwardly across a surface of the sheet 1036 to clean liquids or other materials that may be deposited on the surface 1037 of sheet 1036. As discussed in more detail below, the air knife 1038 may be operably connected to a source of compressed air or other suitable gas or liquid (e.g. supplied by supply hose 504) whereby the flow of air (time and/or pressure) to the air knife 1038 may be selectively controlled by the controller 430. In general, controller 430 may be configured to periodically supply air to the air knife 1038 for specific periods of time at predefined time intervals while autonomous vehicle is in operation (e.g. 30 or 60 seconds every 5 or 10 minutes, depending on the operating environment). Controller 430 may also (or alternatively) be configured to detect matter on the surface of sheet 1036 based, at least in part, on a degradation of the image data and/or LIDAR data, whereby controller 430 may supply air to the air knife 1038 when controller 430 determines that the quality of the sensor data has been degraded.

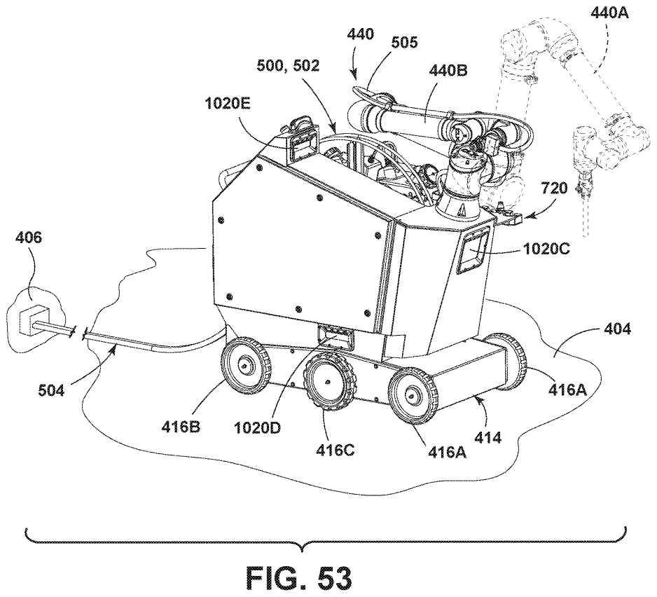

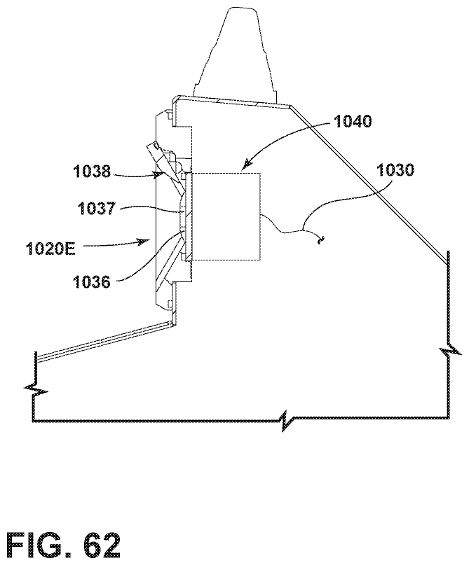

With further reference to FIG. 62 sensor 1020E may comprise a camera 1040 that is operably connected to the controller 430 by electrical and/or data lines 1030 or other suitable arrangements. The sensor 1020E has an elevated position (see also FIG. 53) whereby a remote operator can view the surroundings utilizing the camera 1040. The sensor 1020E includes an air knife 1038 that is configured to direct air onto surface 1037 of sheet 1036 to remove debris or other matter to permit unobstructed viewing utilizing camera 1040.

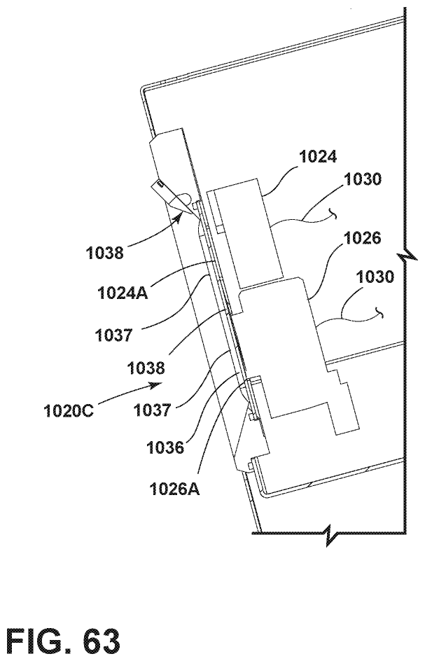

With further reference to FIG. 63, sensor 1020C may include a camera 1024 and a LIDAR unit 1026 that are operably connected to controller 430 via data or power lines data and/or power lines 1030. Camera 1024 may comprise a 2D camera. The front sides 1024A and 1026A of camera 1024 and LIDAR unit 1026, respectively, are positioned behind a transparent sheet 1036, and an air knife 1038 is configured to selectively direct air across the surface 1037 of sheet 1036 in substantially the same manner as discussed above.

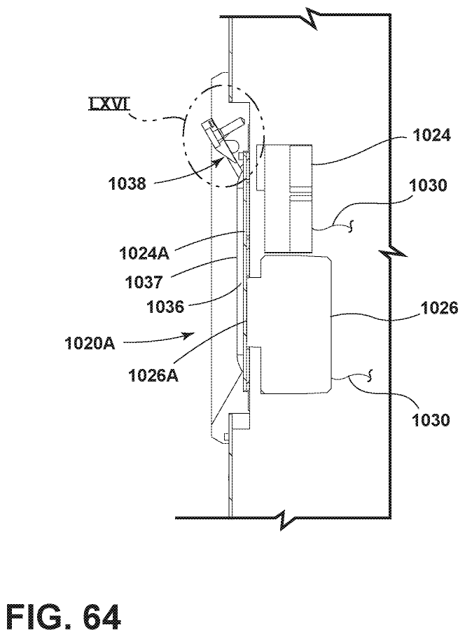

With further reference to FIG. 64, sensor 1020A may comprise a camera 1024 and/or a LIDAR unit 1026. Camera 1024 may comprise a 2D camera. The front sides 1024A and 1026A of camera 1024 and LIDAR unit 1026, respectively, are positioned behind a transparent sheet 1036, and an air knife 1038 is configured to direct air across surface 1037 of sheet 1036 to thereby remove liquid or other matter that may be deposited on surface 1037 of sheet 1036.

With further reference to FIGS. 65-68, the sensors 1020A-1020E may be mounted to the frame or chassis 414 of autonomous vehicle 1010 by bezels 1042 and brackets 1043, or other suitable arrangement. Bezel 1042 includes a surface 1044 that extends at an angle θ relative to surface 1037 of sheet 1036. Surface 1037 of sheet 1036 may be vertical or angled relative to vertical as required for a particular application. A portion 1046 of surface 1044 of bezel 1042 includes a plurality of scallops or grooves 1048 that, together with lower surface 1054 of outer member 1052, form a plurality of parallel passageways 1050 that direct air onto surface 1037 of sheet 1036. Outer member 1052 may be secured to bezel 1042 by threaded fasteners 1053 or other suitable arrangement.

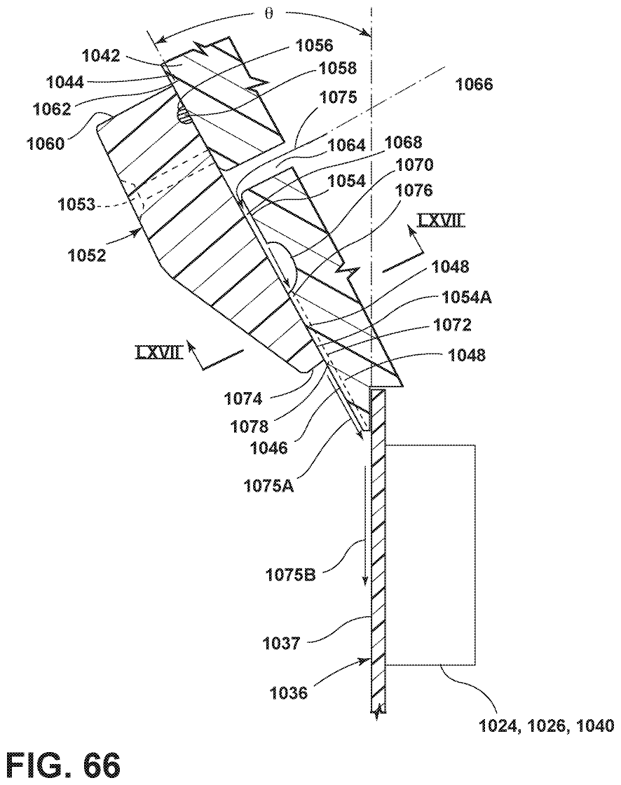

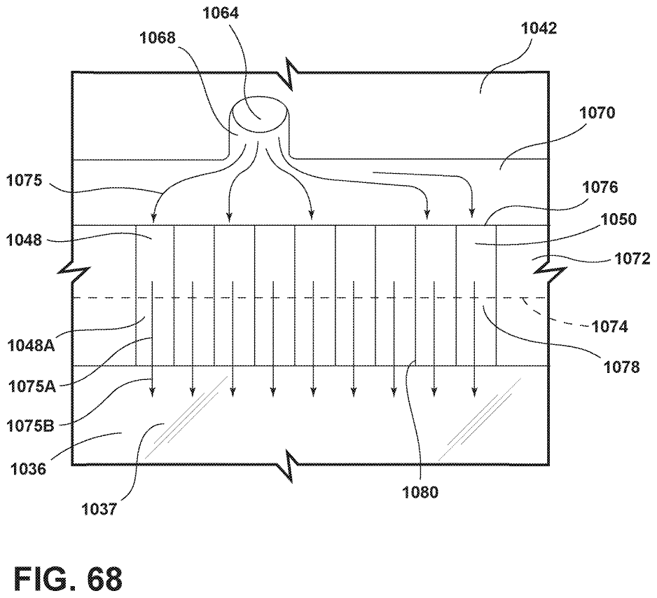

With reference to FIG. 66, lower surface 1054 of outer member 1052 may be flat. A groove 1056 in lower surface 1054 receives a resilient gasket 1058 that extends adjacent to side surface 1060 of outer member 1052. A portion 1062 of angled surface 1044 is flat in the vicinity of the groove 1056 whereby the gasket 1058 forms an airtight seal when outer member 1052 is secured to bezel 1042 by threaded fasteners 1053. Bezel 1042 may include one or more air passageways 1064 that are operably (fluidly) connected to a source of air or other fluid (e.g. compressed air from supply hose 504) by an air tube or line 1066. The bezel 1042 may include one or more air supply grooves 1068 (see also FIGS. 65 and 68) that extend from air passageway 1064 to a transverse groove 1070. When outer member 1052 is secured to bezel 1042, air 1075 from line(s) 1066 flows into the air passageway(s) 1064, through the air supply groove(s) 1068 to transverse groove 1070, and then into passageways 1050. It will be understood that the lower surface 1054 of outer member 1052 covers the air passageway 1064, air supply groove 1068, transverse groove 1070, and grooves or scallops 1048 to form passageways 1050.

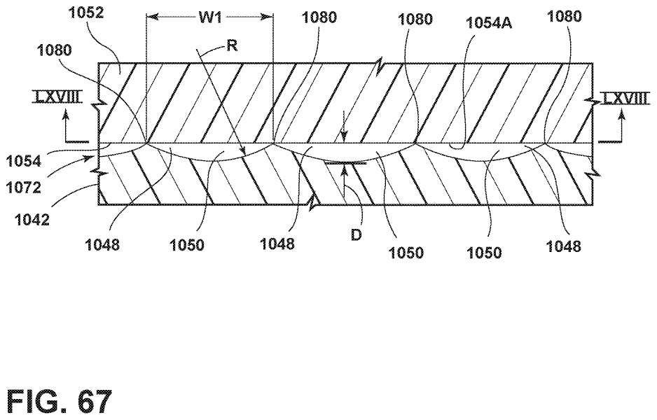

Specifically, with reference to FIGS. 67 and 68, a portion 1054A of lower surface 1054 of outer member 1052 engages a portion 1072 of bezel 1042, whereby passageways 1050 are formed between the grooves 1048 and the portion 1054A of lower surface 1054 of the outer member 1052. The passageways 1050 extend from openings 1076 at the intersection of grooves 1048 and transverse groove 1070, and the passageways 1050 form openings 1078 at edge 1074 of outer member 1052. Thus, compressed air or other fluid from line 1066 enters passageway 1064, and it is then directed through passageways 1050 formed by grooves 1048. The air then exits openings 1078 of passageways 1050, and the air flows along open portions 1048A of grooves 1048 as shown by arrow 1048A, and the air is directed onto the surface 1037 of sheet 1036. The air then flows downward over surface 1037 of sheet 1036 as shown by arrows 1075B whereby the air removes debris, liquid, or other matter from surface 1037.

Referring again to FIG. 67, each groove or scallop 1048 may have a radius R of, for example, about 0.125 inches, a width W1 of about 0.067 inches, and a depth D of about 0.0060 inches to define a concave curved surface. It will be understood that these are merely examples of suitable dimensions according to an aspect of the present disclosure, and various geometries and grooves having various shapes and sizes may be utilized consistent with the present disclosure. For example, the radius R may be in a range of about 0.05 inches to about 0.50 inches, and width W1 may be about 0.01 inches to about 0.25 inches. Also, the grooves 1048 may have different sizes and/or shapes. Furthermore, the grooves 1048 do not necessarily have a uniform radius R, but rather may have, for example, rectangular cross-sectional shapes, triangular cross-sectional shapes, or curved shapes that do not have a constant radius. Although each groove 1048 may have a uniform (constant) depth D, at least some of the grooves 1048 may optionally have varying (non-uniform) depths D.

The grooves or scallops 1048 may be formed in any suitable manner. For example, grooves 1048 may be formed by molding. Alternatively, grooves 1048 may be formed in a flat surface of a bezel 1042 utilizing a suitable tool such as a 0.25-inch ball end mill. The grooves or scallops 1048 may be closely spaced to form sharp edges 1080 that extend between adjacent grooves 1048 and contact lower surface 1054 of outer member 1052. Furthermore, it will be understood that the passageways 1050 may be formed in any suitable manner, and forming grooves in a surface that are closed off by another surface is merely an example of one possible way to form passageways 1050.

The bezel 1042 and outer member 1052 may be made of polymer materials that are resistant to corrosion, and do not let off potentially harmful chemicals or the like. Furthermore, the grooves 1048 and edges 1080 support the outer member 1052 and reduce distortion when outer member 1052 is secured to bezel 1042. Furthermore, as discussed above, the passageways 1050 are elongated channels formed by grooves 1048 that direct air 1075A (FIG. 66) exiting openings 1078 towards the surface 1037 of sheet 1036, whereby air 1075B traveling along surface 1037 removes fluid or other matter disposed on surface 1037.

Controller 430 may be configured to activate one or more of the air knives 1038 on a periodic basis by opening one or more valves to cause air to flow into one or more lines 1066. Controller 430 may also be configured to actuate one or more of the air knives 1038 if a user (e.g. remote) requests activation of air knife 1038 if matter deposited on sheet 1036 creates difficulties when viewing the surroundings utilizing a camera 1024 or 1040. In general, the pressure of air supplied to air knife 1038 may vary as required for a particular application.

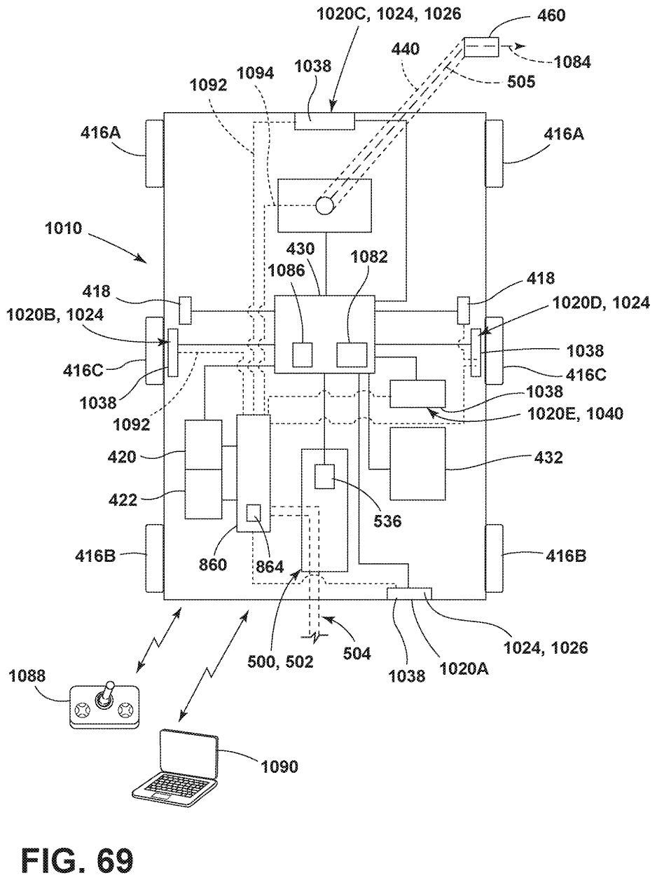

FIG. 69 is a block diagram of autonomous vehicle 1010. As discussed above, autonomous vehicle 1010 may include a controller 430 that is operably connected to a user interface 432. Autonomous vehicle 1010 may include a power source 1082 that is operably connected to the controller 430 and other electrically powered components of autonomous vehicle 1010. It will be understood that the power source 1082 may comprise, for example, rechargeable batteries or other suitable supply of power. The controller 430 is operably connected to the robotic spray arm 440, whereby the controller 430 can be configured (e.g. programed) to cause robotic spray arm 440 to move along various predefined paths as required to direct fluid 1084 onto a surface to be cleaned or sanitized utilizing a selected spray nozzle 460. As discussed above, various spray nozzles 460 may be stored on rack 720 (FIG. 51) and attached to robotic spray arm 440 as required for a particular cleaning or sanitizing task.

As discussed above, autonomous vehicle 1010 may include a user interface 432 that allows a user to send commands to controller 430. Controller 430 may also provide a user display on user interface 432 and/or provide audio signals and images utilizing user interface 432. Controller 430 may also include a wireless transceiver 1086 that is configured to communicate wirelessly with a controller 1088 and/or a computing device 1090. Computing device 1090 may comprise a laptop, computer, tablet, smart phone, or other suitable device that may be a remote device located at a remote location relative to the autonomous vehicle 1010. Controller 430 may be operably connected to front and rear LIDAR units 1026 of sensors 1020A and 1020C, and cameras 1024 of sensors 1020A and 1020C and camera 1040 of sensor 1020E, whereby a remote user can utilize computing device 1090 to view the surroundings of autonomous vehicle 1010 from a remote location. Also, the cameras 1024 and LIDAR units 1026 are operably connected to controller 430 whereby position data from 3D cameras 1024 of sensors 1020B and 1020D and position data from LIDAR units 1026 of sensors 1020A and 1020C is sent to the controller 430 via electronic signals and processed by controller 430 to determine a position of autonomous vehicle 1010 relative to objects and other surfaces adjacent to autonomous vehicle 1010. As such, the signals from the sensors 1020A-1020D are indicative of a distance between the autonomous vehicle 1010 and objects adjacent the autonomous vehicle 1010.

As discussed above, autonomous vehicle 1010 may include fluid containers 420 and 422 that may be fluidly connected to a manifold 860 whereby valves 864 can be utilized to control flowing fluid (e.g. air and water) from supply hose 504, and fluids from containers 420 and 422. Thus, valves 864 of manifold 860 can be controlled by controller 430 to supply air to air knives 1038 via airline 1092 as required. The valves 864 may also be utilized to provide liquid and/or air to robotic spray arm 440 via one or more conduit 1094. As discussed above, liquid from container 420 and/or 422 may be selectively mixed with air and/or water as required for a particular application and spray nozzle 460. As discussed above, the valves 864 may comprise electrically powered valves having electrically powered actuators (e.g. solenoids) that can be selectively actuated by controller 430. Controller 430 may be configured to utilize valves 864 and manifold 860 to control flow of fluids and/or liquids from containers 420 and/or 422 and/or from supply hose 504 into manifold 860, and to control flow of mixtures from manifold 860 to outlets such as spray nozzle 460 and air knives 1038 to provide virtually any desired mixture to one or more selected outlets (e.g. spray nozzle 460 or selected air knives 1038). Controller 430 may also be configured to utilize valves 864 to cause water or air from supply hose 504 to flow through manifold 860 without mixing the water or air with fluids from containers 420 and 422. Still further, the fluid control system may include one or more lines that are fluidly coupled to the first side 506 and second side 508 of supply hose 504, wherein the lines bypass the manifold 860. The fluid control system may include powered valves that are operatively connected to the controller 430 whereby the controller 430 can selectively control flow of water and air directly to spray nozzle 460 and air knives 1038, whereby the air or water can flow through bypass lines and bypass the manifold 860. It will be understood that the manifold 860 and valves 864 are illustrated schematically in FIG. 69, and additional manifolds and/or valves may be utilized in virtually any configuration as required for a particular application.

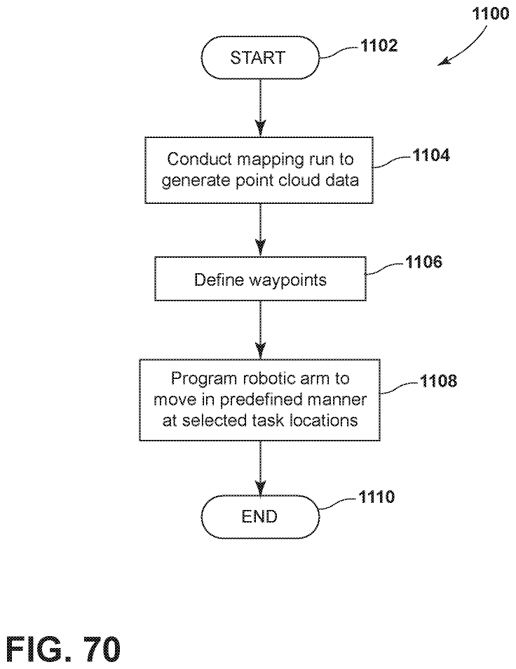

FIG. 70 is a flow chart showing a process 1100 for configuring autonomous vehicle 1010 and autonomous cleaning system 1012 for use at a site that requires cleaning and/or sanitization. Following start 1102, process 1100 proceeds to step 1104. At step 1104, a “Mapping Run” is utilized to generate point cloud data. For example, if autonomous vehicle 1010 is to be used in a space 1114 of a building 1116, autonomous vehicle 1010 may be initially positioned at a first waypoint 1121, and a user may cause the vehicle to move to a plurality of waypoints 1121A-1121J utilizing a controller 1088. Controller 1088 may optionally comprise a controller of a known type having a joystick and other inputs of the type utilized to control, for example, drones and the like. As the user guides the vehicle along the path 1122, the sensors 1020 gather data concerning distances to surfaces 1124 along the path 1122. When autonomous vehicle 1010 has completed moving along the entire length of path 1122, the point cloud data recorded by sensors 1020 (e.g. 3D cameras 1024 and LIDAR units 1026) is stored. Controller 430 may be configured such that the autonomous vehicle can determine its position along path 1122 during cleaning operations utilizing the point cloud data generated during the mapping run.

Referring again to FIG. 70, process 1100 may include defining waypoints at step 1106 based, at least in part, on the point cloud data generated as step 1104. Alternatively, during the Mapping Run of step 1104, a user may input waypoints to guide the vehicle along the path 1122 while autonomous vehicle 1010 is being manually controlled. Each way point can define a change in the movement of the autonomous vehicle 1010 (such as a stopping point or an initiation of a curved movement), and each way point can also define predefined task locations where cleaning or sanitizing procedures are executed by the autonomous vehicle 1010.

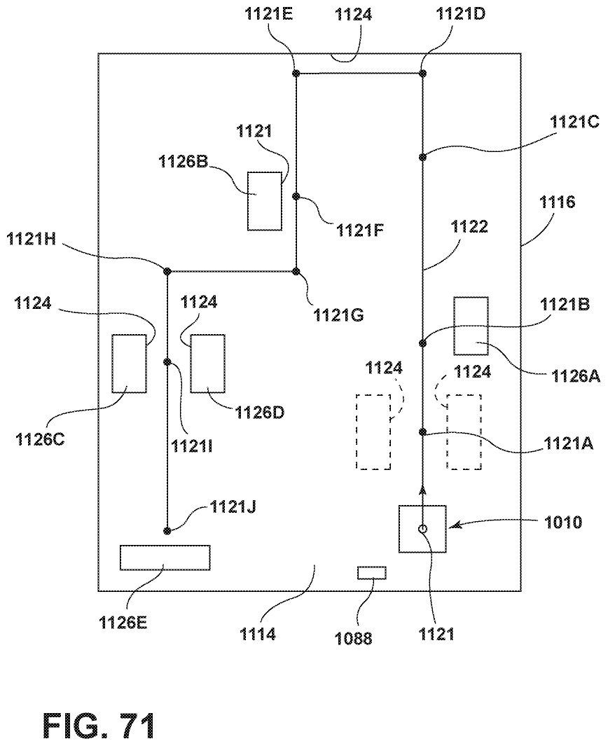

Referring again to FIGS. 70 and 71, at step 1108, the robotic spray arm 440 may be programmed (e.g. using controller 430) to move in predefined directions (translational and rotational) at selected predefined task locations such as waypoint 1121B (FIG. 71) to clean and/or sanitize equipment or the like as required. Additional waypoints 1121F, 11211, etc. may define additional task locations at which robotic spray arm 440 may be programmed to perform specific cleaning tasks at station 1126B, 1126C, 1126D, etc. As discussed above, autonomous vehicle 1010 may be configured to change spray nozzles 460 as required for a particular cleaning or sanitizing task, and the angular position of the spray nozzles 460 may be controlled as required depending on the configuration of the surface to be cleaned at each station. Furthermore, autonomous vehicle 1010 may be configured to utilize selected fluids or mixtures of fluids from containers 420 and 422 and/or air or water supplied by supply line 504 as required for a particular cleaning or sanitizing task.

Referring again to FIG. 70, after robotic spray arm 440 (e.g. controller 430) is programmed to execute predefined linear and/or rotational movements at each cleaning station in connection with control of the flow of fluids at each station, the process 1100 ends 1110. After the configuration process 1100 is completed, autonomous vehicle 1010 can be positioned at a starting waypoint 1121 (FIG. 71), and the controller 430 may be actuated, thereby causing autonomous vehicle 1010 to autonomously travel along path 1122 and execute the required cleaning tasks at stations 1126A-1126E. The starting waypoint 1121 may be located near a source for the fluid and air that is run through the supply hose 504. As discussed above, sensors 1020 provide position data to autonomous vehicle 1010 as autonomous vehicle 1010 moves along the path 1122, whereby autonomous vehicle 1010 can determine its position along the path 1122 and execute the required tasks at each station 1126A-1126E. It will be understood that the path and cleaning task at stations may be adjusted as required following the initial setup process 1100. As also discussed above, the autonomous vehicle 1010 may be configured to pay out and take up supply hose 504 as the autonomous vehicle 1010 moves along path 1122. For example, autonomous vehicle 1010 may pay out hose 504 at a speed that is approximately or substantially equal to a speed of autonomous vehicle 1010 as autonomous vehicle 1010 moves away from a source along a linear path segment, and autonomous vehicle 1010 may take up hose 504 at a speed that is approximately or substantially equal to a speed of autonomous vehicle 1010 as autonomous vehicle 1010 moves towards a stationary hose supply connection source. Autonomous vehicle 1010 may also pay out an additional length of supply hose 504 at nonlinear path segments or corners of path 1122. For example, at corner 1121D, autonomous vehicle 1010 may pay out and take up a length of hose 504 that is greater than a linear distance between points 1121C and 1121E.

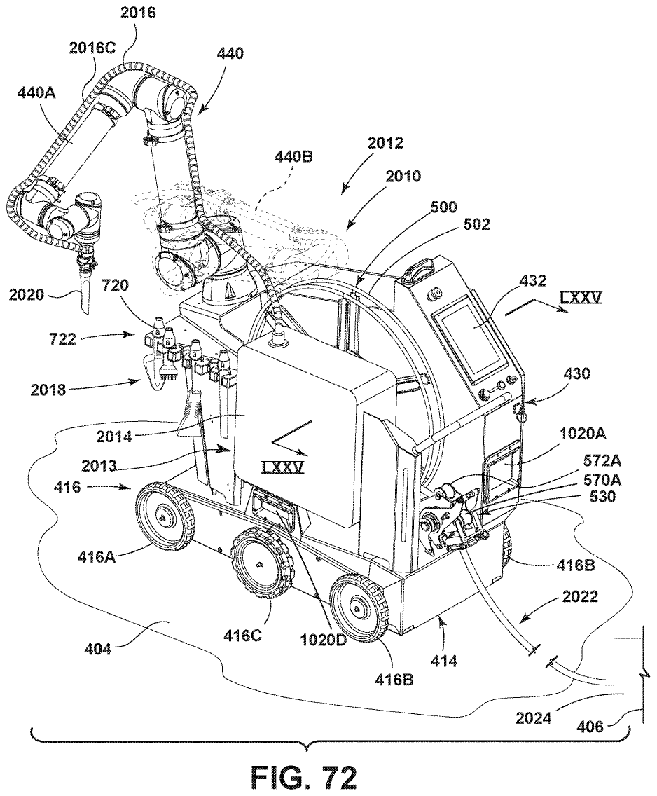

FIG. 72 is an isometric view of an autonomous cleaning system 2012 according to another embodiment that includes an autonomous vehicle 2010. The autonomous vehicle 2010 may include a chassis 414, a robotic arm 440, a reel assembly 500, a spool assembly 502, and a power drive system having a plurality of wheels 416 controlled by a controller 430 to power controlled movement of the autonomous vehicle 2010 that are substantially similar to the corresponding components described in more detail above in connection with FIGS. 29-50, and having like reference numerals. In the embodiment shown in FIG. 72, the autonomous vehicle 2010 of the autonomous cleaning system 2012 further includes a vacuum assembly 2013 mounted on the chassis 414. The vacuum assembly 2013 includes a canister 2014 that is configured to collect debris in an interior cavity 2014A (FIG. 75) thereof. In this way, the autonomous vehicle 2010 is an autonomous vacuum robot that is configured to move about a facility and vacuum debris as compared to an autonomous vehicle used for cleaning and disinfecting as described above in connection with FIGS. 29-50. In the autonomous cleaning system 2012 shown in FIG. 72, the autonomous vehicle 2010 navigates around a facility using a plurality of sensors 1020 in a similar manner as described above. The vacuum assembly 2013 includes a vacuum hose 2016 that is coupled to the robotic arm 440 for movement therewith along a body portion 2016C of the vacuum hose 2016. The vacuum hose 2016 interconnects the canister 2014 with a nozzle assembly 2020 of the robotic arm 440. The vacuum assembly 2013 further includes a vacuum motor 2032 (FIG. 75) that is fluidly coupled to the vacuum hose 2016 to provide suction at the nozzle assembly 2020 through the vacuum hose 2016 so that debris can be suctioned at the nozzle assembly 2020 and deposited into the interior cavity 2014A of the canister 2014. It is contemplated that the canister 2014 can be removed from the autonomous vehicle 2010 and be emptied as needed. Further, it is contemplated that the interior cavity 2014A may include any number of sensors to detect a debris level within the interior cavity 2014A of the canister 2014, and such sensors may be electronically coupled to the controller 430 for signaling the controller 430 when the canister 2014 has reached a predetermined threshold debris level and needs to be emptied.

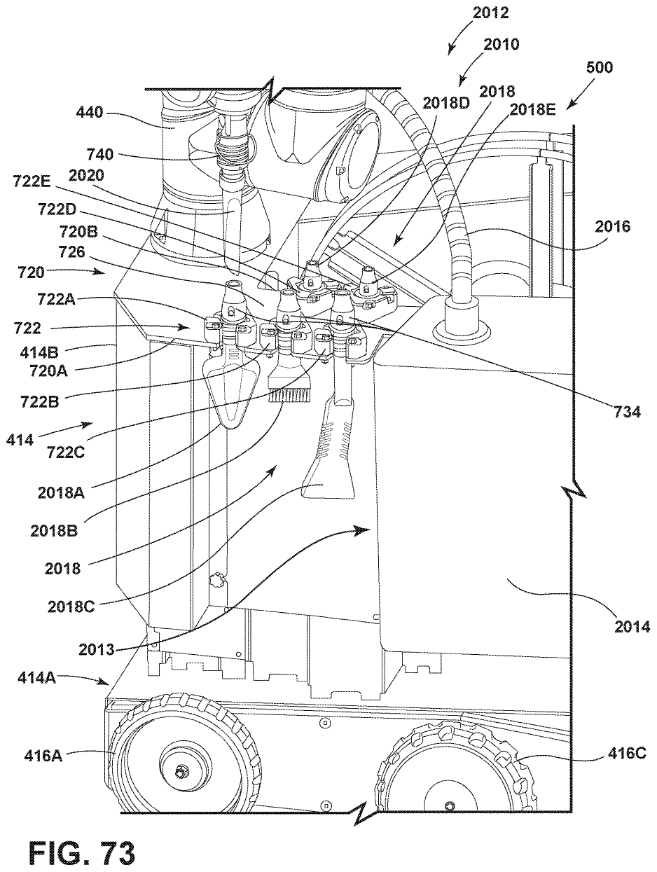

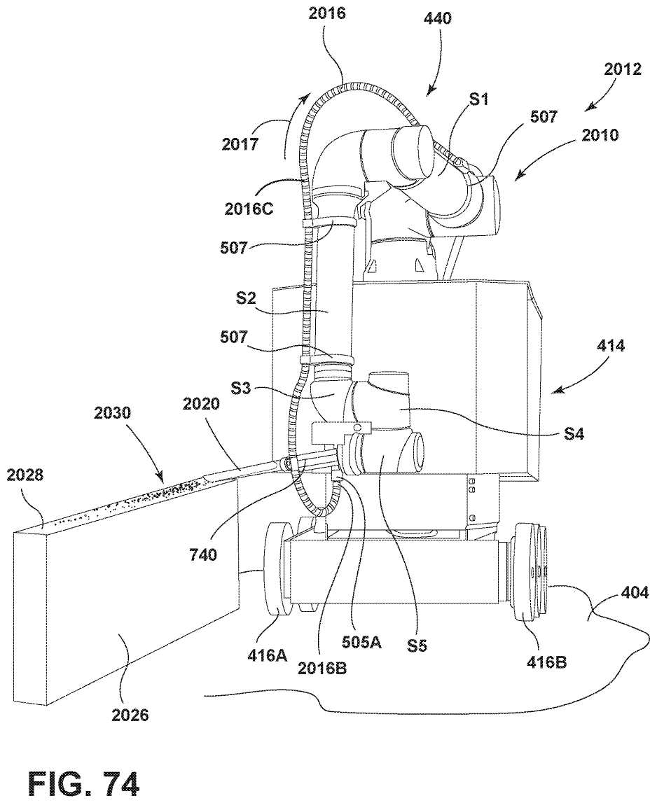

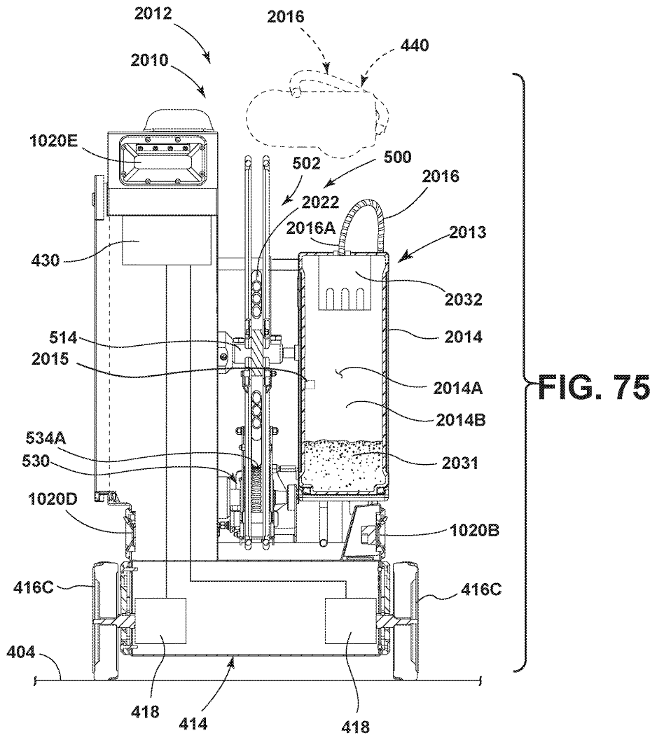

Like the autonomous vehicles described above, the autonomous vehicle 2010 shown in FIGS. 72 and 73 includes a rack 720 having a plurality of holder assemblies 722. Given that the autonomous vehicle 2010 provides a vacuum function, the rack 720 is equipped with a plurality of nozzle assemblies 2018, each configured for various vacuum functions. In the embodiment shown in FIG. 73 the nozzle assemblies 2018 include various configurations and features (such as brushes) that may be useful for given situations. It is contemplated that an area to be cleaned can be scanned by a camera and interpreted by the controller 430, such that the controller 430 can select a suitable nozzle assembly 2018A-2018E for a select vacuuming procedure. Each nozzle assembly 2018A-2018E of the plurality of nozzle assemblies 2018 can be secured to an associated holder assembly 722 of the rack 720 in a manner as described above with reference to FIGS. 42-47E. In this way, each nozzle assembly 2018A-2018E of the plurality of nozzle assemblies 2018 are removably supported on the rack 720. Each nozzle assembly 2018A-2018E of the plurality of nozzle assemblies 2018 includes an associated connector assembly 734 that can connect with an associated holder assembly 722 of the rack 720 for storage on and removal from the rack 720, and also removably engage and disengage from the tool connector assembly 740 of the robotic arm 440 in a similar manner as described above with reference to FIGS. 48-49. In the embodiment shown in FIGS. 72 and 73 nozzle assembly 2020 has been selected for a targeted vacuum procedure as further described below with reference to FIG. 74.

Referring again to FIG. 72, the autonomous vehicle 2010 further includes a powered roller assembly 530 that selectively pays out and takes in a supply line 2022. In the embodiment shown in FIG. 72, the supply line 2022 is contemplated to be a power supply line that connects to a power source 2024 that may be provided on a base station positioned on a wall 406 of a facility. It is contemplated that the supply line 2022 may provide 120V-240V to run the autonomous vehicle 2010. In this way, the autonomous vehicle 2010 does not require an onboard battery unit to power the autonomous vehicle 2010. Thus, the mechanical and electronic components of the autonomous vehicle 2010 can be powered via power distributed from the power supply line 2022 as provided by the power source 2024. It is contemplated that the power supply line 2022 is a single line that can be paid out by the roller assembly 530 in a similar manner as compared to the dual conduit supply hose 504 described above with reference to FIGS. 33-40 as the autonomous vehicle 2010 moves away from the power source 2024. Further, the power supply line 2022 can be reeled in by the roller assembly 530 and stored on the spool assembly 502 of the reel assembly 500 as the autonomous vehicle 2010 moves towards the power source 2024, in a manner similar to that described above with reference to the supply hose 504 and illustrated in FIGS. 33-40.

Referring now to FIG. 74, the autonomous vehicle 2010 is shown supported on a floor surface 404 of a facility. Specifically, the autonomous vehicle 2010 is shown positioned adjacent an object 2026 is also supported on the floor surface 404 of the facility. It is contemplated that the object 2026 may be any object or piece of equipment that would be positioned within the facility that requires vacuuming. In FIG. 74, the object 2026 includes an upper surface 2028 having an amount of debris 2030 disposed thereon. It is contemplated that the autonomous vehicle 2010 has detected the debris 2030 deposited on the upper surface 2028 of the object 2026 using any one of the sensors or cameras provided on the autonomous vehicle 2010. As discussed above, the robotic arm 440 includes a plurality of sections S1-S5 that are interconnected by a plurality of articulating joints J1-J5 that allow the robotic arm 440 to maneuver into specific positions for providing a vacuum procedure. As specifically illustrated in FIG. 74, the robotic arm 440 has positioned the nozzle assembly 2020 such that a distal end of the nozzle assembly 2020 is directly adjacent to the upper surface 2028 of the object 2026 to capture the debris 2030 during a vacuuming procedure. It is contemplated that the debris 2030 can be captured using and extending motion of the robotic arm 440 along the upper surface 2028 of the object 2026, or that the debris 2030 can be captured by driving the autonomous vehicle 2010 in a forward direction along the object 2026. As the debris 2030 is captured during a vacuuming procedure, the debris 2030 will travel through the vacuum hose 2016 in the direction as indicated by arrow 2017 towards the canister 2014 for depositing the same within the interior cavity 2014A of the canister 2014. Like the hoses discussed above with the robotic spray arm 440, the body portion 2016C of the vacuum hose 2016 is coupled to the robotic arm 440 using a plurality of mounting clamps 507. In this way, the vacuum hose 2016 does not get kinked or tangled with any given movement of the robotic arm 440 so that the vacuum hose 2016 can fluidly interconnect the vacuum motor 2032 to the nozzle assembly 2020 of the robotic arm 440 to provide suction at the nozzle assembly 2020.

Referring now to FIG. 75, deposited debris 2031 is shown received within the interior cavity 2014A of the canister 2014. As noted above, the canister 214 may include a sensor 2015 disposed thereon which can detect a level of debris within the interior cavity 2014A of the canister 2014. When the level of debris reaches a predetermined threshold level, the sensor 2015 can alert the controller 430 that the canister 2014 needs to be emptied. The canister 2014 may be a fully removable canister or may include a removable portion 2014B that can easily allow a user or a docking station to empty the canister 2014. As further shown in FIG. 75, a vacuum motor 2032 is shown positioned within the interior cavity 2014A of the canister 2014. The vacuum motor 2032 is operably and fluidly coupled to a first end 2016A of the vacuum hose 2016 that is coupled to the canister 2014, while a second end 2016B of the vacuum hose 2016 is coupled to the tool connector 740 adjacent the attached nozzle assembly 2020 (FIG. 74), such that the nozzle assembly 2020 is operably and fluidly coupled to the vacuum hose 2016. Thus, the vacuum hose 2016 includes first and second ends 2016A, 2016B with the body portion 2016C disposed therebetween. In the embodiment shown in FIG. 75, the vacuum motor 2032 is shown positioned within the interior cavity 2014A of the canister 2014, however, it is contemplated that the vacuum motor 2032 may be positioned anywhere on the autonomous vehicle 2010 so long as it is operably coupled to the vacuum hose 2016 for depositing debris within the canister 2014.

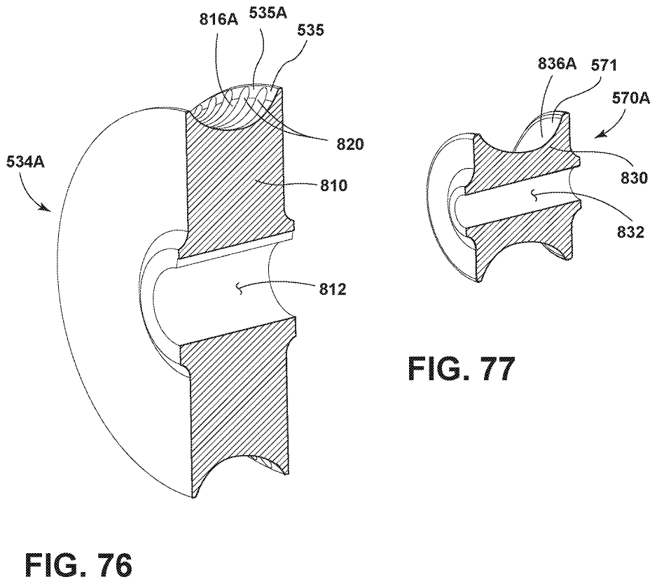

With further reference to FIG. 75, the supply line 2022 is shown partially wound up and received on the spool assembly 502 of the reel assembly 500. As noted above, the supply line 2022 is contemplated to be a single power cord that interconnects the autonomous vehicle 2010 to a power source. Thus, as shown in FIG. 75, the supply line 2022 is stacked around the barrel or hub 514 of the spool assembly 502 in a single stack configuration. Being a single cord, the supply line 220 requires a different motor driven roller 534A and engagement wheel system for the roller assembly 530. Specifically, with reference to FIG. 76, the roller 534A includes a single receiving channel 816A that is an outwardly opening U-shaped channel configured to receive the supply line 2022 as the supply line 2022 is engaged by the roller 534A in a power supply line payout or take-up procedure. The supply line 2022 can nest within the receiving channel 816A of the roller 534A during engagement therewith. This nesting feature ensures that the supply line 2022 does not move laterally along the annular bearing surface 535 of the roller 534A and stays properly positioned while engaged with the roller 534A. As further shown in FIG. 76, the annular bearing surface 535 of the roller 534A includes a tractioned or textured upper surface 535A having a plurality of grooves 820 disposed thereon. In this way, the roller 534 a does not include a dual receiving channel configuration like the roller 534 shown in FIG. 39. Similarly, the engagement wheels 570A, 572A (FIG. 72) include a single upwardly opening receiving channel 836A as shown in FIG. 77. In this way, the roller assembly 530 of the autonomous vehicle 2010 is configured to engage and pay out or roll up a single cord configuration of the supply line 2022. Thus, the autonomous vehicle 2010 can pay out the supply line 2022 for deposition of the same on a floor surface of a facility as the autonomous vehicle 2010 moves away from a selected power source to which the supply line 2022 is coupled, and reel in the supply line 2022 for storage on the spool assembly 502 as the autonomous vehicle 2010 moves closer to the selected power source. The power supply line 2022 is contemplated to provide electricity needed to power movement of the autonomous vehicle 2010, as well as power the onboard functions of the autonomous vehicle 2010, such as the vacuum motor 2032. Thus, it is contemplated that the vacuum motor 2032 is electronically coupled with the power supply line 2022.

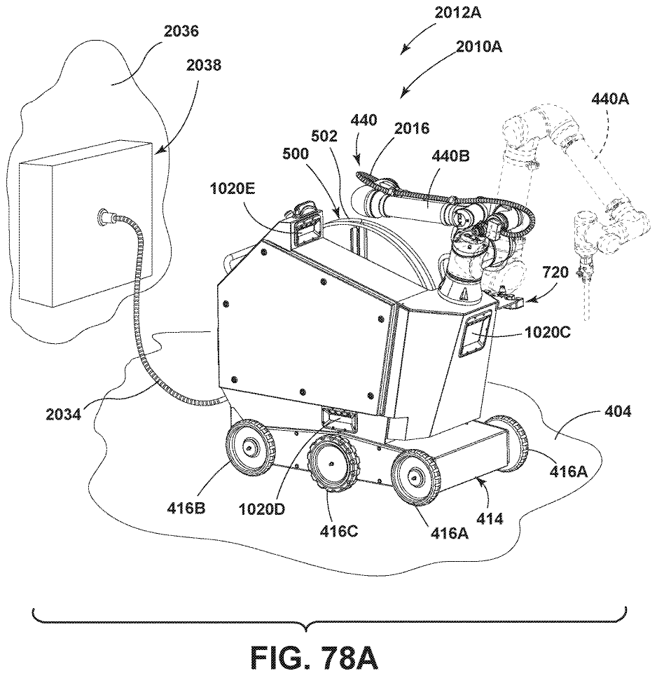

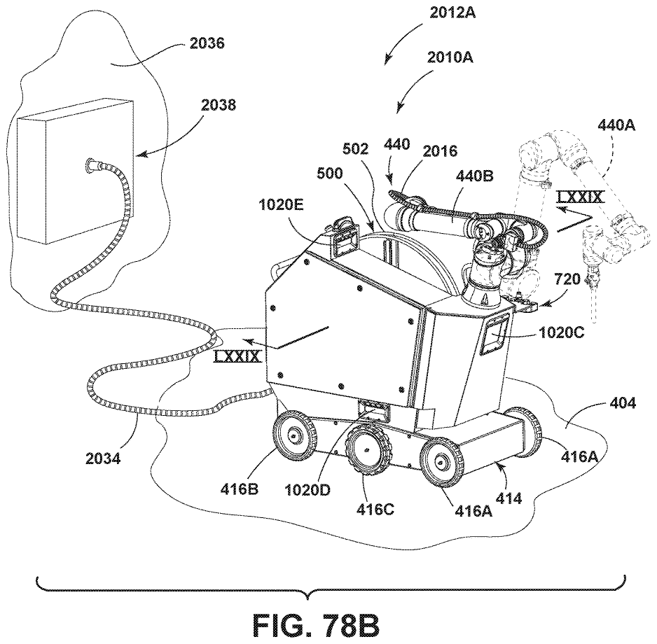

Referring now to FIGS. 78A and 78B, another embodiment of an autonomous cleaning system 2012A is shown having an autonomous vehicle 2010A. The autonomous vehicle 2010A includes a number of features in common with the autonomous vehicle 2010 discussed above with reference to FIGS. 72-75, for which like reference numerals are used to indicate components common to both autonomous vehicles 2010, 2010A. In the embodiment shown in FIGS. 78A and 78B, the autonomous vehicle 2010A includes a supply line 2034 that is coupled to a vacuum source 2038 disposed on a wall 2036 of a facility. Thus, in this embodiment, the supply line 2034 is a vacuum hose configured to supply suction to the autonomous vehicle 2010A. It is contemplated that the supply line 2034 is a single vacuum hose that can be paid out by the roller assembly 530 and deposited on the floor surface 404 of a facility as the autonomous vehicle 2010A moves away from the vacuum source 2038, as shown in FIG. 78B. Further, the supply line 2034 can be reeled in by the roller assembly 530 and stored on the spool assembly 502 of the reel assembly 500 as the autonomous vehicle 2010A moves towards the vacuum source 2038. Thus, the payout and reel in procedures for the supply line 2034 are similar to those described above with reference to the power supply line 2022 described above and illustrated in FIGS. 72-77, and the supply hose 504 described above and illustrated in FIGS. 33-40.

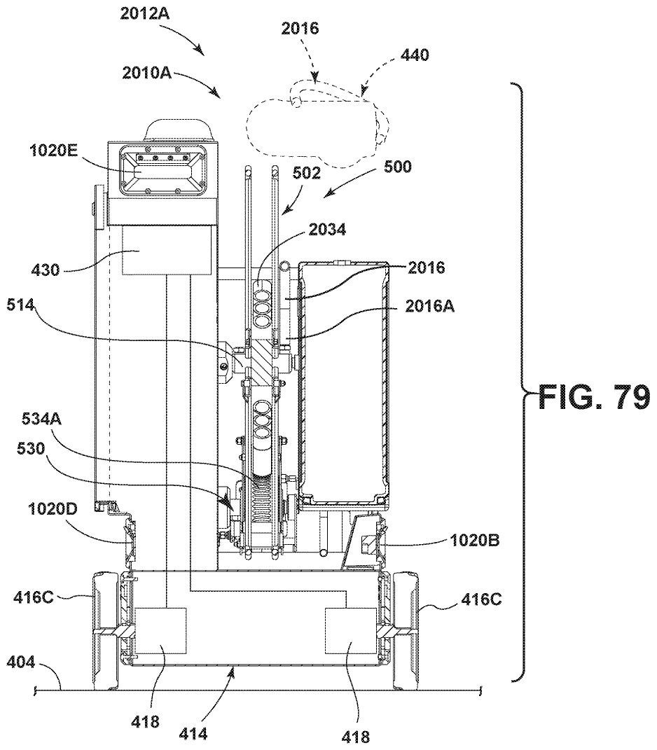

In FIGS. 78A and 78B, the vacuum hose 2016 is still shown coupled to the robotic arm 440 for movement between a variety of positions indicated at reference numerals 440A and 440B, for example. However, in the embodiment shown in FIGS. 78A and 78B, the first end 2016A of the vacuum hose 2016 is contemplated to be coupled to the barrel or hub 514 of the reel assembly 500 as best shown in FIG. 79, while the second end 2016B remains coupled to the tool connector 740. In this way, the vacuum hose 2016 is operably coupled to the supply line 2034 through the reel assembly 500, such that suction can be provided to the vacuum hose 2016 from the supply line 2034. In this way, the supply line 2034 provides suction to the autonomous vehicle 2010A as derived from the vacuum source 2038. At the autonomous vehicle 2010A, the suction is transmitted through the reel assembly 500 at the barrel 514 to the vacuum hose 2016 that is coupled to the robotic arm 440 from which a nozzle assembly, such as nozzle assembly 2020, can be maneuvered within the facility for cleaning up a floor surface or objects supported on the floor surface within a facility. It is contemplated that suction can be provided to the autonomous vehicle 2010A through the supply hose 2038 and the vacuum hose 2016 along a path that is similar to the delivery of pressurized air to the autonomous vehicles described above using supply hose 504. As the autonomous vehicle 2010A of FIGS. 78A-79 does not include a tethered power source, like autonomous vehicle 2010, the autonomous vehicle 2010A is contemplated to rely on battery power for powering movement of the autonomous vehicle 2010A, and for powering the various components thereof.

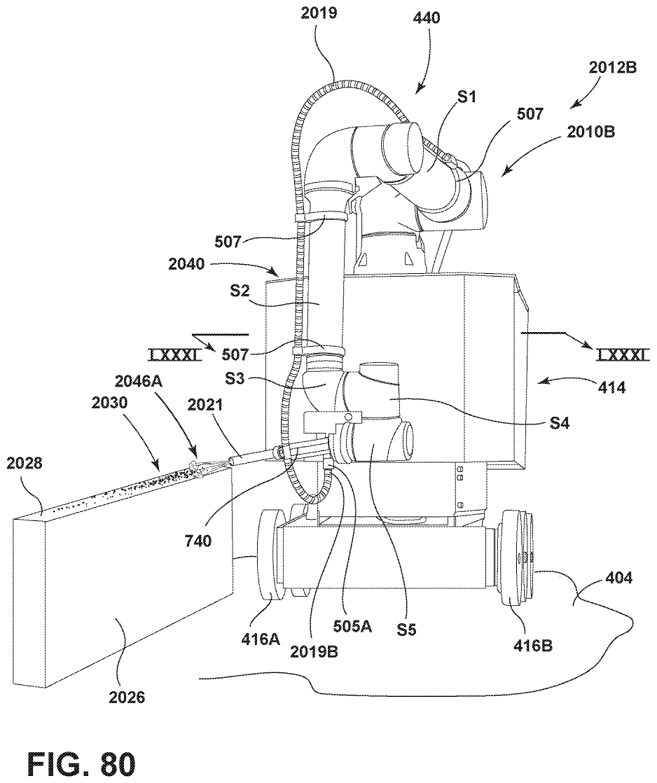

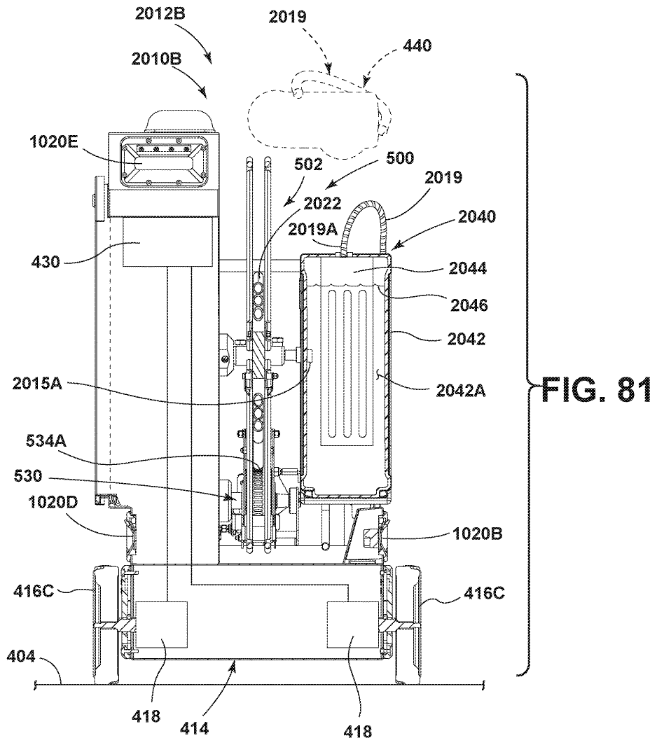

Referring now to FIGS. 80 and 81, another embodiment of an autonomous cleaning system 2012B is shown having an autonomous vehicle 2010B. The autonomous vehicle 2010B includes a number of features in common with the autonomous vehicles 2010 and 2010A discussed above with reference to FIGS. 72-79, for which like reference numerals are used to indicate components common to the autonomous vehicles 2010, 2010A and 2010B. In the embodiment shown in FIGS. 80 and 81, the autonomous vehicle 2010B includes a steam supply line 2019 that is coupled to a steam generator 2040. The steam generator 2040 is supported on the chassis 414 of the autonomous vehicle 2010B for movement therewith. Like the vacuum motor 2032 of autonomous vehicle 2010, the steam generator 2040 of the autonomous vehicle 2010B is contemplated to be powered by a power supply line 2022 that is paid out and reeled in using the reel assembly 500 as the autonomous vehicle 2010B moves about a facility. Thus, the autonomous vehicle 2010B, much like autonomous vehicle 2010, is contemplated to be powered for movement and cleaning operations using a facility's power source, as compared to a battery-operated autonomous vehicle.

With further reference to FIG. 80, the autonomous vehicle 2010B is shown supported on a floor surface 404 of a facility. Specifically, the autonomous vehicle 2010B is shown positioned adjacent an object 2026 that is also supported on the floor surface 404 of the facility. It is contemplated that the object 2026 may be any object or piece of equipment that would be positioned within the facility that requires a steam cleaning procedure. In FIG. 80, the object 2026 includes an upper surface 2028 having an amount of debris 2030 disposed thereon. It is contemplated that the autonomous vehicle 2010B has detected the debris 2030 deposited on the upper surface 2028 of the object 2026 using any one of the sensors or cameras provided on the autonomous vehicle 2010B. As discussed above, the robotic arm 440 can maneuver into specific positions for directly supplying steam to stuck on debris. As specifically illustrated in FIG. 80, the robotic arm 440 has positioned a nozzle assembly 2021 such that a distal end of the nozzle assembly 2021 is directly adjacent to the upper surface 2028 of the object 2026 to impart steam 2046A on the debris 2030 during a steam cleaning procedure. It is contemplated that the debris 2030 can be loosened and removed from the upper surface 2028 of the object 2026 by the introduction of steam through the nozzle assembly 2021. Like the hoses discussed above with the robotic spray arm 440, the steam supply hose 2019 is coupled to the robotic arm 440 using a plurality of mounting clamps 507. In this way, the steam supply hose 2019 does not get kinked or tangled with any given movement of the robotic arm 440. It is contemplated that the nozzle assembly 2021 is specifically configured to deliver steam to an object or surface to be steam cleaned. Further, the nozzle assembly 2021 may include wire bristles or scraping elements that help to loosen and remove debris during a steam cleaning procedure.

Referring now to FIG. 81, the steam generator 2040 includes a boiler 2042 having a boiler cavity 2042A. Within the boiler cavity 2042A, a heating element 2044 is disposed along with an amount of water 2046. The water 2046 disposed within the boiler cavity 2042A is heated with the heating element 2044 for conversion into steam which is supplied to the nozzle assembly 2021 via the steam supply hose 2019. Specifically, the boiler 2042 is coupled to a first end 2019A of the steam supply hose 2019, while a second end 2019B of the steam supply hose 2019 is coupled to the tool connector 740 adjacent the attached nozzle assembly 2021 (FIG. 80). The boiler 2042 may include a sensor 2015A which can detect a level of water 2046 available within the boiler cavity 2042A of the boiler 2042. It is further contemplated that the sensor 2015A can be used to detect a temperature of the water 2046 as heated within the boiler 2042 by the heating element 2044. The heating element 2044 and the sensor 2015A are contemplated to be electronically coupled with the power supply line 2022 for powering the same. When the level of water 2046 depletes to a predetermined threshold level, the sensor 2015A can alert the controller 430 that the boiler 2042 needs more water to continue operations. The boiler 2042 may be a fully removable piece of equipment or may include a removable portion that can easily allow a user or a docking station to fill the boiler 2042 with water.

With further reference to FIG. 80, the power supply line 2022 is shown partially wound up and received on the spool assembly 502 of the reel assembly 500. As noted above, the power supply line 2022 is contemplated to be a single power cord that interconnects the autonomous vehicle 2010 to a power source. Thus, as shown in FIG. 80, the supply line 2022 is stacked around the barrel or hub 514 of the spool assembly 502 in a single stack configuration, much like the configuration shown in FIG. 75. Thus, the autonomous vehicle 2010B can move about a facility to provide steam cleaning operations where needed in order to remove debris and sanitize equipment, all while being electronically coupled to a power source of the facility via power supply line 2022.

It will be understood that construction of the described disclosure and other components is not limited to any specific material. Other exemplary embodiments of the disclosure disclosed herein may be formed from a wide variety of materials, unless described otherwise herein. Also, any of the components and/or features described above in connection with any of FIGS. 1-81 may be used in any combination with any other components and/or features described above in connection with any of FIGS. 1-81. Unless specifically stated otherwise herein, any of the autonomous vehicles or systems described herein may include one or more components or features of any other autonomous vehicles or systems described herein in any combination.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connectors or other elements of the system may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

1. An autonomous vehicle, comprising:
a chassis having a powered drive system that is configured to move the autonomous vehicle;
a reel assembly having a spool and a roller assembly;
a power supply line operably coupled to the roller assembly and at least partially housed on the spool, wherein the power supply line is configured to electronically couple the autonomous vehicle to a power source that is not on the autonomous vehicle; and:
a controller that is configured to cause the roller assembly to: 1) pay out the power supply line from the spool when the autonomous vehicle moves away from the power source, and: 2) wind the power supply line onto the spool as the autonomous vehicle moves towards the power source.

2. The autonomous vehicle of claim 1, including:
a robotic arm supported on the chassis and having a plurality of sections interconnected by a plurality of articulating joints, the robotic arm including a nozzle assembly disposed at a distal end thereof.

3. The autonomous vehicle of claim 2, including:
a vacuum assembly supported on the chassis, wherein the vacuum assembly includes a vacuum hose, a vacuum motor and a canister, wherein the vacuum hose fluidly interconnects the vacuum motor to the nozzle assembly of the robotic arm to provide suction at the nozzle assembly, wherein the canister includes an interior cavity configured to collect debris suctioned from the nozzle assembly, and further wherein the vacuum motor is electronically coupled to the power supply line.

4. The autonomous vehicle of claim 3, wherein a body portion of the vacuum hose is coupled to the robotic arm for movement therewith.

5. The autonomous vehicle of claim 4, including:
a sensor operably coupled to the canister, wherein the sensor is configured to detect a level of debris collected within the interior cavity of the canister.

6. The autonomous vehicle of claim 2, including:
a tool connector assembly releasably interconnecting the nozzle assembly with the robotic arm.

7. The autonomous vehicle of claim 6 including:
a rack disposed on the chassis and having a plurality of holder assemblies, wherein each holder assembly of the plurality of holder assemblies is configured to releasably engage and support an associated nozzle assembly, and wherein the tool connector assembly is configured to be fluidly connected to a selected nozzle assembly supported by the rack upon axial and rotational movement of the tool connector assembly imparted by the robotic arm, whereby: 1) the selected nozzle assembly supported by the rack can be fluidly connected to the tool connector assembly and disengaged from the rack, and: 2) the selected nozzle assembly connected to the tool connector assembly can be moved into engagement with a selected holder assembly of the plurality of holder assemblies and disconnected from the tool connector assembly.

8. The autonomous vehicle of claim 2, including:
a plurality of sensors that are configured to provide signals indicative of a distance between the autonomous vehicle and objects adjacent to the autonomous vehicle.

9. The autonomous vehicle of claim 8, wherein the plurality of sensors comprises at least one LIDAR unit or at least one camera, whereby the controller determines distances of objects relative to the autonomous vehicle based, at least in part, on signals from the at least one LIDAR unit or at least one camera.

10. The autonomous vehicle of claim 2, including:
a steam generator supported on the chassis, wherein the steam generator includes a steam supply line, a boiler and a heating element disposed within an interior cavity of the boiler, wherein the steam supply line fluidly interconnects the boiler to the nozzle assembly of the robotic arm to provide steam at the nozzle assembly.

11. The autonomous vehicle of claim 10, wherein a body portion of the steam supply line is coupled to the robotic arm for movement therewith.

12. The autonomous vehicle of claim 11, including:
a sensor operably coupled to the boiler, wherein the sensor is configured to detect a level of water available within an interior cavity of the boiler.

13. The autonomous vehicle of claim 10, including:
a tool connector assembly releasably interconnecting the nozzle assembly with the robotic arm.

14. The autonomous vehicle of claim 13 including:
a rack disposed on the chassis and having a plurality of holder assemblies, wherein each holder assembly of the plurality of holder assemblies is configured to releasably engage and support an associated nozzle assembly, and wherein the tool connector assembly is configured to be fluidly connected to a selected nozzle assembly supported by the rack upon axial and rotational movement of the tool connector assembly imparted by the robotic arm, whereby: 1) the selected nozzle assembly supported by the rack can be fluidly connected to the tool connector assembly and disengaged from the rack, and: 2) the selected nozzle assembly connected to the tool connector assembly can be moved into engagement with a selected holder assembly of the plurality of holder assemblies and disconnected from the tool connector assembly.

15. The autonomous vehicle of claim 10, including:
a plurality of sensors that are configured to provide signals indicative of a distance between the autonomous vehicle and objects adjacent to the autonomous vehicle.

16. The autonomous vehicle of claim 15, wherein the plurality of sensors comprises at least one LIDAR unit or at least one camera, whereby the controller determines distances of objects relative to the autonomous vehicle based, at least in part, on signals from the at least one LIDAR unit or at least one camera.

17. An autonomous vehicle comprising:
a chassis;
a powered drive system supported by the chassis, wherein the powered drive system is configured to selectively move the autonomous vehicle;
a reel assembly having a spool that houses a supply hose, whereby suction can be supplied to the autonomous vehicle from a vacuum source that is fluidly connected to the supply hose, wherein a portion of the supply hose extends between the spool and the vacuum source;
a robotic arm having a nozzle assembly that is coupled to the supply hose; and
a controller that is configured to actuate the powered drive system to move the autonomous vehicle along a predefined path, and pay out the supply hose as the autonomous vehicle moves in a first direction along the predefined path.

18. The autonomous vehicle of claim 17, wherein the controller is further configured to retract the supply hose onto the spool as the autonomous vehicle moves in a second direction along the predefined path that is opposed to the first direction.

19. The autonomous vehicle of claim 18, wherein the controller is configured to signal the powered drive system to stop the autonomous vehicle at first and second predefined task locations along the predefined path and cause the robotic arm to move the nozzle assembly in predefined first and second motion sequences at the first and second predefined task locations, respectively, to vacuum first and second surfaces, respectively.

20. The autonomous vehicle of claim 17, including:
a plurality of sensors that are configured to provide signals to the controller indicative of a distance between the autonomous vehicle and objects adjacent to the autonomous vehicle.
